(19) United States
(12) Patent Application Publication
(10) Pub. No.: US 2017/0102467 A1
(43) Pub. Date: Apr. 13, 2017

(54) SYSTEMS, METHODS, AND APPARATUS FOR TRACKING AN OBJECT

(71) Applicant: CertusView Technologies, LLC, Palm Beach Gardens, FL (US)

(72) Inventors: Steven E. Nielsen, North Palm Beach, FL (US); Curtis Chambers, Palm Beach Gardens, FL (US); Jeffrey Farr, Royal Palm Beach, FL (US); Jack Maxwell Vice, Orlando, FL (US); Sanjay Mishra, North Potomac, MD (US); Joli Rightmyer, Arlington, VA (US)

(21) Appl. No.: 14/549,488

(22) Filed: Nov. 20, 2014

Related U.S. Application Data
(60) Provisional application No. 61/906,848, filed on Nov. 20, 2013.

(51) Int. Cl. G01S 19/47; G01S 19/26; G01S 19/43

(52) U.S. Cl. CPC G01S 19/47; G01S 19/43; G01S 19/26

(57) ABSTRACT

Systems, methods, and apparatus are provided for tracking an object moving along and above a ground surface. The object may comprise, affixed thereto or contained therein, a satellite-based location tracking apparatus to provide a first set of position coordinate pairs for the object as well as an inertial measurement unit to provide a plurality of heading direction values for the object and/or a velocity/distance sensor to provide a second set of position coordinate pairs based on, for example, optical flow image processing of a plurality of images of the ground surface. At least one processor may calculate a third set of position coordinate pairs based on a combination of the first set of position coordinate pairs, accounting for first reliability factor(s), as well as the second set of position coordinate pairs, accounting for second reliability factor(s), and/or the plurality of heading direction values, accounting for third related reliability factor(s).

### CROSS-REFERENCE TO RELATED APPLICATIONS

The present application claims a priority benefit, under 35 U.S.C. §119(e), to U.S. Provisional Patent Application No. 61/906,848, entitled “Object Tracking Methods and Apparatus Employing GPS Information Quality Assessment and Optical Flow-Based Dead Reckoning Techniques,” filed on Nov. 20, 2013, under attorney docket no. DYCO-102/00US (319976-2025), and which is incorporated herein by reference.

### BACKGROUND

Object tracking can be complicated by, among other things, a loss of information (e.g., partial or full object obstructions), noise from, e.g., the surrounding environment, and the complexity of the object's motion, shape, or other aspects. Methods and apparatus for tracking a moving object have many applications, examples of which include, but are not limited to, motion-based detection, recognition, surveillance, documentation, and/or navigation. Field service operations are one context for such applications.

A field service operation may be any operation in which an entity dispatches a technician and/or another staff member to perform certain activities, for example, installations, services, and/or repairs. Field service operations may be used in various industries, examples of which include, but are not limited to, network installations, utility installations, security systems, construction, medical equipment, heating, ventilating and air conditioning (HVAC), and the like.

An example of a field service operation in the construction industry is a so-called “locate and marking operation,” also commonly referred to more simply as a “locate operation” (or sometimes merely as a “locate”). In a typical locate operation, a locate technician visits a work site (also referred to herein as a “jobsite”), at which there is a plan to disturb the ground (e.g., excavate, dig one or more holes and/or trenches, bore, etc.) so as to determine a presence or an absence of one or more underground facilities (such as various types of utility cables and pipes) in a dig area to be excavated or disturbed at the work site. In some instances, a locate operation may be requested for a “design” project, in which there may be no immediate plan to excavate or otherwise disturb the ground, but nonetheless information about a presence or absence of one or more underground facilities at a work site may be valuable to inform a planning, permitting and/or engineering design phase of a future construction project.

In many states, an excavator who plans to disturb ground at a work site is required by law to notify any potentially affected underground facility owners prior to undertaking an excavation activity. Advanced notice of excavation activities may be provided by an excavator (or another party) by contacting a “one-call center.” One-call centers typically are operated by a consortium of underground facility owners for the purposes of receiving excavation notices and in turn notifying facility owners and/or their agents of a plan to excavate. As part of an advanced notification, excavators typically provide to the one-call center various information relating to the planned activity, including a location (e.g., address) of the work site and a description of the dig area to be excavated or otherwise disturbed at the work site.

FIG. 1 illustrates an example in which a locate operation is initiated as a result of an excavator 3110 providing an excavation notice to a one-call center 3120. An excavation notice also is commonly referred to as a “locate request,” and may be provided by the excavator to the one-call center via an electronic mail message, information entry via a website maintained by the one-call center, or a telephone conversation between the excavator and an operator at the one-call center. The locate request may include an address or some other location-related information describing the geographic location of a work site at which the excavation is to be performed, as well as a description of the dig area (e.g., a text description), such as its location relative to certain landmarks and/or its approximate dimensions, within which there is a plan to disturb the ground at the work site. One-call centers similarly may receive locate requests for design projects (for which, as discussed above, there may be no immediate plan to excavate or otherwise disturb the ground).

Once facilities implicated by the locate request are identified by a one-call center (e.g., via a polygon map/buffer zone process), the one-call center generates a “locate request ticket” (also known as a “locate ticket,” or simply a “ticket”). The locate request ticket essentially constitutes an instruction to inspect a work site and typically identifies the work site of the proposed excavation or design and a description of the dig area, typically lists on the ticket all of the underground facilities that may be present at the work site (e.g., by providing a member code for the facility owner whose polygon falls within a given buffer zone), and may also include various other information relevant to the proposed excavation or design (e.g., the name of the excavation company, a name of a property owner or party contracting the excavation company to perform the excavation, etc.). The one-call center sends the ticket to one or more underground facility owners 3140 and/or one or more locate service providers 3130 (who may be acting as contracted agents of the facility owners) so that they can conduct a locate and marking operation to verify a presence or absence of the underground facilities in the dig area. For example, in some instances, a given underground facility owner 3140 may operate its own fleet of locate technicians (e.g., locate technician 3145), in which case the one-call center 3120 may send the ticket to the underground facility owner 3140. In other instances, a given facility owner may contract with a locate service provider to receive locate request tickets and perform a locate and marking operation in response to received tickets on their behalf.

Upon receiving the locate request, a locate service provider or a facility owner (hereafter referred to as a “ticket recipient”) may dispatch a locate technician (e.g., locate technician 3150) to the work site of planned excavation to determine a presence or absence of one or more underground facilities in the dig area to be excavated or otherwise disturbed. A typical first step for the locate technician includes utilizing an underground facility “locate device,” which is an instrument or set of instruments (also referred to commonly as a “locate set”) for detecting facilities that are concealed in some manner, such as cables and pipes that are located underground. The locate device is employed by the technician to verify the presence or absence of underground facilities indicated in the locate request ticket as potentially present in the dig area (e.g., via the facility owner member codes listed in the ticket). This process is often referred to as a “locate operation.”

In one example of a locate operation, an underground facility locate device is used to detect electromagnetic fields that are generated by an applied signal provided along a length of a target facility to be identified. In this example, a locate device may include both a signal transmitter to provide the applied signal (e.g., which is coupled by the locate technician to a tracer wire disposed along a length of a facility), and a signal receiver which is generally a handheld apparatus carried by the locate technician as the technician walks around the dig area to search for underground facilities. FIG. 2 illustrates a conventional locate device 3500 (indicated by the dashed box) that includes a transmitter 3505 and a locate receiver 3510. The transmitter 3505 is connected, via a connection point 3525, to a target object (in this example, underground facility 3515) located in the ground 3520. The transmitter generates the applied signal 3530, which is coupled to the underground facility via the connection point (e.g., to a tracer wire along the facility), resulting in the generation of a magnetic field 3535. The magnetic field in turn is detected by the locate receiver 3510, which itself may include one or more detection antenna (not shown). The locate receiver 3510 indicates a presence of a facility when it detects electromagnetic fields arising from the applied signal 3530. Conversely, the absence of a signal detected by the locate receiver generally indicates the absence of the target facility.

In yet another example, a locate device employed for a locate operation may include a single instrument, similar in some respects to a conventional metal detector. In particular, such an instrument may include an oscillator to generate an alternating current that passes through a coil, which in turn produces a first magnetic field. If a piece of electrically conductive metal is in close proximity to the coil (e.g., if an underground facility having a metal component is below/near the coil of the instrument), eddy currents are induced in the metal and the metal produces its own magnetic field, which in turn affects the first magnetic field. The instrument may include a second coil to measure changes to the first magnetic field, thereby facilitating detection of metallic objects.

In addition to the locate operation, the locate technician also generally performs a “marking operation,” in which the technician marks the presence (and in some cases the absence) of a given underground facility in the dig area based on the various signals detected (or not detected) during the locate operation. For this purpose, the locate technician conventionally utilizes a “marking device” to dispense a marking material on, for example, the ground, pavement, or other surface along a detected underground facility. Marking material may be any material, substance, compound, and/or element, used or which may be used separately or in combination to mark, signify, and/or indicate. Examples of marking materials may include, but are not limited to, paint, chalk, dye, and/or iron. Marking devices, such as paint marking wands and/or paint marking wheels, provide a convenient method of dispensing marking materials onto surfaces, such as onto the surface of the ground or pavement.

FIGS. 3A and 3B illustrate a conventional marking device 50 with a mechanical actuation system to dispense paint as a marker. Generally speaking, the marking device 50 includes a handle 38 at a proximal end of an elongated shaft 36 and resembles a sort of “walking stick,” such that a technician may operate the marking device while standing/walking in an upright or substantially upright position. A marking dispenser holder 40 is coupled to a distal end of the shaft 36 so as to contain and support a marking dispenser 56, e.g., an aerosol paint can having a spray nozzle 54. Typically, a marking dispenser in the form of an aerosol paint can is placed into the holder 40 upside down, such that the spray nozzle 54 is proximate to the distal end of the shaft (close to the ground, pavement or other surface on which markers are to be dispensed).

In FIGS. 3A and 3B, the mechanical actuation system of the marking device 50 includes an actuator or mechanical trigger 42 proximate to the handle 38 that is actuated/triggered by the technician (e.g., via pulling, depressing, or squeezing with finger(s)/hand(s)). The actuator 42 is connected to a mechanical coupler 52 (e.g., a rod) disposed inside and along a length of the elongated shaft 36. The coupler 52 is in turn connected to an actuation mechanism 58, at the distal end of the shaft 36, which mechanism extends outward from the shaft in the direction of the spray nozzle 54. Thus, the actuator 42, the mechanical coupler 52, and the actuation mechanism 58 constitute the mechanical actuation system of the marking device 50.

FIG. 3A shows the mechanical actuation system of the conventional marking device 50 in the non-actuated state, wherein the actuator 42 is “at rest” (not being pulled) and, as a result, the actuation mechanism 58 is not in contact with the spray nozzle 54. FIG. 3B shows the marking device 50 in the actuated state, wherein the actuator 42 is being actuated (pulled, depressed, squeezed) by the technician. When actuated, the actuator 42 displaces the mechanical coupler 52 and the actuation mechanism 58 such that the actuation mechanism contacts and applies pressure to the spray nozzle 54, thus causing the spray nozzle to deflect slightly and dispense paint. The mechanical actuation system is spring-loaded so that it automatically returns to the non-actuated state (FIG. 3A) when the actuator 42 is released.

In some environments, arrows, flags, darts, or other types of physical marks may be used to mark the presence or absence of an underground facility in a dig area, in addition to or as an alternative to a material applied to the ground (such as paint, chalk, dye, tape) along the path of a detected utility. The marks resulting from any of a wide variety of materials and/or objects used to indicate a presence or absence of underground facilities generally are referred to as “locate marks.” Often, different color materials and/or physical objects may be used for locate marks, wherein different colors correspond to different utility types. For example, the American Public Works Association (APWA) has established a standardized color-coding system for utility identification for use by public agencies, utilities, contractors and various groups involved in ground excavation (e.g., red=electric power lines and cables; blue=potable water; orange=telecommunication lines; yellow=gas, oil, steam). In some cases, the technician also may provide one or more marks to indicate that a particular facility was not found or that no facility was found in the dig area (sometimes referred to as a “clear”).

As mentioned above, the foregoing activity of identifying and marking a presence or absence of one or more underground facilities generally is referred to for completeness as a “locate and marking operation.” However, in light of common parlance adopted in the construction industry, and/or for the sake of brevity, one or both of the respective locate and marking functions may be referred to in some instances simply as a “locate operation” or a “locate” (i.e., without making any specific reference to the marking function). Accordingly, it should be appreciated that any reference in the relevant arts to the task of a locate technician simply as a “locate operation” or a “locate” does not necessarily exclude the marking portion of the overall process. At the same time, in some contexts a locate operation is identified separately from a marking operation, wherein the former relates more specifically to detection-related activities and the latter relates more specifically to marking-related activities.

Inaccurate locating and/or marking of underground facilities can result in physical damage to the facilities, property damage, and/or personal injury during the excavation process that, in turn, can expose a facility owner or contractor to significant legal liability. When underground facilities are damaged and/or when property damage or personal injury results from damaging an underground facility during an excavation, the excavator may assert that the facility was not accurately located and/or marked by a locate technician, while the locate contractor who dispatched the technician may in turn assert that the facility was indeed properly located and marked. Proving whether the underground facility was properly located and marked can be difficult after the excavation (or after some damage, e.g., a gas explosion), because in many cases the physical locate marks (e.g., the marking material or other physical marks used to mark the facility on the surface of the dig area) will have been disturbed or destroyed during the excavation process (and/or damage resulting from excavation).

### SUMMARY

Applicants have recognized and appreciated that uncertainties which may be attendant to locate and marking operations may be significantly reduced by collecting various information particularly relating to the marking operation, rather than merely focusing on information relating to detection of underground facilities via a locate device. In many instances, excavators arriving to a work site have only physical locate marks on which to rely to indicate a presence or absence of underground facilities, and they are not generally privy to information that may have been collected previously during the locate operation. Accordingly, the integrity and accuracy of the physical locate marks applied during a marking operation arguably is significantly more important in connection with reducing risk of damage and/or injury during excavation than the location of where an underground facility was detected via a locate device during a locate operation.

Furthermore, Applicants have recognized and appreciated that the location at which an underground facility ultimately is detected during a locate operation is not always where the technician physically marks the ground, pavement, or other surface during a marking operation; in fact, technician imprecision or negligence, as well as various ground conditions and/or different operating conditions amongst different locate device, may in some instances result in significant discrepancies between detected location and physical locate marks. Accordingly, having documentation (e.g., an electronic record) of where physical locate marks were actually dispensed (i.e., what an excavator encounters when arriving to a work site) is notably more relevant to the assessment of liability in the event of damage and/or injury than where an underground facility was detected prior to marking.

Examples of marking devices configured to collect some types of information relating specifically to marking operations are provided in U.S. Patent Application Publication No. 2008/0228294-A1, entitled “Marking System and Method With Location and/or Time Tracking,” filed Mar. 13, 2007, and published Sep. 18, 2008; and U.S. Patent Application Publication No. 2008/0245299-A1, entitled “Marking System and Method,” filed Apr. 4, 2007, and published Oct. 9, 2008, both of which publications are incorporated herein by reference. These publications describe, amongst other things, collecting information relating to the geographic location, time, and/or characteristics (e.g., color/type) of dispensed marking material from a marking device and generating an electronic record based on this collected information. Applicants have recognized and appreciated that collecting information relating to both geographic location and color of dispensed marking material provides for automated correlation of geographic information for a locate mark to facility type (e.g., red=electric power lines and cables; blue=potable water; orange=telecommunication lines; yellow=gas, oil, steam); in contrast, in conventional locate devices equipped with GPS capabilities as discussed above, there is no apparent automated provision for readily linking GPS information for a detected facility to the type of facility detected.

Applicants have further appreciated and recognized that, in at least some instances, it may be desirable to document and/or monitor other aspects of the performance of a marking operation in addition to, or instead of, applied physical marks. One aspect of interest may be the motion of a marking device, since motion of the marking device may be used to determine, among other things, whether the marking operation was performed at all, a manner in which the marking operation was performed (e.g., quickly, slowly, smoothly, within standard operating procedures or not within standard operating procedures, in conformance with historical trends or not in conformance with historical trends, etc.), a characteristic of the particular technician performing the marking operation, accuracy of the marking device, and/or a location of marking material (e.g., paint) dispensed by the marking device. Thus, it may be desirable to document and/or monitor motion of the marking device during performance of a marking operation.

As with other applications of object tracking, various types of motion of a marking device may be of interest in any given scenario, and thus various devices (e.g., motion detectors) may be used for detecting the motion of interest. For instance, linear motion (e.g., motion of the marking device parallel to a ground surface under which one or more facilities are buried, e.g., a path of motion traversed by a bottom tip of the marking device as the marking device is moved by a technician along a target surface onto which marking material may be dispensed) and/or rotational (or “angular”) motion (e.g., rotation of a bottom tip of the marking device around a pivot point when the marking device is swung by a technician) may be of interest. Various types of sensors/detectors may be used to detect these types of motion.

As one example, an accelerometer may be used to collect acceleration data that may be converted into velocity data and/or position data so as to provide an indication of linear motion (e.g., along one, two, or three axes of interest) and/or rotational motion. As another example, an inertial motion unit (IMU), which typically includes multiple accelerometers and gyroscopes (e.g., three accelerometers and three gyroscopes such that there is one accelerometer and gyroscope for each of three orthogonal axes), and may also include an electronic compass, may be used to determine various characteristics of the motion of the marking device, such as velocity, orientation, heading direction (e.g., with respect to gravitational north in a north-south-east-west or “NSEW” reference frame) and gravitational forces.

Applicants have recognized and appreciated that motion of an object may also be determined at least in part by analyzing images of a target surface over which the object is moved (e.g., ground, pavement, and/or another target surface over which a marking device is moved by a technician and onto which target surface marking material may be dispensed such that a bottom tip of the marking device traverses a path of motion just above and along the target surface). To acquire such images of a target surface for analysis so as to determine motion (e.g., relative position) of a marking device, in some illustrative embodiments, a marking device is equipped with a camera system and image analysis software installed therein (hereafter called an “imaging-enabled marking device”) so as to provide “tracking information” representative of relative position of the marking device as a function of time. In certain embodiments, the camera system may include one or more digital video cameras. Alternatively, the camera system may include one or more optical flow chips and/or other components to facilitate acquisition of various image information and provision of tracking information based on analysis of the image information. For purposes of the present disclosure, the terms “capturing an image” or “acquiring an image” via a camera system refers to reading one or more pixel values of an imaging pixel array of the camera system when radiation reflected from a target surface within the camera system's field of view impinges on at least a portion of the imaging pixel array. Also, the term “image information” refers to any information relating to respective pixel values of the camera system's imaging pixel array (including the pixel values themselves) when radiation reflected from a target surface within the camera system's field of view impinges on at least a portion of the imaging pixel array.

In other embodiments, other devices may be used in combination with the camera system to provide such tracking information representative of relative position of the marking device as a function of time. These other devices may include, but are not limited to, an inertial measurement unit (IMU), a sonar range finder, an electronic compass, and any combinations thereof.

The camera system and image analysis software may be used for tracking motion and/or orientation of an object (e.g., the marking device). For example, the image analysis software may include algorithms for performing optical flow calculations based on the images of the target surface captured by the camera system. The image analysis software additionally may include one or more algorithms that are useful for performing optical flow-based dead reckoning. In one example, an optical flow algorithm is used for performing an optical flow calculation for determining the pattern of apparent motion of the camera system, which is representative of a relative position as a function of time of a bottom tip of the marking device as the marking device is carried/moved by a technician such that the bottom tip of the marking device traverses a path just above and along the target surface onto which marking material may be dispensed. Optical flow outputs provided by the optical flow calculations, and more generally information provided by image analysis software, may constitute or serve as a basis for tracking information representing the relative position as a function of time of the marking device (and more particularly the bottom tip of the marking device, as discussed above).

Dead reckoning is the process of estimating an object's current position based upon a previously determined position (also referred to herein as a “starting position,” a “reference position,” or a “last known position”), and advancing that position based upon known or estimated speeds over elapsed time (from which a linear distance traversed may be derived), and based upon direction (e.g., changes in heading relative to a reference frame, such as changes in a compass heading in a north-south-east-west or “NSEW” reference frame).

The optical flow-based dead reckoning that is used in connection with or incorporated in the imaging-enabled marking device of the present disclosure (as well as associated methods and systems) is useful for determining and recording the apparent motion (e.g., relative position as a function of time) of the camera system of the marking device (and therefore the marking device itself, and more particularly a path traversed by a bottom tip of the marking device) during underground facility locate operations and, thereby, track and log the movement that occurs during locate activities.

For example, upon arrival at the jobsite, a locate technician may activate the camera system and optical flow algorithm of the imaging-enabled marking device. Information relating to a starting position (or “initial position,” or “reference position,” or “last known position”) of the marking device (also referred to herein as “start position information”), such as latitude and longitude coordinates that may be obtained from any of a variety of sources (e.g., images or maps encoded by a geographic information system (GIS); a receiver for a satellite or pseudo-satellite (sometimes referred to as “pseudolite”) navigation system, such as a regional or global navigation satellite system (GNSS) like the United States' NAVSTAR Global Positioning System (GPS), Russia's Global Navigation Satellite System (GLONASS), China's BeiDou Navigation Satellite System (BDS), Japan's Quasi-Zenith Satellite System (QZSS), India's Regional Navigation Satellite System (IRNSS), the European Union's Galileo system, or some combination thereof; triangulation methods based on cellular telecommunications towers; multilateration techniques based on the time difference of arrival of radio signals from synchronized emitter and/or receiver sites of a communications system, etc.), is captured at the beginning of the locate operation and also may be acquired at various times during the locate operation (e.g., in some instances periodically at approximately one second intervals if a GNSS receiver is used).

The optical flow-based dead reckoning process may be performed throughout the duration of the locate operation with respect to one or more starting or initial positions obtained during the locate operation. Upon completion of the locate operation, the output of the optical flow-based dead reckoning process, which indicates the apparent motion of the marking device throughout the locate operation (e.g., the relative position as a function of time of the bottom tip of the marking device traversing a path along the target surface), is saved in the electronic records of the locate operation.

In another aspect, the present disclosure describes devices and methods for combining geo-location data with data from other sensors, for example, a marking device for and a method of combining geo-location data with data from other sensors for creating electronic records of locate operations. That is, the marking device of the present disclosure has a location tracking system incorporated therein. In one example, the location tracking system is a GNSS receiver. Additionally, the marking device of the present disclosure has one or more other sensors incorporated therein. In one example, the other sensors may include one or more digital video cameras and image analysis software for performing an optical flow-based dead reckoning process. Additionally, the image analysis software may include an optical flow algorithm for executing an optical flow calculation for determining the pattern of apparent motion of the camera system, which is representative of a relative position as a function of time of a bottom tip of the marking device as the marking device is carried/moved by a technician such that the bottom tip of the marking device traverses a path just above and along the target surface onto which marking material may be dispensed.

By use of the geo-location data, which indicates absolute location, in combination with data from one or more other sensors, which indicates relative location, an electronic record may be created that indicates the movement of the marking device during locate operations. In one example, the geo-location data of a GNSS receiver may be used as the primary source of the location information that is logged in the electronic records of locate operations. However, when the GNSS information becomes inaccurate, unreliable, and/or is essentially unavailable (e.g., due to environmental obstructions leading to an exceedingly low signal strength from one or more satellites), data from the one or more other sensors may be used as an alternative or additional source of the location information that is logged in the electronic records of locate operations. For example, an optical flow-based dead reckoning process may determine the current location (e.g., estimated position) relative to the last known “good” GNSS coordinates (i.e., “start position information” relating to a “starting position,” an “initial position,” a “reference position,” or a “last known position”).

In another example, data from the one or more other sensors may be used as the source of the location information that is logged in the electronic records of locate operations. However, a certain amount error may be accumulating over time, for example, in the optical flow-based dead reckoning process. Therefore, when the information in the DR-location data becomes inaccurate or unreliable (according to some predetermined criterion or criteria), and/or is essentially unavailable (e.g., due to inconsistent or otherwise poor image information arising from some types of target surfaces being imaged), geo-location data and/or data from one or more other sensors may be used as the source of the location information that is logged in the electronic records of locate operations. Accordingly, in some embodiments the source of the location information that is stored in the electronic records may toggle dynamically, automatically, and in real time between the location tracking system and one or more other sensors, based on the real-time status of a geo-location device (e.g. a GNSS receiver) and/or based on the real-time accuracy of the one or more other sensors.

In sum, one embodiment is directed to a method of monitoring the position of a marking device; comprising: A) receiving start position information indicative of an initial position of the marking device; B) capturing at least one image using at least one camera system attached to the marking device; C) analyzing the at least one image to determine tracking information indicative of a motion of the marking device; and D) analyzing the tracking information and the start position information to determine current position information indicative of a current position of the marking device.

Another embodiment is directed to a method of monitoring the position of a marking device traversing a path along a target surface, the method comprising: A) using a geo-location device, generating geo-location data indicative of positions of the marking device as it traverses at least a first portion of the path; B) using at least one camera system on the marking device to obtain an optical flow plot indicative of at least a portion of the path on the target surface traversed by the marking device; and C) generating dead reckoning data indicative of positions of the marking device as it traverses at least a second portion of the path based at least in part on the optical flow plot and at least one position of the marking device determined based on the geo-location data.

Another embodiment is directed to an apparatus comprising: a marking device for dispensing marking material onto a target surface, the marking device including: at least one camera system attached to the marking device; and control electronics communicatively coupled to the at least one camera system and comprising a processing unit configured to: A) receive start position information indicative of an initial position of the marking device; B) capture at least one image using the at least one camera system attached to the marking device; C) analyze the at least one image to determine tracking information indicative of the a motion of the marking device; and D) analyze the tracking information and the start position information to determine current position information indicative of a current position of the marking device.

Another embodiment is directed to an apparatus comprising: a marking device for dispensing marking material onto a target surface, the marking device including: at least one camera system attached to the marking device; and control electronics communicatively coupled to the at least one camera system and comprising a processing unit configured to: control a geo-location device to generate geo-location data indicative of positions of the marking device as it traverses at least a first portion of a path on the target surface; using the at least one camera system, obtain an optical flow plot indicative of at least a portion of the path on the target surface traversed by the marking device; and generate dead reckoning data indicative of positions of the marking device as it traverses at least a second portion of the path based at least in part on the optical flow plot and at least one position of the marking device determined based on the geo-location data.

Another embodiment is directed to a computer program product comprising a computer readable medium having a computer readable program code embodied therein, the computer readable program code adapted to be executed to implement a method comprising: A) receiving start position information indicative of an initial position of the marking device; B) capturing at least one image using at least one camera system attached to the marking device; C) analyzing the at least one image to determine tracking information indicative of the a motion of the marking device; and D) analyzing the tracking information and the start position information to determine current position information indicative of a current position of the marking device.

Another embodiment is directed to a computer program product comprising a computer readable medium having a computer readable program code embodied therein, the computer readable program code adapted to be executed to implement a method of monitoring the position of a marking device traversing a path along a target surface, the method comprising: A) using a geo-location device, generating geo-location data indicative of positions of the marking device as it traverses at least a first portion of the path; B) using at least one camera system on the marking device to obtain an optical flow plot indicative of at least a portion of the path on the target surface traversed by the marking device; and C) generating dead reckoning data indicative of positions of the marking device as it traverses at least a second portion of the path based at least in part on the optical flow plot and at least one position of the marking device determined based on the geo-location data.

For purposes of the present disclosure, the term “dig area” refers to a specified area of a work site within which there is a plan to disturb the ground (e.g., excavate, dig holes and/or trenches, bore, etc.), and beyond which there is no plan to excavate in the immediate surroundings. Thus, the metes and bounds of a dig area are intended to provide specificity as to where some disturbance to the ground is planned at a given work site. It should be appreciated that a given work site may include multiple dig areas.

The term “facility” refers to one or more lines, cables, fibers, conduits, transmitters, receivers, or other physical objects or structures capable of or used for carrying, transmitting, receiving, storing, and providing utilities, energy, data, substances, and/or services, and/or any combination thereof. The term “underground facility” means any facility beneath the surface of the ground. Examples of facilities include, but are not limited to, oil, gas, water, sewer, power, telephone, data transmission, cable television (TV), and/or Internet services.

The term “locate device” refers to any apparatus and/or device for detecting and/or inferring the presence or absence of any facility, including without limitation, any underground facility. In various examples, a locate device may include both a locate transmitter and a locate receiver (which in some instances may also be referred to collectively as a “locate instrument set,” or simply “locate set”).

The term “marking device” refers to any apparatus, mechanism, or other device that employs a marking dispenser for causing a marking material and/or marking object to be dispensed, or any apparatus, mechanism, or other device for electronically indicating (e.g., logging in memory) a location, such as a location of an underground facility. Additionally, the term “marking dispenser” refers to any apparatus, mechanism, or other device for dispensing and/or otherwise using, separately or in combination, a marking material and/or a marking object. An example of a marking dispenser may include, but is not limited to, a pressurized can of marking paint. The term “marking material” means any material, substance, compound, and/or element, used or which may be used separately or in combination to mark, signify, and/or indicate. Examples of marking materials may include, but are not limited to, paint, chalk, dye, and/or iron. The term “marking object” means any object and/or objects used or which may be used separately or in combination to mark, signify, and/or indicate. Examples of marking objects may include, but are not limited to, a flag, a dart, and arrow, and/or an RFID marking ball. It is contemplated that marking material may include marking objects. It is further contemplated that the terms “marking materials” or “marking objects” may be used interchangeably in accordance with the present disclosure.

The term “locate mark” means any mark, sign, and/or object employed to indicate the presence or absence of any underground facility. Examples of locate marks may include, but are not limited to, marks made with marking materials, marking objects, global positioning or other information, and/or any other means. Locate marks may be represented in any form including, without limitation, physical, visible, electronic, and/or any combination thereof.

The terms “actuate” or “trigger” (verb form) are used interchangeably to refer to starting or causing any device, program, system, and/or any combination thereof to work, operate, and/or function in response to some type of signal or stimulus. Examples of actuation signals or stimuli may include, but are not limited to, any local or remote, physical, audible, inaudible, visual, non-visual, electronic, mechanical, electromechanical, biomechanical, biosensing or other signal, instruction, or event. The terms “actuator” or “trigger” (noun form) are used interchangeably to refer to any method or device used to generate one or more signals or stimuli to cause or causing actuation. Examples of an actuator/trigger may include, but are not limited to, any form or combination of a lever, switch, program, processor, screen, microphone for capturing audible commands, and/or other devices or methods. An actuator/trigger may also include, but is not limited to, a device, software, or program that responds to any movement and/or condition of a user, such as, but not limited to, eye movement, brain activity, heart rate, other data, and/or the like, and generates one or more signals or stimuli in response thereto. In the case of a marking device or other marking mechanism (e.g., to physically or electronically mark a facility or other feature), actuation may cause marking material to be dispensed, as well as various data relating to the marking operation (e.g., geographic location, time stamps, characteristics of material dispensed, etc.) to be logged in an electronic file stored in memory. In the case of a locate device or other locate mechanism (e.g., to physically locate a facility or other feature), actuation may cause a detected signal strength, signal frequency, depth, or other information relating to the locate operation to be logged in an electronic file stored in memory.

The terms “locate and marking operation,” “locate operation,” and “locate” generally are used interchangeably and refer to any activity to detect, infer, and/or mark the presence or absence of an underground facility. In some contexts, the term “locate operation” is used to more specifically refer to detection of one or more underground facilities, and the term “marking operation” is used to more specifically refer to using a marking material and/or one or more marking objects to mark a presence or an absence of one or more underground facilities. The term “locate technician” refers to an individual performing a locate operation. A locate and marking operation often is specified in connection with a dig area, at least a portion of which may be excavated or otherwise disturbed during excavation activities.

The term “user” refers to an individual utilizing a locate device and/or a marking device and may include, but is not limited to, land surveyors, locate technicians, and support personnel.

The terms “locate request” and “excavation notice” are used interchangeably to refer to any communication to request a locate and marking operation. The term “locate request ticket” (or simply “ticket”) refers to any communication or instruction to perform a locate operation. A ticket might specify, for example, an address and/or a description of a dig area to be marked, a day and/or time that the dig area is to be marked, and/or whether the user is to mark the excavation area for certain gas, water, sewer, power, telephone, cable television, and/or some other underground facility. The term “historical ticket” refers to past tickets that have been completed.

The following U.S. applications are hereby incorporated herein by reference:

U.S. Patent Application Publication No. 2012/0065924-A1, published Mar. 15, 2012, corresponding to non-provisional U.S. patent application Ser. No. 13/210,291, filed Aug. 15, 2011, and entitled, “Methods, Apparatus and Systems for Surface Type Detection in Connection with Locate and Marking Operations;”

U.S. Patent Application Publication No. 2012/0069178-A1, published Mar. 22, 2012, corresponding to non-provisional U.S. patent application Ser. No. 13/236,162, filed Sep. 19, 2011, and entitled, “Methods and Apparatus for Tracking Motion and/or Orientation of a Marking Device;”

U.S. Patent Application Publication No. 2011/0007076, published Jan. 13, 2011, corresponding to non-provisional U.S. patent application Ser. No. 12/831,330, filed on Jul. 7, 2010, entitled “Methods, Apparatus and Systems for Generating Searchable Electronic Records of Underground Facility Locate and/or Marking Operations;”

Non-provisional U.S. patent application Ser. No. 13/210,237, filed Aug. 15, 2011, entitled “Methods and Apparatus for Marking Material Color Detection in Connection with Locate and Marking Operations;”

U.S. Patent Application Publication No. 2010/0117654, published May 13, 2010, corresponding to non-provisional U.S. patent application Ser. No. 12/649,535, filed on Dec. 30, 2009, entitled “Methods and Apparatus for Displaying an Electronic Rendering of a Locate and/or Marking Operation Using Display Layers;” and

U.S. Patent Application Publication No. 2013/0002854, published Jan. 3, 2013, corresponding to non-provisional U.S. patent application Ser. No. 13/462,794, filed on May 2, 2012, entitled “Marking Methods, Apparatus and Systems Including Optical Flow-Based Dead Reckoning Features.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

Other systems, processes, and features will become apparent to those skilled in the art upon examination of the following drawings and detailed description. It is intended that all such additional systems, processes, and features be included within this description, be within the scope of the present invention, and be protected by the accompanying claims.

### BRIEF DESCRIPTION OF DRAWINGS

The skilled artisan will understand that the figures, described herein, are for illustration purposes only, and that the drawings are not intended to limit the scope of the disclosed teachings in any way. In some instances, various aspects or features may be shown exaggerated or enlarged to facilitate an understanding of the inventive concepts disclosed herein (the drawings are not necessarily to scale, emphasis instead being placed upon illustrating the principles of the teachings). In the drawings, like reference characters generally refer to like features, functionally similar and/or structurally similar elements throughout the various figures.

FIG. 1 shows an example in which a locate and marking operation is initiated as a result of an excavator providing an excavation notice to a one-call center.

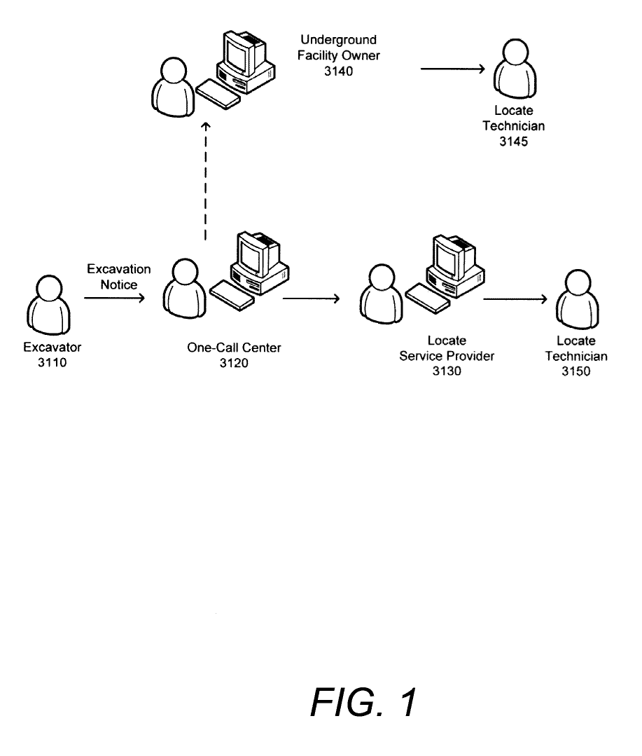

FIG. 2 illustrates one example of a conventional locate instrument set including a locate transmitter and a locate receiver.

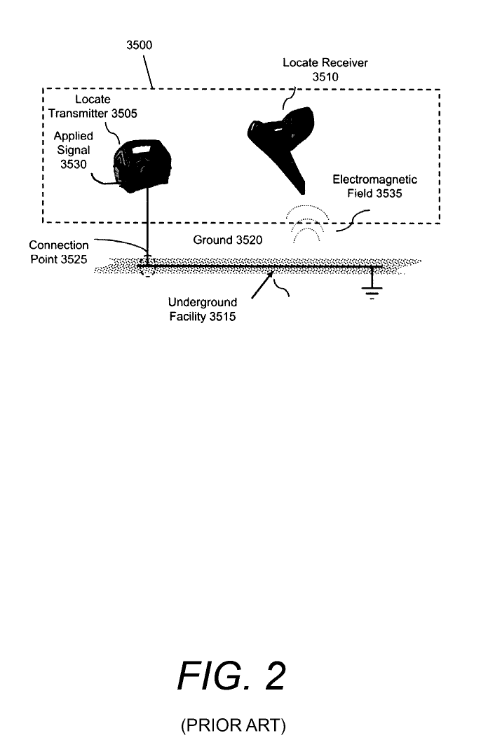

FIGS. 3A and 3B illustrate a conventional marking device in an actuated and non-actuated state, respectively.

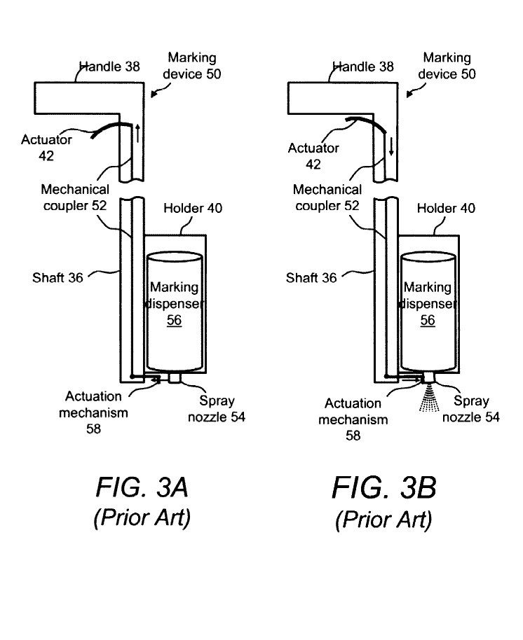

FIG. 4A shows a perspective view of an example of an imaging-enabled marking device that has a camera system and image analysis software installed therein for facilitating optical flow-based dead reckoning, according to some embodiments of the present disclosure.

FIG. 4B shows a block diagram of a camera system of the imaging-enabled marking device of FIG. 4A, according to one embodiment of the present disclosure.

FIG. 5 illustrates a functional block diagram of an example of the control electronics of the imaging-enabled marking device, according to the present disclosure.

FIG. 6 illustrates an example of a locate operations jobsite and an example of the path taken by the imaging-enabled marking device under the control of the user, according to the present disclosure.

FIG. 7 illustrates an example of an optical flow plot that represents the path taken by the imaging-enabled marking device, according to the present disclosure.

FIG. 8 illustrates a flow diagram of an example of a method of performing optical flow-based dead reckoning via an imaging-enabled marking device, according to the present disclosure.

FIG. 9A illustrates a view of an example of camera system data (e.g., a frame of image data) that shows velocity vectors overlaid thereon that indicate the apparent motion of the imaging-enabled marking device, according to the present disclosure.

FIG. 9B is a table showing various data involved in the calculation of updated longitude and latitude coordinates for respective incremental changes in estimated position of a marking device pursuant to an optical flow algorithm processing image information from a camera system, according to one embodiment of the present disclosure.

FIG. 10 illustrates a functional block diagram of an example of a locate operations system that includes a network of imaging-enabled marking devices, according to the present disclosure.

FIG. 11 illustrates a schematic diagram of an example of a camera configuration for implementing a range finder function on a marking device using a single camera, according to the present disclosure.

FIG. 12 illustrates a perspective view of an example of a geo-enabled and dead reckoning-enabled marking device for creating electronic records of locate operations, according to the present disclosure.

FIG. 13 illustrates a functional block diagram of an example of the control electronics of the geo-enabled and DR-enabled marking device, according to the present disclosure.

FIG. 14 illustrates an example of an aerial view of a locate operations jobsite and an example of an actual path taken by the geo-enabled and DR-enabled marking device during locate operations, according to the present disclosure.

FIG. 15 illustrates the aerial view of the example locate operations jobsite and an example of a GNSS-indicated path, which is the path taken by the geo-enabled and DR-enabled marking device during locate operations as indicated by geo-location data of the location tracking system, according to the present disclosure.

FIG. 16 illustrates the aerial view of the example locate operations jobsite and an example of a DR-indicated path, which is the path taken by the geo-enabled and DR-enabled marking device during locate operations as indicated by DR-location data of the optical flow-based dead reckoning process, according to the present disclosure.

FIG. 17 illustrates both the GNSS-indicated path and the DR-indicated path overlaid atop the aerial view of the example locate operations jobsite, according to the present disclosure.

FIG. 18 illustrates a portion of the GNSS-indicated path and a portion of the DR-indicated path that are combined to indicate the actual locate operations path taken by the geo-enabled and DR-enabled marking device during locate operations, according to the present disclosure.

FIG. 19 illustrates a flow diagram of an example of a method of combining geo-location data and DR-location data for creating electronic records of locate operations, according to the present disclosure.

FIG. 20 illustrates a functional block diagram of an example of a locate operations system that includes a network of geo-enabled and DR-enabled marking devices, according to the present disclosure.

FIG. 21 is a table showing various components and component vendors for the optical flow assembly electronics, according to the present disclosure.

FIG. 22 shows a perspective view of an example of an optical flow sensor placement on a marking device, according to the present disclosure.

FIG. 23 shows a perspective view of an example of a placement of components of an optical flow sensor on a marking device, according to the present disclosure.

FIG. 24 illustrates a method of combining data from a satellite with data from one or more sensors of velocity and/or distance traveled to refine what would otherwise be unreliable satellite data, according to the present disclosure.

FIG. 25 illustrates a state machine model of object movement, according to the present disclosure.

FIG. 26 illustrates a method used by a state machine model of object movement, according to the present disclosure.

### DETAILED DESCRIPTION

Following below are more detailed descriptions of various concepts related to, and embodiments of, inventive systems, marking methods and apparatus including optical flow-based dead reckoning features. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Although the discussion below involves a marking device (e.g., used for a locate operation, as discussed above) so as to illustrate the various inventive concepts disclosed herein relating to optical flow-based dead reckoning, it should be appreciated that the inventive concepts disclosed herein are not limited to applications in connection with a marking device; rather, any of the inventive concepts disclosed herein may be more generally applied to other devices and instrumentation used in connection with the performance of a locate operation to identify and/or mark a presence or an absence of one or more underground utilities. In particular, the inventive concepts disclosed herein may be similarly applied in connection with a locate transmitter and/or receiver, and/or a combined locate and marking device, examples of which are discussed in detail in U.S. Patent Application Publication No. 2010/0117654, published May 13, 2010, corresponding to non-provisional U.S. patent application Ser. No. 12/649,535, filed on Dec. 30, 2009, entitled “Methods and Apparatus for Displaying an Electronic Rendering of a Locate and/or Marking Operation Using Display Layers,” which publication is incorporated herein by reference in its entirety.

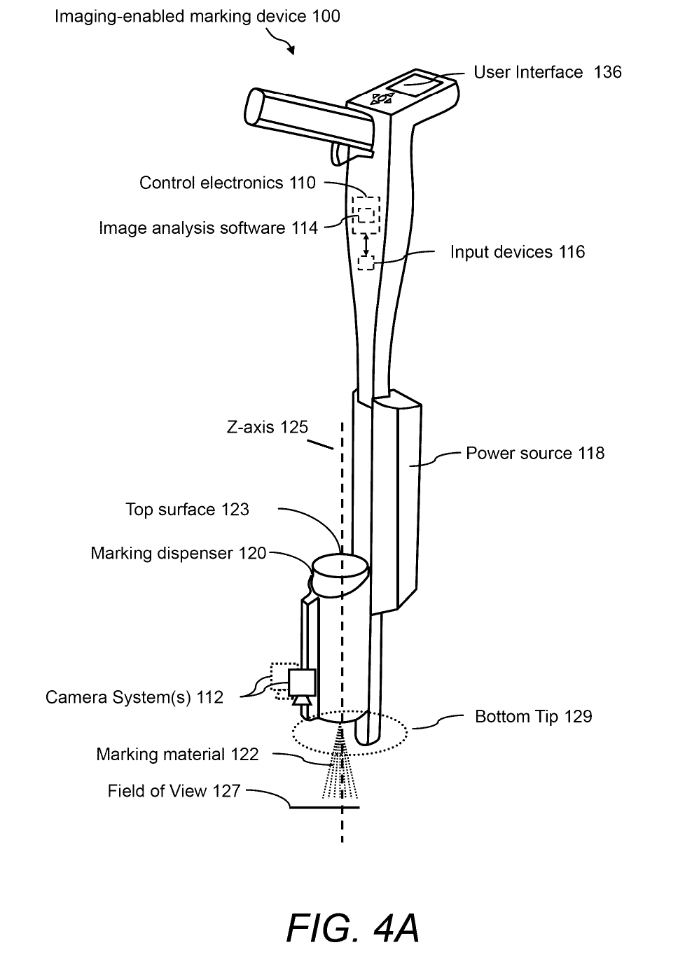

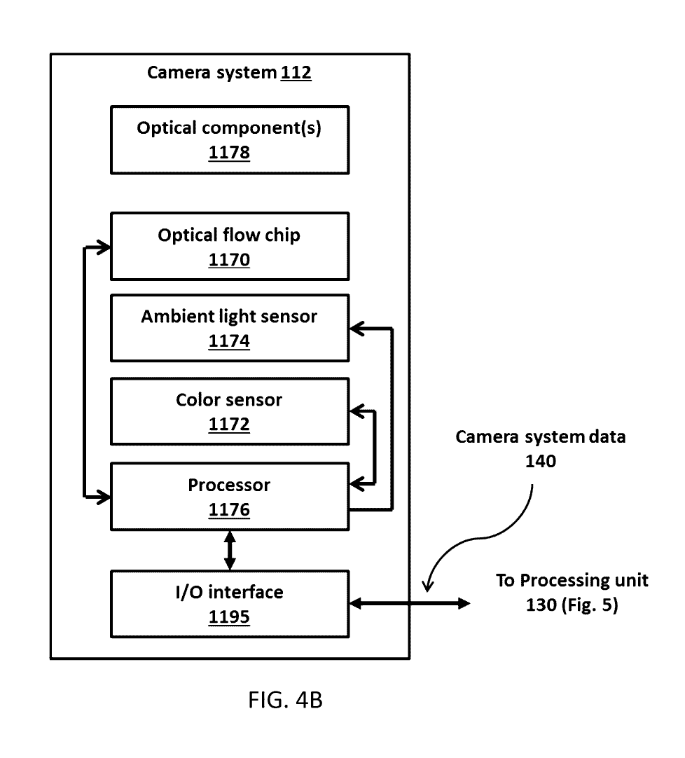

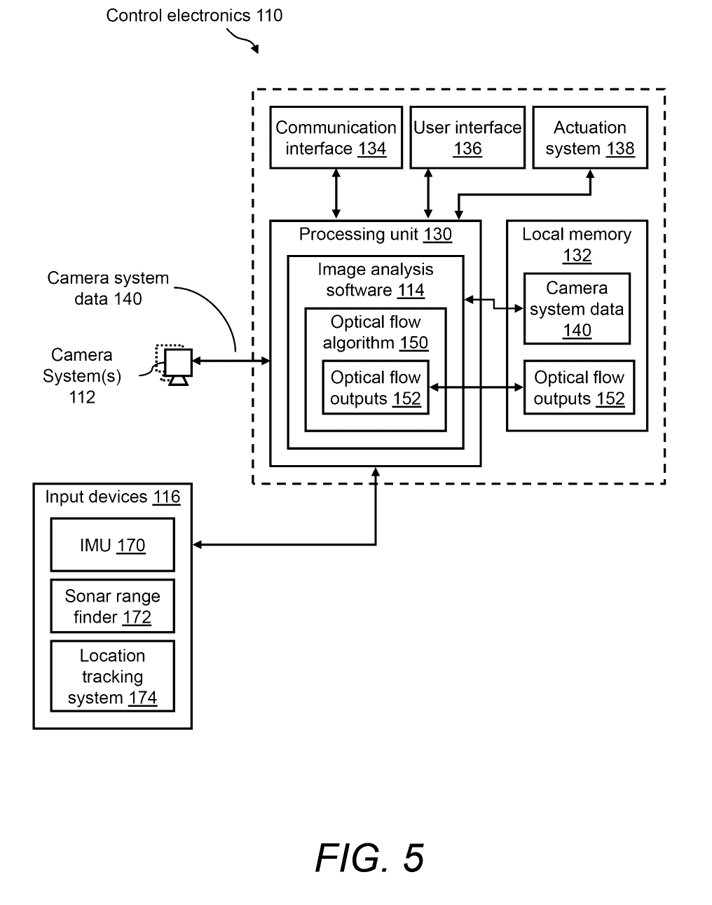

FIG. 4A illustrates a perspective view of an imaging-enabled marking device 100 with optical flow-based dead reckoning functionality, according to one embodiment of the present invention. In various aspects, the imaging-enabled marking device 100 is capable of creating electronic records of locate operations based at least in part on a camera system and image analysis software that is installed therein. The image analysis software may alternatively be remote from the marking device and operate on data uploaded from the marking device, either contemporaneously to collection of the data or at a later time. As shown in FIG. 4A, the marking device 100 also includes various control electronics 110, examples of which are discussed in greater detail below with reference to FIG. 5.

For purposes of the present disclosure, it should be appreciated that the terminology “camera system,” used in connection with a marking device, refers generically to any one or more components coupled to (e.g., mounted on and/or incorporated in) the marking device that facilitate acquisition of camera system data (e.g., image data) relevant to the determination of movement and/or orientation (e.g., relative position as a function of time) of the marking device. In some exemplary implementations, “camera system” also may refer to any one or more components that facilitate acquisition of image and/or color data relevant to the determination of marking material color in connection with a marking material dispensed by the marking device. In particular, the term “camera system” as used herein is not necessarily limited to conventional cameras or video devices (e.g., digital cameras or video recorders) that capture one or more images of the environment, but may also or alternatively refer to any of a number of sensing and/or processing components (e.g., semiconductor chips or sensors that acquire various data (e.g., image-related information) or otherwise detect movement and/or color without necessarily acquiring an image), alone or in combination with other components (e.g., semiconductor sensors alone or in combination with conventional image acquisition devices or imaging optics).

In certain embodiments, the camera system may include one or more digital video cameras. In one exemplary implementation, any time that imaging-enabled marking device is in motion, at least one digital video camera may be activated and image processing may occur to process information provided by the video camera(s) to facilitate determination of movement and/or orientation of the marking device. In other embodiments, as an alternative to or in addition to one or more digital video cameras, the camera system may include one or more digital still cameras, and/or one or more semiconductor-based sensors or chips (e.g., one or more color sensors, light sensors, optical flow chips) to provide various types of camera system data (e.g., including one or more of image information, non-image information, color information, light level information, motion information, etc.).

Similarly, for purposes of the present disclosure, the term “image analysis software” relates generically to processor-executable instructions that, when executed by one or more processing units or processors (e.g., included as part of control electronics of a marking device and/or as part of a camera system, as discussed further below), process camera system data (e.g., including one or more of image information, non-image information, color information, light level information, motion information, etc.) to facilitate a determination of one or more of marking device movement, marking device orientation, and marking material color. In some implementations, all or a portion of such image analysis software may also or alternatively be included as firmware in one or more special purpose devices (e.g., a camera system including one or more optical flow chips) so as to provide and or process camera system data in connection with a determination of marking device movement.

As noted above, in the marking device 100 illustrated in FIG. 4A, the one or more camera systems 112 may include any one or more of a variety of components to facilitate acquisition and/or provision of “camera system data” to the control electronics 110 of the marking device 100 (e.g., to be processed by image analysis software 114, discussed further below). The camera system data ultimately provided by camera system(s) 112 generally may include any type of information relating to a target surface onto which marking material may be dispensed, including information relating to marking material already dispensed on the surface, from which information a determination of marking device movement and/or orientation, and/or marking material color, may be made. Accordingly, it should be appreciated that such information constituting camera system data may include, but is not limited to, image information, non-image information, color information, surface type information, and light level information.

To this end, the camera system 112 may include any of a variety of conventional cameras (e.g., digital still cameras, digital video cameras), special purpose cameras or other image-acquisition devices (e.g., infra-red cameras), as well as a variety of respective components (e.g., semiconductor chips and/or sensors relating to acquisition of image-related data and/or color-related data), and/or firmware (e.g., including at least some of the image analysis software 114), used alone or in combination with each other, to provide information (e.g., camera system data). Generally speaking, the camera system 112 includes one or more imaging pixel arrays on which radiation impinges.

For purposes of the present disclosure, the terms “capturing an image” or “acquiring an image” via a camera system refers to reading one or more pixel values of an imaging pixel array of the camera system when radiation reflected from a target surface within the camera system's field of view impinges on at least a portion of the imaging pixel array. In this respect, the x-y plane corresponding to the camera system's field of view is “mapped” onto the imaging pixel array of the camera system. Also, the term “image information” refers to any information relating to respective pixel values of the camera system's imaging pixel array (including the pixel values themselves) when radiation reflected from a target surface within the camera system's field of view impinges on at least a portion of the imaging pixel array. With respect to pixel values, for a given pixel there may be one or more words of digital data representing an associated pixel value, in which each word may include some number of bits. In various examples, a given pixel may have one or more pixel values associated therewith, and each value may correspond to some measured or calculated parameter associated with the acquired image. For example, a given pixel may have three pixel values associated therewith respectively denoting a level of red color content (R), a level green color content (G) and a level of blue color content (B) of the radiation impinging on that pixel (referred to herein as an “RGB schema” for pixel values). Other schema for respective pixel values associated with a given pixel of an imaging pixel array of the camera system include, for example: “RGB+L,” denoting respective R, G, B color values, plus normalized CIE L* (luminance); “HSV,” denoting respective normalized hue, saturation and value components in the HSV color space; “CIE XYZ,” denoting respective X, Y, Z components of a unit vector in the CIE XYZ space; “CIE L*a*b*,” denoting respective normalized components in the CIE L*a*b* color space; and “CIE L*c*h*,” denoting respective normalized components in the CIE L*c*h* color space.

FIG. 4B illustrates a block diagram of one example of a camera system 112, according to one embodiment of the present invention. The camera system 112 of this embodiment may include one or more “optical flow chips” 1170, one or more color sensors 1172, one or more ambient light sensors 1174, one or more optical components 1178 (e.g., filters, lenses, polarizers), one or more controllers and/or processors 1176, and one or more input/output (I/O) interfaces 1195 to communicatively couple the camera system 112 to the control electronics 110 of the marking device 100 (e.g., and, more particularly, the processing unit 130, discussed further below). As illustrated in FIG. 4B, each of the optical flow chip(s), the color sensor(s), the ambient light sensor(s), and the I/O interface(s) may be coupled to the controller(s)/processors, wherein the controller(s)/processor(s) are configured to receive information provided by one or more of the optical flow chip(s), the color sensor(s), and the ambient light sensor(s), in some cases process and/or reformat all or part of the received information, and provide all or part of such information, via the I/O interface(s), to the control electronics 110 (e.g., processing unit 130) as camera system data 140.

While FIG. 4B illustrates each of an optical flow chip, a color sensor and an ambient light sensor, it should be appreciated that in other embodiments each of these components is not necessarily required in a camera system as contemplated according to the concepts disclosed herein. For example, in one embodiment, the camera system may include an optical flow chip 1170 (to provide one or more of color information, image information, and motion information), and optionally one or more optical components 1178, but need not necessarily include the color sensor 1172 or ambient light sensor 1174. Also, while not explicitly illustrated in FIG. 4B, it should be appreciated that various form factors and packaging arrangements are contemplated for the camera system 112, including different possible placements of one or more of the optical components 1178 with respect to one or more of the optical flow chip(s) 1170, the ambient light sensor(s) 1174, and the color sensor(s) 1172, for purposes of affecting in some manner (e.g., focusing, filtering, polarizing) radiation impinging upon one or more sensing/imaging elements of the camera system 112.

In one exemplary implementation of the camera system 112 shown in the embodiment of FIG. 4B, the optical flow chip 1170 includes an image acquisition device and may measure changes in position of the chip (i.e., as mounted on the marking device) by optically acquiring sequential images and mathematically determining the direction and magnitude of movement. To this end, in one embodiment, the optical flow chip 1170 may include some portion of the image analysis software 114 as firmware to facilitate analysis of sequential images (alternatively or in addition, some portion of the image analysis software 114 may be included as firmware and executed by the processor 1176 of the camera system, discussed further below, in connection with operation of the optical flow chip 1170). Exemplary optical flow chips may acquire images at up to 6400 times per second at 1600 counts (e.g., pixels) per inch (cpi), at speeds up to 40 inches per second (ips) and acceleration up to 15 g. In some examples, the optical flow chip may operate in one of two modes: 1) gray tone mode, in which the images are acquired as gray tone images, and 2) color mode, in which the images are acquired as color images. In some embodiments, the optical flow chip may operate in color mode and obviate the need for a separate color sensor, similarly to various embodiments employing a digital video camera (as discussed in greater detail below). In other embodiments, the optical flow chip may be used to provide information relating to whether the marking device is in motion or not.

Similarly, in one implementation of the camera system 112 shown in FIG. 4B, an exemplary color sensor 1172 may combine a photodiode, color filter, and transimpedance amplifier on a single die. In this example, the output of the color sensor may be in the form of an analog signal and provided to an analog-to-digital converter (e.g., as part of the processor 1176, or as dedicated circuitry not specifically shown in FIG. 4B) to provide one or more digital values representing color. In another example, the color sensor 1172 may be an integrated light-to-frequency converter (LTF) that provides RGB color sensing that is performed by a photodiode grid including 16 groups of 4 elements each. In this example, the output for each color may be a square wave whose frequency is directly proportional to the intensity of the corresponding color. Each group may include a red sensor, a green sensor, a blue sensor, and a clear sensor with no filter. Since the LTF provides a digital output, the color information may be input directly to the processor 1176 by sequentially selecting each color channel, then counting pulses or timing the period to obtain a value. In one embodiment, the values may be sent to processor 1176 and converted to digital values which are provided to the control electronics 110 of the marking device (e.g., the processing unit 130) via I/O interface 1195.

An exemplary ambient light sensor 1174 of the camera system 112 shown in FIG. 4B may include a silicon NPN epitaxial planar phototransistor in a miniature transparent package for surface mounting. The ambient light sensor 1174 may be sensitive to visible light much like the human eye and have peak sensitivity at, e.g., 570 nm. The ambient light sensor provides information relating to relative levels of ambient light in the area targeted by the positioning of the marking device.

An exemplary processor 1176 of the camera system 112 shown in FIG. 4B may include an ARM based microprocessor such as the STM32F103, available from STMicroelectronics (Geneva, Switzerland), or a PIC 24 processor such as the PIC24FJ256GA106-I/PT, available from Microchip Technology Inc. (Chandler, Ariz.). The processor may be configured to receive data from one or more of the optical flow chip(s) 1170, the color sensor(s) 1172, and the ambient light sensor(s) 1174, in some instances process and/or reformat received data, and to communicate with the processing unit 130. As noted above, the processor also or alternatively may store and execute firmware representing some portion of the image analysis software 114 (discussed in further detail below).

An I/O interface 1195 of the camera system 112 shown in FIG. 4B may be one of various wired or wireless interfaces such as those discussed further below with respect to communications interface 134 of FIG. 5. For example, in one implementation, the I/O interface may include a USB driver and port for providing data from the camera system 112 to processing unit 130.

In one exemplary implementation based on the camera system outlined in FIG. 4B, the one or more optical flow chips 1170 may be the ADNS-3080 chip, available from Avago Technologies (San Jose, Calif.). Alternative chips also available from Avago Technologies and similarly suitable for the optical flow chip shown in FIG. 4B include the ADNS-3060 chip, the ADNS-3090 chip, and the ADNS-5030 chip. The one or more color sensors 1172 may be selected as the TAOS TCS3210 sensor available from Texas Advanced Optoelectronic Solutions (now ams USA Inc. (Raleigh, N.C.)). The one or more ambient light sensors 1174 may be selected as the Vishay part number TEMT6000 available from Vishay (Shelton, Conn.). The one or more optical components 1178 may be selected as double convex coated lens having a diameter of approximately 12 millimeters and a focal length of approximately 25 millimeters, examples of which are available from Anchor Optics (Barrington, N.J.). Other types of optical components such as polarizing or neutral density filters may be employed, based at least in part on the type of target surface from which image information is being acquired.

With reference again to FIG. 4A, the camera system 112 may alternatively or additionally include one or more standard digital video cameras. The one or more digital video cameras may be any standard digital video cameras that have a frame rate and resolution that is suitable, preferably optimal, for use in imaging-enabled marking device 100. Each digital video camera may be a universal serial bus (USB) digital video camera. In one example, each digital video camera may be the Sony PlayStation®Eye video camera that has a 10-inch focal length and is capable of capturing 60 frames/second, where each frame is, for example, 640×480 pixels. In various embodiments, the digital output of the one or more digital video cameras serving as the camera system 112 may be stored in any standard or proprietary video file format (e.g., Audio Video Interleave (.AVI) format and QuickTime (.QT) format). In another example, only certain frames of the digital output of the one or more digital video cameras serving as the camera system 112 may be stored.

Also, while FIG. 4A illustrates a camera system 112 disposed generally near a bottom tip 129 of the marking device 100 and proximate to a marking dispenser 120 from which marking material 122 is dispensed onto a target surface, it should be appreciated that the invention is not limited in this respect, and that one or more camera systems 112 may be disposed in a variety of arrangements on the marking device 100. Generally speaking, the camera system 112 may be mounted on the imaging-enabled marking device 100 such that marking material dispensed on a target surface may be within some portion of the camera system's field of view (FOV). As shown in FIG. 4A, for purposes of generally specifying a coordinate reference frame for the camera system's field of view, a z-axis 125 is taken to be substantially parallel to a longitudinal axis of the marking device 100 and the marking dispenser 120 and generally along a trajectory of the marking material 122 when dispensed from the marking dispenser. In many instances, during use of the marking device 100 by a technician, the z-axis 125 shown in FIG. 4A is deemed also to be substantially parallel to a normal to the target surface onto which the marking material 122 is dispensed (e.g., substantially aligned with the Earth's gravitational vector). Given the foregoing, the camera system's FOV 127 is taken to be in an x-y plane that is substantially parallel to the target surface (e.g., just above the target surface, or substantially corresponding with the target surface) and perpendicular to the z-axis. For purposes of general illustration, FIG. 4A shows the FOV 127 from a perspective along an edge of the x-y plane, such that the FOV 127 appears merely as a line in the drawing; it should be appreciated, however, that the actual extent (e.g., boundaries) and area of the camera system's FOV 127 may vary from implementation to implementation and, as discussed further below, may depend on multiple factors (e.g., distance along the z-axis 125 between the camera system 112 and the target surface being imaged; various optical components included in the optical system).

In one example implementation, the camera system 112 may be placed about 10 to 13 inches from the target surface to be marked or traversed (e.g., as measured along the z-axis 125), when the marking device is held by a technician during normal use, so that the marking material dispensed on the target surface may be roughly centered horizontally in the camera system's FOV and roughly two thirds down from the top of the FOV. In this way, image data captured by the camera system 112 may be used to verify that marking material has been dispensed onto the target surface and/or determine a color of the marking material that has been dispensed. In other example implementations, the marking dispenser 120 is coupled to a “front facing” surface of the marking device 100 (e.g., essentially opposite to that shown in FIG. 4A), and the camera system may be mounted on a rear surface of the marking device, such that an optical axis of the camera system is substantially parallel to the z-axis 125 shown in FIG. 4A, and such that the camera system's FOV 127 is essentially parallel with the target surface on which marking material 122 is dispensed. In one example implementation, the camera system 112 may be mounted approximately in a center of a length of the marking device parallel to the z-axis 125; in another implementation, the camera system may be mounted approximately four inches above a top-most surface 123 of the inverted marking dispenser 120, and offset approximately two inches from the rear surface of the marking device 100. Again, it should be appreciated that various coupling arrangements and respective positions for one or more camera systems 112 and the marking device 100 are possible according to different embodiments.

In another aspect, the camera system 112 may operate in the visible spectrum or in any other suitable spectral range. For example, the camera system 112 may operate in the ultraviolet “UV” (10-400 nm), visible (380-760 nm), near infrared (750-2500 nm), infrared (750-1 mm), microwave (1-1000 mm), various sub-ranges and/or combinations of the foregoing, or other suitable portions of the electromagnetic spectrum.

In yet another aspect, the camera system 112 may be sensitive to light in a relatively narrow spectral range (e.g., light at wavelength within 10% of a central wavelength, 5% of a central wavelength, 1% of a central wavelength or less). The spectral range may be chosen based on the type of target surface to be marked, for example, to provide improved or maximized contrast or clarity in the images of the surface capture by the camera system 112.

In yet another embodiment, the camera system 112 may be integrated in a mobile/portable computing device that is communicatively coupled to, and may be mechanically coupled to and decoupled from, the imaging-enabled marking device 100. For example, the camera system 112 may be integrated in a hand-size or smaller mobile/portable device (e.g., a wireless telecommunications device, a “smart phone,” a personal digital assistant (PDA), etc.) that provides one or more processing, electronic storage, electronic display, user interface, communication facilities, and/or other functionality (e.g., GNSS-enabled functionality) for the marking device (e.g., at least some of the various functionality discussed below in connection with FIG. 5). In some exemplary implementations, the mobile/portable device may provide, via execution of processor-executable instructions or applications on a hardware processor of the mobile/portable device, and/or via retrieval of external instructions, external applications, and/or other external information via a communication interface of the mobile/portable device, essentially all of the processing and related functionality required to operate the marking device. In other implementations the mobile/portable device may only provide some portion of the overall functionality. In yet other implementations, the mobile/portable device may provide redundant, shared and/or backup functionality for the marking device to enhance robustness.

In one exemplary implementation, a mobile/portable device may be mechanically coupled to the marking device (e.g., via an appropriate cradle, harness, or other attachment arrangement) or otherwise integrated with the device and communicatively coupled to the device (e.g., via one or more wired or wireless connections), so as to permit one or more electronic signals to be communicated between the mobile/portable device and other components of the marking device. As noted above, a coupling position of the mobile/portable device may be based at least in part on a desired field of view for the camera system integrated with the mobile/portable device to capture images of a target surface.

One or more light sources (not shown) may be positioned on the imaging-enabled marking device 100 to illuminate the target surface. The light source may include a lamp, a light emitting diode (LED), a laser, a chemical illumination source, the light source may include optical elements such a focusing lens, a diffuser, a fiber optic, a refractive element, a reflective element, a diffractive element, a filter (e.g., a spectral filter or neutral density filter), etc.

As also shown in FIG. 4A, image analysis software 114 may reside at and execute on control electronics 110 of imaging-enabled marking device 100, for processing at least some of the camera system data 140 (e.g., digital video output) from the camera system 112. In various embodiments, as noted above, the image analysis software 114 may be configured to process information provided by one or more components of the camera system, such as one or more color sensors, one or more ambient light sensors, and/or one or more optical flow chips. Alternatively or in addition, as noted briefly above and discussed again further below, all or a portion of the image analysis software 114 may be included with and executed by the camera system 112 (even in implementations in which the camera system is integrated with a mobile/portable computing device), such that some of the camera system data 140 provided by the camera system is the result of some degree of “pre-processing” by the image analysis software 114 of various information acquired by one or more components of the camera system 112 (wherein the camera system data 140 may be further processed by other aspects of the image analysis software 114 resident on and/or executed by control electronics 110).

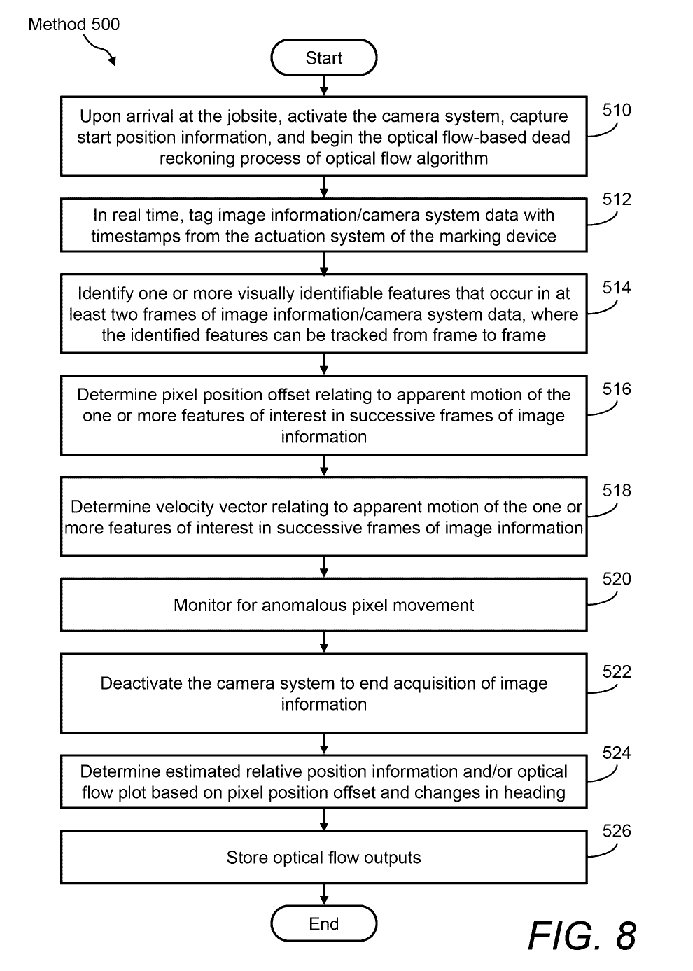

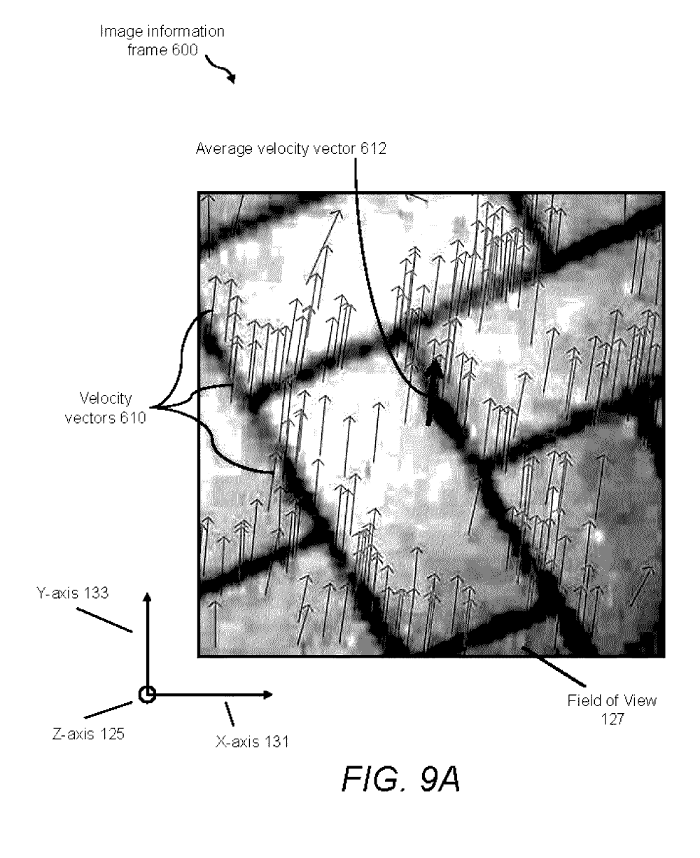

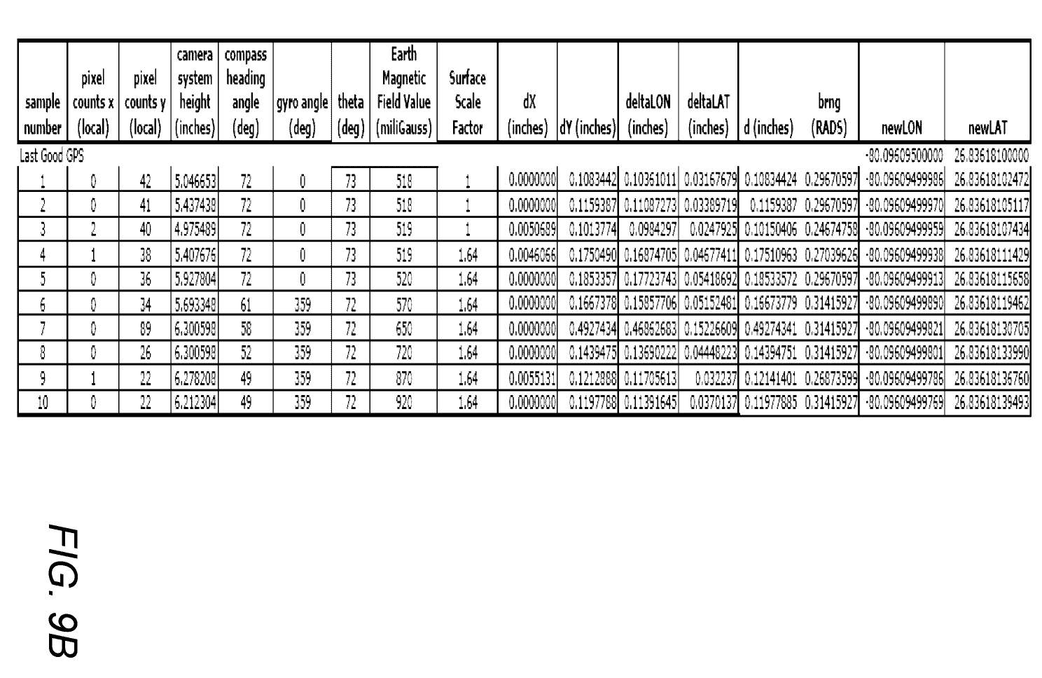

The image analysis software 114 may include one or more algorithms for processing camera system data 140, examples of which algorithms include, but are not limited to, an optical flow algorithm (e.g., for performing an optical flow-based dead reckoning process in connection with the imaging-enabled marking device 100), a pattern recognition algorithm, an edge-detection algorithm, a surface detection algorithm, and a color detection algorithm. Additional details of example algorithms that may be included in the image analysis software 114 are provided in part in the following U.S. applications: U.S. Patent Application Publication No. 2012/0065924-A1, published Mar. 15, 2012, corresponding to non-provisional U.S. patent application Ser. No. 13/210,291, filed Aug. 15, 2011, and entitled, “Methods, Apparatus and Systems for Surface Type Detection in Connection with Locate and Marking Operations;” U.S. Patent Application Publication No. 2012/0069178-A1, published Mar. 22, 2012, corresponding to non-provisional U.S. patent application Ser. No. 13/236,162, filed Sep. 19, 2011, and entitled, “Methods and Apparatus for Tracking Motion and/or Orientation of a Marking Device;” U.S. Patent Application Publication No. 2011/0007076, published Jan. 13, 2011, corresponding to non-provisional U.S. patent application Publication Ser. No. 12/831,330, filed on Jul. 7, 2010, entitled “Methods, Apparatus and Systems for Generating Searchable Electronic Records of Underground Facility Locate and/or Marking Operations;” and non-provisional U.S. patent application Ser. No. 13/210,237, filed Aug. 15, 2011, entitled “Methods and Apparatus for Marking Material Color Detection in Connection with Locate and Marking Operations,” each of which applications are incorporated by reference herein in their entirety. Details specifically relating to an optical flow algorithm also are discussed below, for example in connection with FIGS. 8 and 9.

The imaging-enabled marking device 100 of FIG. 4A may include other devices that may be useful in combination with the camera system 112 and image analysis software 114. For example, certain input devices 116 may be integrated into or otherwise connected (wired, wirelessly, etc.) to control electronics 110. Input devices 116 may be, for example, any systems, sensors, and/or devices that are useful for acquiring and/or generating data that may be used in combination with the camera system 112 and image analysis software 114 for any purpose. Additional details of examples of input devices 116 are described with reference to FIG. 5.

As also shown in FIG. 4A, various components of imaging-enabled marking device 100 may be powered by a power source 118. Power source 118 may be any power source that is suitable for use in a portable device, such as, but not limited to, one or more rechargeable batteries, one or more non-rechargeable batteries, a solar electrovoltaic panel, a standard AC power plug feeding an AC-to-DC converter, and the like.

A marking dispenser 120 (e.g., an aerosol marking paint canister) may be installed in imaging-enabled marking device 100, and marking material 122 may be dispensed from marking dispenser 120. Examples of marking materials may include, but are not limited to, paint, chalk, dye, and/or marking powder. As discussed above, in various implementations, one or more camera systems 112 may be mounted or otherwise coupled to the imaging-enabled marking device 100, generally proximate to the marking dispenser 120, so as to appropriately capture images of a target surface over which the marking device 100 traverses (and onto which the marking material 122 may be dispensed). More specifically, in some embodiments, an appropriate mounting position for one or more camera systems 112 ensures that a field of view (FOV) of the camera system covers the target surface traversed by the marking device, so as to facilitate tracking (e.g., via processing of camera system data 140) of a motion of the tip of imaging-enabled marking device 100 that is dispensing marking material 122.

Referring to FIG. 5, a functional block diagram of an example of control electronics 110 of imaging-enabled marking device 100 according to one embodiment of the present invention is presented. In this example, control electronics 110 may include, but is not limited to, the image analysis software 114 shown in FIG. 4A, a processing unit 130, a quantity of local memory 132, a communication interface 134, a user interface 136, and an actuation system 138.

Image analysis software 114 may be programmed into processing unit 130 (e.g., the software may be stored all or in part on the local memory 132 and downloaded/accessed by the processing unit 130, and/or may be downloaded/accessed by the processing unit 130 via the communication interface 134 from an external source). Also, although FIG. 5 illustrates the image analysis software 114 including the optical flow algorithm 150 “resident” on and executed by the processing unit 130 of control electronics 110, as noted above it should be appreciated that in other embodiments according to the present invention, all or a portion of the image analysis software may be resident on (e.g., as “firmware”) and executed by the camera system 112 itself. In particular, with reference again to the camera system 112 shown in FIG. 4B, in one embodiment employing one or more optical flow chips 1170 and/or processor 1176, all or a portion of the image analysis software 114 (and all or a portion of the optical flow algorithm 150) may be executed by the optical flow chip(s) 1170 and/or the processor 1176, such that at least some of the camera system data 140 provided by the camera system 112 constitutes “pre-processed” information (e.g., relating to information acquired by various components of the camera system 112), which camera system data 140 may be further processed by the processing unit 130 according to various concepts discussed herein.

Referring again to FIG. 5, processing unit 130 may be any general-purpose processor, controller, or microcontroller device that is capable of managing the overall operations of imaging-enabled marking device 100, including managing data that is returned from any component thereof. Local memory 132 may be any volatile or non-volatile data storage device, such as, but not limited to, a random access memory (RAM) device and a removable memory device (e.g., a USB flash drive).

The communication interface 134 may be any wired and/or wireless communication interface for connecting to a network (not shown) and by which information (e.g., the contents of local memory 132) may be exchanged with other devices connected to the network. Examples of wired communication interfaces may include, but are not limited to, USB protocols, RS232 protocol, RS422 protocol, IEEE 1394 protocol, Ethernet protocols, and any combinations thereof. Examples of wireless communication interfaces may include, but are not limited to, an Intranet connection; an Internet connection; radio frequency (RF) technology, such as, but not limited to, Bluetooth®, ZigBee®, Wi-Fi, Wi-Max, IEEE 802.11; and any cellular protocols; Infrared Data Association (IrDA) compatible protocols; optical protocols (i.e., relating to fiber optics); Local Area Networks (LAN); Wide Area Networks (WAN); Shared Wireless Access Protocol (SWAP); any combinations thereof; and other types of wireless networking protocols.

User interface 136 may be any mechanism or combination of mechanisms by which the user may operate imaging-enabled marking device 100 and by which information that is generated by imaging-enabled marking device 100 may be presented to the user. For example, user interface 136 may include, but is not limited to, a display, a touch screen, one or more manual pushbuttons, one or more light-emitting diode (LED) indicators, one or more toggle switches, a keypad, an audio output (e.g., speaker, buzzer, and alarm), a wearable interface (e.g., data glove), a mobile telecommunications device or a portable computing device (e.g., a smart phone, a tablet computer, a personal digital assistant, etc.) communicatively coupled to or included as a constituent element of the marking device 100, and any combinations thereof.

Actuation system 138 may include a mechanical and/or electrical actuator mechanism (not shown) that may be coupled to an actuator that causes the marking material to be dispensed from the marking dispenser of imaging-enabled marking device 100. Actuation means starting or causing imaging-enabled marking device 100 to work, operate, and/or function. Examples of actuation may include, but are not limited to, any local or remote, physical, audible, inaudible, visual, non-visual, electronic, electromechanical, biomechanical, biosensing or other signal, instruction, or event. Actuations of imaging-enabled marking device 100 may be performed for any purpose, such as, but not limited to, for dispensing marking material and for capturing any information of any component of imaging-enabled marking device 100 without dispensing marking material. In one example, an actuation may occur by pulling or pressing a physical trigger of imaging-enabled marking device 100 that causes the marking material to be dispensed.

FIG. 5 also shows one or more camera systems 112 connected to control electronics 110 of imaging-enabled marking device 100. In particular, camera system data 140 (e.g., which in some instances may be successive frames of a video, in .AVI and .QT file format) from the camera system 112 is passed to processing unit 130 and processed by image analysis software 114. Further, camera system data 140 may be stored in local memory 132.

FIG. 5 shows that image analysis software 114 may include one or more algorithms, including for example an optical flow algorithm 150 for performing an optical flow calculation to determine a pattern of apparent motion of the camera system 112 and, hence, the marking device 100 (e.g., the optical flow calculation facilitates determination of estimated position along a path traversed by the bottom tip 129 of the marking device 100 shown in FIG. 4A, when carried/used by a technician, along a target surface onto which marking material 122 may be dispensed). In one example, optical flow algorithm 150 may use the Pyramidal Lucas-Kanade method for performing the optical flow calculation. An optical flow calculation typically entails the process of indentifying features (or groups of features) in common to at least two frames of image data (e.g., constituting at least part of the camera system data 140) and, therefore, can be tracked from frame to frame. With reference again to FIG. 4A, recall that the camera system 112 acquires images within its field of view (FOV), e.g., in an x-y plane parallel to (or substantially coincident with) a target surface over which the marking device is moved, so as to provide image information (e.g., that may be subsequently processed by the image analysis software 114, wherever resident or executed). In one embodiment, optical flow algorithm 150 processes image information relating to acquired images by comparing the x-y position (in pixels) of the common feature(s) in the at least two frames and determines at least the change (or offset) in x-y position of the common feature(s) from one frame to the next (in some instances, as discussed further below, the direction of movement of the camera system and hence the marking device is determined as well, e.g., via an electronic compass or inertial motion unit (IMU), in conjunction with the change in x-y position of the common feature(s) in successive frames). In some implementations, the optical flow algorithm 150 alternatively or additionally may generate a velocity vector for each common feature, which represents the movement of the feature from one frame to the next frame. Additional details of velocity vectors are described with reference to FIG. 9.

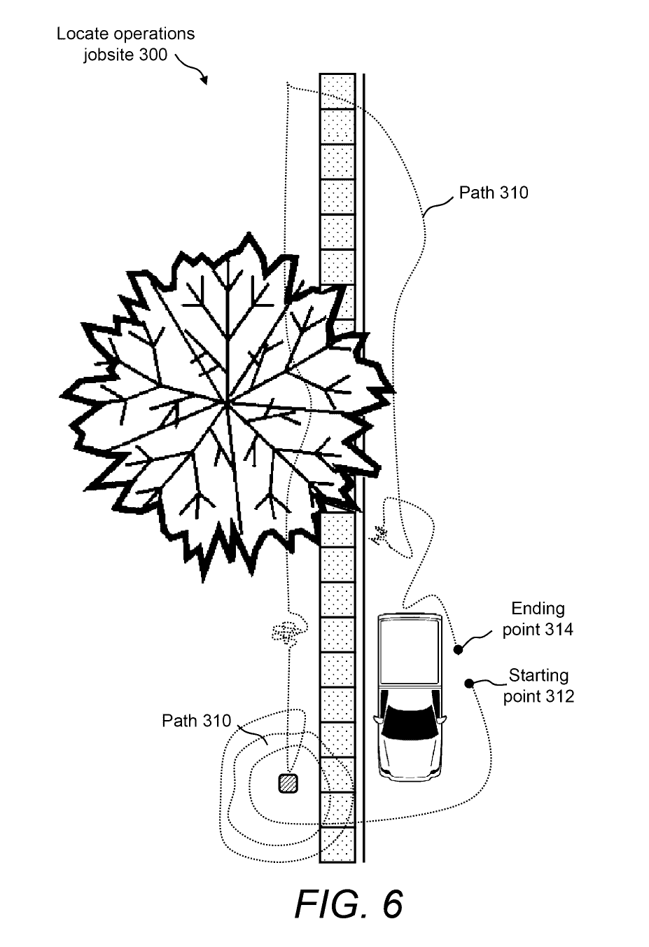

One or more results of the optical flow calculation of optical flow algorithm 150 may be saved as optical flow outputs 152. Optical flow outputs 152 may include the “raw” data generated by optical flow algorithm 150 (e.g., estimates of relative position), and/or graphical representations of the raw data. Optical flow outputs 152 may be stored in local memory 132. Additionally, to provide additional information that may be useful in combination with the optical flow-based dead reckoning process, the information in optical flow outputs 152 may be tagged with actuation-based time-stamps from actuation system 138. These actuation-based time-stamps are useful to indicate when marking material is dispensed during locate operations with respect to the estimated relative position data provided by optical flow algorithm. For example, the information in optical flow outputs 152 may be tagged with time-stamps for each actuation-on event and each actuation-off event of actuation system 138. Additional details of examples of the contents of optical flow outputs 152 of optical flow algorithm 150 are described with reference to FIGS. 6 through 9. Additional details of an example method of performing the optical flow calculation are described with reference to FIG. 8.

FIG. 5 also shows certain input devices 116 connected to control electronics 110 of imaging-enabled marking device 100. For example, input devices 116 may include, but are not limited to, at least one or more of the following types of devices: an inertial measurement unit (IMU) 170, a sonar range finder 172, and a location tracking system 174.

An IMU is an electronic device that measures and reports an object's acceleration, orientation, and/or gravitational forces by use of one or more inertial sensors, such as one or more accelerometers, gyroscopes, and compasses. IMU 170 may be any commercially available IMU device for reporting the acceleration, orientation, and gravitational forces of any device in which it is installed. In one example, IMU 170 may be the IMU 6 Degrees of Freedom (6DOF) device, which is available from SparkFun Electronics (Boulder, Colo.). This SparkFun IMU 6DOF device has Bluetooth® capability and provides 3 axes of acceleration data, 3 axes of gyroscopic data, and 3 axes of magnetic data. An angle measurement from IMU 170 may support an angle input parameter of optical flow algorithm 150, which is useful for accurately processing camera system data 140, as described with reference to the method of FIG. 8. Other examples of IMUs suitable for purposes of the present invention include, but are not limited to, the OS5000 family of electronic compass devices available from OceanServer Technology, Inc. (Fall River, Mass.), the MPU6000 family of devices available from Invensense (San Jose, Calif.), and the GEDC-6 attitude heading reference system available from Sparton (DeLeon Springs, Fla.).

In one implementation, an IMU 170 including an electronic compass may be situated in/on the marking device such that a particular heading of the IMU's compass (e.g., magnetic north) is substantially aligned with one of the x or y axes of the camera system's FOV. In this manner, the IMU may measure changes in rotation of the camera system's FOV relative to a coordinate reference frame specified by N-S-E-W, i.e., north, south, east and west (e.g., the IMU may provide a heading angle “theta,” i.e., θ, between one of the x and y axes of the camera system's FOV and magnetic north). In other implementations, multiple IMUs 170 may be employed for the marking device 100; for example, a first IMU may be disposed proximate to the bottom tip 129 of the marking device (from which marking material is dispensed, as shown in FIG. 4A) and a second IMU may be disposed proximate to a top end of the marking device (e.g., proximate to the user interface 136 shown in FIG. 4A).

A sonar (or acoustic) range finder is an instrument for measuring distance from the observer to a target. In one example, sonar range finder 172 may be the Maxbotix LV-MaxSonar-EZ4 Sonar Range Finder MB1040 from Pololu Corporation (Las Vegas, Nev.), which is a compact sonar range finder that can detect objects from 0 to 6.45 m (21.2 ft) with a resolution of 2.5 cm (1″) for distances beyond 15 cm (6″). In one implementation, sonar range finder 172 is mounted in/on the marking device 100 such that a z-axis of the range finder is substantially parallel to the z-axis 125 shown in FIG. 4A (i.e., an x-y plane of the range finder is substantially parallel to the FOV 127 of the camera system 112), and such that the range finder is at a known distance along a length of the marking device with respect to the camera system 112. Accordingly, sonar range finder 172 may be employed to measure a distance (or “height” H) between the camera system 112 and the target surface traversed by the marking device, along the z-axis 125 shown in FIG. 4A. In one example, the distance measurement from sonar range finder 172 (the height H) may provide a distance input parameter of optical flow algorithm 150, which is useful for accurately processing camera system data 140, as described below with reference to the method of FIG. 8.

Location tracking system 174 may include any geo-location device that can determine its geographical location to a certain degree of accuracy. For example, location tracking system 174 may include a GNSS receiver, such as a Global Positioning System (GPS) receiver. A GPS receiver may provide, for example, any standard format data stream, such as a National Marine Electronics Association (NMEA) data stream. Location tracking system 174 may also include an error correction component (not shown), which may be any mechanism for improving the accuracy of the geo-location data. When performing the optical flow-based dead reckoning process, geo-location data from location tracking system 174 may be used for capturing a “starting” position (also referred to herein as an “initial” position, a “reference” position or a “last-known” position) of imaging-enabled marking device 100 (e.g., a position along a path traversed by the bottom tip of the marking device over a target surface onto which marking material may be dispensed), from which starting (or “initial,”, or “reference” or “last-known”) position subsequent positions of the marking device may be determined pursuant to the optical flow-based dead reckoning process.

In one exemplary implementation, the location tracking system 174 may include an ISM300F2-C5-V0005 GPS module (available from Inventek Systems, LLC (Westford, Mass.). The Inventek GPS module includes two UARTs (universal asynchronous receiver/transmitter) for communication with the processing unit 130, supports both the SIRF Binary and NMEA-0183 protocols (depending on firmware selection), and has an information update rate of 5 Hz. A variety of geographic location information may be requested by the processing unit 130 and provided by the GPS module to the processing unit 130 including, but not limited to, time (coordinated universal time—UTC), date, latitude, north/south indicator, longitude, east/west indicator, number and identification of satellites used in the position solution, number and identification of GPS satellites in view and their elevation, azimuth and signal-to-noise-ratio (SNR) values, and dilution of precision (DOP) values. Accordingly, it should be appreciated that in some implementations the location tracking system 174 may provide a wide variety of geographic information as well as timing information (e.g., one or more time stamps) to the processing unit 130, and it should also be appreciated that any information available from the location tracking system 174 (e.g., any information available in various NMEA data messages, such as coordinated universal time, date, latitude, north/south indicator, longitude, east/west indicator, number and identification of satellites used in the position solution, number and identification of GPS satellites in view and their elevation, azimuth and SNR values, dilution of precision values) may be included in electronic records of a locate operation (e.g., logged locate information).

In one implementation, the imaging-enabled marking device 100 may include two or more camera systems 112 that are mounted in any useful configuration. For example, the two camera systems 112 may be mounted side-by-side, one behind the other, in the same plane, not in the same plane, and any combinations thereof. In one example, the respective FOVs of the two camera systems slightly overlap, regardless of the mounting configuration. In another example, an optical flow calculation may be performed on camera system data 140 provided by both camera systems so as to increase the overall accuracy of the optical flow-based dead reckoning process of the present disclosure.

In another example, in place of or in combination with sonar range finder 172, two camera systems 112 may be used to perform a range finding function, which is to determine the distance between a certain camera system and the target surface traversed by the marking device. More specifically, the two camera systems may be used to perform a stereoscopic (or stereo vision) range finder function, which is well known. For range finding, the two camera systems may be placed some distance apart so that the respective FOVs may have a desired percent overlap (e.g., 50%-66% overlap). In this scenario, the two camera systems may or may not be mounted in the same plane.

In yet another example involving multiple camera systems 112 employed with the marking device 100, one camera system may be mounted in a higher plane (parallel to the target surface) than another camera system with respect to the target surface. In this example, one camera system accordingly is referred to as a “higher” camera system and the other is referred to as a “lower” camera system. The higher camera system has a larger FOV for capturing more information about the surrounding environment. That is, the higher camera system may capture features that are not within the field of view of the lower camera system (which camera has a smaller FOV). For example, the higher camera system may capture the presence of a curb nearby or other markings nearby, which may provide additional context to the marking operation. In this scenario, the FOV of the higher camera system may include 100% of the FOV of the lower camera system. By contrast, the FOV of the lower camera system may include only a small portion (e.g., about 33%) of the FOV of the higher camera system. In another aspect, the higher camera system may have a lower frame rate but higher resolution as compared with the lower camera system (e.g., the higher camera system may have a frame rate of 15 frames/second and a resolution of 2240×1680 pixels, while the lower camera system may have a frame rate of 60 frames/second and a resolution of 640×480 pixels). In this configuration of multiple camera systems, the range finding function may occur at the slower frame rate of 15 frames/second, while the optical flow calculation may occur at the faster frame rate of 60 frames/second.

Referring to FIG. 6, an example of a locate operations jobsite 300 and an example of the path taken by imaging-enabled marking device 100 under the control of the user is presented. In this example, present at locate operations jobsite 300 may be a sidewalk that runs along a street. An underground facility pedestal and a tree are present near the sidewalk. FIG. 6 also shows a vehicle, which is the vehicle of the locate technician (not shown), parked on the street near the underground facility pedestal.

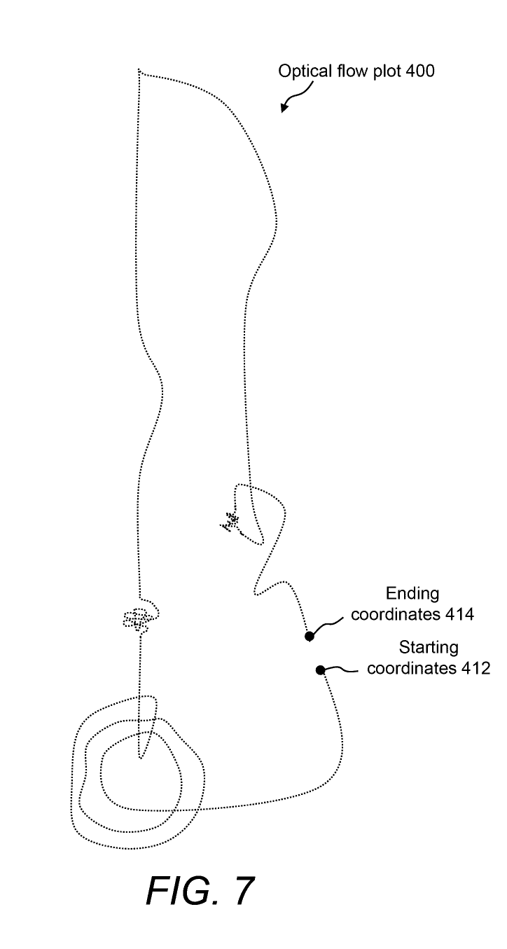

A path 310 is indicated at locate operations jobsite 300. Path 310 indicates the path taken by imaging-enabled marking device 100 under the control of the user while performing the locate operation (e.g., a path traversed by the bottom tip of the marking device along a target surface onto which marking material may be dispensed). Path 310 has a starting point 312 and an ending point 314. More specifically, path 310 indicates the continuous path taken by imaging-enabled marking device 100 between starting point 312, which is the beginning of the locate operation, and ending point 314, which is the end of the locate operation. Starting point 312 may indicate the position of imaging-enabled marking device 100 when first activated upon arrival at locate operations jobsite 300. By contrast, ending point 314 may indicate the position of imaging-enabled marking device 100 when deactivated upon departure from locate operations jobsite 300. The optical flow-based dead reckoning process of optical flow algorithm 150 is tracking the apparent motion of imaging-enabled marking device 100 along path 310 from starting point 312 to ending point 314 (e.g., estimating the respective positions of the bottom tip of the marking device along the path 310). Additional details of an example of the output of optical flow algorithm 150 for estimating respective positions along the path 310 of FIG. 6 are described with reference to FIG. 7.

Referring to FIG. 7, an example of an optical flow plot 400 that represents estimated relative positions along the path 310 of FIG. 6 traversed by imaging-enabled marking device 100 is presented. Associated with optical flow plot 400 is starting coordinates 412, which represent “start position information” associated with a “starting position” of the marking device (also referred to herein as an “initial position,” a “reference position,” or a “last-known position”); in the illustration of FIG. 7, the starting coordinates 412 correspond to the starting point 312 of path 310 shown in FIG. 6.

For purposes of the present disclosure, “start position information” associated with a “starting position,” an “initial position,” a “reference position,” or a “last-known position” of a marking device, when used in connection with an optical flow-based dead reckoning process for an imaging-enabled marking device, refers to geographical information that serves as a basis from which the dead reckoning process is employed to estimate subsequent relative positions of the marking device (also referred to herein as “apparent motion” of the marking device). As discussed in further detail below, the start position information may be obtained from any of a variety of sources, and often is constituted by geographic coordinates in a particular reference frame (e.g., GNSS latitude and longitude coordinates). In one example, start position information may be determined from geo-location data of location tracking system 174, as discussed above in connection with FIG. 5. In other examples, start position information may be obtained from a geographic information system (GIS)-encoded image (e.g., an aerial image or map), in which a particular point in the GIS-encoded image may be specified as coinciding with the starting point of a path traversed by the marking device, or may be specified as coinciding with a reference point (e.g., an environmental landmark, such as a telephone pole, a mailbox, a curb corner, a fire hydrant, or other geo-referenced feature) at a known distance and direction from the starting point of the path traversed by the marking device.

As also shown in FIG. 7, associated with optical flow plot 400 is ending coordinates 414, which may be determined by the optical flow calculations of optical flow algorithm 150 based at least in part on the starting coordinates 412 (corresponding to start position information serving as a basis from which the dead reckoning process is employed to estimate subsequent relative positions of the marking device). In the example of FIG. 7, ending coordinates 414 of optical flow plot 400 substantially correspond to ending point 314 of path 310 of FIG. 6. As discussed further below, however, practical considerations in implementing the optical flow algorithm 150 over appreciable differences traversed by the marking device may result in some degree of error in the estimated relative position information provided by optical flow outputs 152 of the optical flow algorithm 150 (such that the ending coordinates 414 of the optical flow plot 400 may not coincide precisely with the ending point 314 of the actual path 310 traversed by the marking device).

In one example, optical flow algorithm 150 generates optical flow plot 400 by continuously determining the x-y position offset of certain groups of pixels from one frame to the next in image-related information acquired by the camera system, in conjunction with changes in heading (direction) of the marking device (e.g., as provided by the IMU 170) as the marking device traverses the path 310. Optical flow plot 400 is an example of a graphical representation of “raw” estimated relative position data that may be provided by optical flow algorithm 150 (e.g., as a result of image-related information acquired by the camera system and heading-related information provided by the IMU 170 being processed by the algorithm 150). Along with the “raw” estimated relative position data itself, the graphical representation, such as optical flow plot 400, may be included in the contents of the optical flow output 152 for this locate operation. Additionally, “raw” estimated relative position data associated with optical flow plot 400 may be tagged with timestamp information from actuation system 138, which indicates when marking material is being dispensed along path 310 of FIG. 6.

FIG. 8 illustrates a flow diagram of an example method 500 of performing optical flow-based dead reckoning via execution of the optical flow algorithm 150 by an imaging-enabled marking device 100. Method 500 may include, but is not limited to, the following steps, which are not limited to any order, and not all of which steps need necessarily performed according to different embodiments.

At step 510, the camera system 112 is activated (e.g., the marking device 100 is powered-up and its various constituent elements begin to function), and an initial or starting position is captured and/or entered (e.g., via a GNSS location tracking system or GIS-encoded image, such as an aerial image or map) so as to provide “start position information” serving as a basis for relative positions estimated by the method 500. For example, upon arrival at the jobsite, a user, such as a locate technician, activates imaging-enabled marking device 100, which automatically activates the camera system 112, the processing unit 130, the various input devices 116, and other constituent elements of the marking device. Start position information representing a starting position of the marking device may be obtained as the current latitude and longitude coordinates from location tracking system 174 and/or by the user/technician manually entering the current latitude and longitude coordinates using user interface 136 (e.g., which coordinates may be obtained with reference to a GIS-encoded image). As noted above, an example of an start position information is starting coordinates 412 of optical flow plot 400 of FIG. 7.

Subsequently, optical flow algorithm 150 begins acquiring and processing image information acquired by the camera system 112 and relating to the target surface (e.g., successive frames of image data including one or more features that are present within the camera system's field of view). As discussed above, the image information acquired by the camera system 112 may be provided as camera system data 140 that is then processed by the optical flow algorithm; alternatively, in some embodiments, image information acquired by the camera system is pre-processed to some extent by the optical flow algorithm 150 resident as firmware within the camera system (e.g., as part of an optical flow chip 1170, shown in FIG. 4B), and pre-processed image information may be provided by the camera system 112 as a constituent component (or all of) the camera system data 140.

At step 512, the camera system data 140 optionally may be tagged in real time with timestamps from actuation system 138. For example, certain information (e.g., representing frames of image data) in the camera system data 140 may be tagged in real time with “actuation-on” timestamps from actuation system 138 and certain other information (e.g., representing certain other frames of image data) in the camera system data 140 may be tagged in real time with “actuation-off” timestamps.

At step 514, in processing image information acquired by the camera system 112 on a frame-by-frame basis, optical flow algorithm 150 identifies one or more visually identifiable features (or groups of features) in successive frames of image information. For purposes of the present disclosure, the term “visually identifiable features” refers to one or more image features present in successive frames of image information that are detectable by the optical flow algorithm (whether or not such features are discernible by the human eye). In one aspect, the visually identifiable features occur in at least two frames, preferably multiple frames, of image information acquired by the camera system and, therefore, can be tracked through two or more frames. A visually identifiable feature may be represented, for example, by a specific pattern of repeatably identifiable pixel values (e.g., RGB color, hue, and/or saturation data).

At step 516, the pixel position offset is determined relating to apparent motion of the one or more visually identifiable features (or groups of features) that are identified in step 514. In one example, the optical flow calculation that is performed by optical flow algorithm 150 in step 516 uses, for example, the Pyramidal Lucas-Kanade method for performing the optical flow calculation. In some implementations, the method 500 may optionally calculate a “velocity vector” as part of executing the optical flow algorithm 150 to facilitate determinations of estimated relative position. For example, at step 518 of FIG. 8, a velocity vector is optionally determined relating to the apparent motion of the one or more visually identifiable features (or groups of features) that are identified in step 514. For example, optical flow algorithm 150 may generate a velocity vector for each feature that is being tracked from one frame to the next frame. The velocity vector represents the movement of the feature from one frame to the next frame. Optical flow algorithm 150 may then generate an average velocity vector, which is the average of the individual velocity vectors of all features of interest that have been identified.

By way of example and referring to FIG. 9A, a view of a frame of image information 600 is presented that shows velocity vectors overlaid thereon, as determined in step 518 of method 500. Image information frame 600 represents image content within the field of view 127 of the camera system 112 at a particular instant of time (the frame 600 shows imagery of a brick pattern, which is an example of a type of surface being traversed by imaging-enabled marking device 100). FIG. 9A also illustrates a coordinate system of the field of view 127 captured in the image information frame 600, including the z-axis 125 (discussed above in connection with, and shown in, FIG. 4A), and an x-axis 131 and y-axis 133 defining a plane of the field of view 127.

Based on the image information frame 600 shown in FIG. 9A, the visually identifiable features (or groups of features) that are identified by optical flow algorithm 150 in step 514 of method 500 are the lines between the bricks. Therefore, in this example the positions of velocity vectors 610 substantially track with the evolving positions of the lines between the bricks in successive image information frames. Velocity vectors 610 show the apparent motion of the lines between the bricks from the illustrated frame 600 to the next frame (not shown), meaning velocity vectors 610 show the apparent motion between two sequential frames. Velocity vectors 610 are indicated by arrows, where direction of motion is indicated by the direction of the arrow and the length of the arrow indicates the distance moved. Generally, a velocity vector represents the velocity of an object plus the direction of motion in the frame of reference of the field of view. In this scenario, velocity vectors 610 can be expressed as pixels/frame, knowing that the frame to frame time depends on the frame rate at which the camera system 112 captures successive image frames. FIG. 9A also shows an average velocity vector 612 overlaid on image information frame 600, which represents the average of all velocity vectors 610.

In the optical flow calculation (which in some embodiments may involve determination of an average velocity vector as discussed above in connection with FIG. 9A), for each frame of image information optical flow algorithm 150 determines and logs the x-y position (in pixels) of the feature(s) of interest that are tracked in successive frames. Optical flow algorithm 150 then determines the change or offset in the x-y positions of the feature(s) of interest from frame to frame. For example, the change in x-y position of one or more features in a certain frame relative to the previous frame may be 55 pixels left and 50 pixels down. Using distance information from sonar range finder 172 (i.e., height of the camera system 112 from the target surface along the z-axis 125, as shown in FIG. 4A), optical flow algorithm 150 correlates the number of pixels offset to an actual distance measurement (e.g., 100 pixels=1 cm). A mathematical relationship or a lookup table (not shown) for correlating distance to, for example, pixels/cm or pixels/inch may be used. In this manner, optical flow algorithm 150 determines the direction of movement of the feature(s) of interest relative to the x-y plane of the FOV 127 of the camera system 112.

With reference again to FIG. 4B, as noted above in one embodiment the camera system 112 includes one or more optical flow chips 1170 which, alone or in combination with a processor 1176 of the camera system 112, may be configured to implement at least a portion of the optical flow algorithm 150 discussed herein. More specifically, in one embodiment, a camera system 112 including an optical flow chip 1170 (and optionally processor 1176) is configured to provide as camera system data 140 respective counts Cx and Cy, where Cx represents a number of pixel positions along the x-axis of the camera system's FOV that a particular visually identifiable feature has shifted between two successive image frames acquired by the camera system, and where Cy represents a number of pixel positions along the y-axis of the camera system's FOV that the particular visually identifiable feature has shifted between the two successive image frames.

Based on the respective counts Cx and Cy that are provided as camera system data 140 for every two frames of image data processed by the optical flow chip 1170, a portion of the image analysis software 114 executed by the processing unit 130 shown in FIG. 5 may convert the counts Cx and Cy to actual distances (e.g., in inches) over which the particular visually identifiable feature has moved in the camera system's FOV (which in turn represents movement of the bottom tip 129 of the marking device), according to the relationships:

dx=(s*Cx*g)/(B*CPI)

dy=(s*Cy*g)/(B*CPI)

where: * represents multiplication; “dx” and “dy” are distances (e.g., in inches) traveled along the x-axis and the y-axis, respectively, in the camera system's field of view, between successive image frames; “Cx” and “Cy” are the pixel counts provided by the optical flow chip of the camera system; “B” is the focal length of a tens (e.g., optical component 1178 of the camera system) used to focus an image of the target surface in the field of view of the camera system onto the optical flow chip; “g”=(H−B), where “H”=the distance of the camera system 112 from the target surface along the z-axis 125 of the marking device (see FIG. 4B), e.g., the “height” of the camera system from the target surface as measured using an IR or sonar range finder 172 (or by stereo calculations using two optical flow chips); “CPI” is the optical flow chip's counts-per-inch conversion factor; and “s” is a scale factor which may be used to scale the distance measurement on different ground surfaces due to the camera system's ability to “see” different target surfaces better, or due to the inconstancy of height readings on various target surfaces (e.g., the range finder 172 may read height on various surfaces inconsistently but with a predictable offset due to the different absorptive and reflective properties of the surface being imaged).

In another embodiment, instead of readings from sonar range finder 172 supplying the distance input parameter (the height “H” noted above) for optical flow algorithm 150, the distance input parameter may be a fixed value stored in local memory 132. In yet another embodiment, instead of sonar range finder 172, a range finding function via stereo vision of two camera systems 112 may be used to supply the distance input parameter.

Further, an angle measurement from IMU 170 may support a dynamic angle input parameter of optical flow algorithm 150, which may be useful for more accurately processing image information frames in some instances. For example, in some instances, the perspective of the image information in the FOV of the camera system 112 may change somewhat for deviation of the camera system's optical axis relative to a normal to the target surface being imaged. Therefore, an angle input parameter related to the position of the camera system's optical axis relative to a normal to the target surface (e.g., +2 degrees from perpendicular, −5 degrees from perpendicular, etc) may allow for correction of distance calculations based on pixel counts in some situations.

At step 520, the method 500 may optionally monitor for anomalous pixel movement during the optical flow-based dead reckoning process. During marking operations, apparent motion of objects may be detected in the FOV of the camera system 112 that is not the result of imaging-enabled marking device 100 moving. For example, an insect, a bird, an animal, a blowing leaf may briefly pass through the FOV of the camera system 112. However, optical flow algorithm 150 may assume that any movement detected is implying motion of imaging-enabled marking device 100. Therefore, throughout the steps of method 500, according to one example implementation it may be beneficial for optical flow algorithm 150 to optionally monitor readings from IMU 170 in order to ensure that the apparent motion detected is actually the result of imaging-enabled marking device 100 moving, and not anomalous pixel movement due to an object passing briefly through the camera system's FOV. In other words, readings from IMU 170 may be used to support a filter function for filtering out anomalous pixel movement.

At step 522, in preparing for departure from the jobsite, the user may optionally deactivate the camera system 112 (e.g., power-down a digital video camera serving as the camera system) to end image acquisition.

At step 524, using the optical flow calculations of steps 516 and optionally 518, optical flow algorithm 150 determines estimated relative position information and/or an optical flow plot based on pixel position offset and changes in heading (direction), as indicated by one or more components of the IMU 170. In one example, optical flow algorithm 150 generates a table of time stamped position offsets with respect to the start position information (e.g., latitude and longitude coordinates) representing the initial or starting position. In another example, the optical flow algorithm generates an optical flow plot, such as, but not limited to, optical flow plot 400 of FIG. 4. Additionally, optical flow output 152 may include time stamped readings from any input devices 116 used in the optical flow-based dead reckoning process. For example, optical flow output 152 includes time stamped readings from IMU 170, sonar range finder 172, and location tracking system 174.

More specifically, in one embodiment the optical flow algorithm 150 calculates incremental changes in latitude and longitude coordinates, representing estimated changes in position of the bottom tip of the marking device on the path traversed along the target surface, which incremental changes may be added to start position information representing a starting position (or initial position, or reference position, or last-known position) of the marking device. In one aspect, the optical flow algorithm 150 uses the quantities dx and dy discussed above (distances traveled along an x-axis and a y-axis, respectively, in the camera system's field of view) between successive frames of image information, and converts these quantities to latitude and longitude coordinates representing incremental changes of position in a north-south-east-west (NSEW) reference frame. As discussed in greater detail below, this conversion is based at least in part on changes in marking device heading represented by a heading angle theta (θ) provided by the IMU 170.

In particular, in one embodiment the optical flow algorithm 150 first implements the following mathematical relationships to calculate incremental changes in relative position in terms of latitude and longitude coordinates in a NSEW reference frame:

deltaLON=dx*cos(θ)+dy*sin(θ); and

deltaLAT=−dx*sin(θ)+dy*cos(θ),

wherein “dx” and “dy” are distances (in inches) traveled along an x-axis and a y-axis, respectively, in the camera system's field of view, between successive frames of image information; “θ” is the heading angle (in degrees), measured clockwise from magnetic north, as determined by a compass and or a combination of compass and gyro headings (e.g., as provided by the IMU 170); and “deltaLON” and “deltaLAT” are distances (in inches) traveled along an east-west axis and a north-south axis, respectively, of the NSEW reference frame. The optical flow algorithm then computes the following values to provide updated latitude and longitude coordinates (in degrees):

newLAT=a sin {[sin(LAT_position)*cos(180/πr*d/R)]+[cos(LAT_position)*sin(180/π*d/R)*cos(brng)]}

newLON=LON_position+a tan 2{[cos(180/πr*d/R)−sin(LAT_position)*sin(newLAT)],[sin(brng)*sin(180/πr*d/R)*cos(LAT_position)]}

where “d” is the total distance traveled given by:

d=sqrt(deltaLON̂2+deltaLAT̂2);

where “brng” is the bearing in degrees given by:

brng=a tan(deltaLAT/deltaLON);

where “a tan 2” is the function defined by:

$$a tan 2 ( y , x ) = \{ \begin{matrix}arctan ( \frac{y}{x} ) , & x > 0 \\ arctan ( \frac{y}{x} ) + π , & y \geq 0 , x < 0 \\ arctan ( \frac{y}{x} ) - π , & y < 0 , x < 0 \\ + \frac{π}{2} , & y > 0 , x = 0 \\ - \frac{π}{2} , & y < 0 , x = 0 \\ undefined , & y = 0 , x = 0\end{matrix} \} ,$$

and where R is the radius of the Earth (i.e., 251,106,299 inches), and LON_position and LAT_position are the respective longitude and latitude coordinates (in degrees) resulting from the immediately previous longitude and latitude coordinate calculation.

Regarding the accuracy of heading data (e.g., obtained from an electronic compass of the IMU 170), the Earth's magnetic field value typically remains fairly constant for a known location on Earth, thereby providing for substantially accurate heading angles. That said, certain disturbances of the Earth's magnetic field may adversely impact the accuracy of heading data obtained from an electronic compass. Accordingly, in one exemplary implementation, magnetometer data (e.g., also provided by the IMU 170) for the Earth's magnetic field may be monitored, and if the monitored data suggests an anomalous change in the magnetic field (e.g., above a predetermined threshold value, e.g., 535 mG) that may adversely impact the accuracy of the heading data provided by an electronic compass, a relative heading angle provided by one or more gyroscopes of the IMU 170 may be used to determine the heading angle theta relative to the “last known good” heading data provided by the electronic compass (e.g., by incrementing or decrementing the last known good compass heading with the relative change in heading detected by the gyro direction.

FIG. 9B is a table showing various data involved in the calculation of updated longitude and latitude coordinates for respective incremental changes in estimated position of a marking device pursuant to an optical flow algorithm processing image information from a camera system, according to one embodiment of the present disclosure. In the table shown in FIG. 9B, to facilitate calculation of dx and dy pursuant to the mathematical relationships discussed above, a value of a focal length B of a lens employed in the camera system is taken as 0.984252 inches, and a value of the counts-per-inch conversion factor CPI for an optical flow chip of the camera system 112 is taken as 1600. As shown in the table of FIG. 9B, ten samples of progressive position are calculated, and in samples 4-10 a surface scale factor “s” is employed (representing that some aspect of the target surface being imaged has changed and that an adjustment factor should be used in some of the intermediate distance calculations, pursuant to the mathematical relationships discussed above). Also, a threshold value for the Earth's magnetic field is taken as 535 mG, above which it is deemed that relative heading information from a gyro of the IMU should be used to provide the heading angle theta based on a last known good compass heading.

With reference again to the method 500 shown in FIG. 9, at step 526, optical flow output 152 resulting from execution of the optical flow algorithm 150 is stored. In one example, any of the data reflected in the table shown in FIG. 9A may constitute optical flow output 152; in particular, the newLON and newLAT values, corresponding to respective updated longitude and latitude coordinates for estimated position, may constitute part of the optical flow output 152. In other examples, one or more of a table of time stamped position offsets with respect to the initial starting position (e.g., initial latitude and longitude coordinates), an optical flow plot (e.g., optical flow plot 400 of FIG. 7), every nth frame (every 10^{th} or 20^{th} frame) of image data 140, and time stamped readings from any input devices 116 (e.g., time stamped readings from IMU 170, sonar range finder 172, and location tracking system 174) may be stored in local memory 132 as constituent elements of optical flow output 152. Information about locate operations that is stored in optical flow outputs 152 may be included in electronic records of locate operations.

In performing the method 500 of FIG. 8 to calculate updated longitude and latitude coordinates for estimated positions as the marking device traverses a path along the target surface, it has been observed (e.g., by comparing actual positions along the path traversed by the marking device with calculated estimated positions) that the accuracy of the estimated positions is generally within some percentage (X %) of the linear distance traversed by the marking device along the path from the most recent starting position (or initial/reference/last-known position). For example, with reference again to FIG. 6, if at some time during the locate operation the marking device has traversed to a first point that is 50 inches along the path 310 from the starting point 312, the longitude and latitude coordinates for an updated estimated position at the first point (as determined pursuant to the method 500 of FIG. 8) generally are accurate to within approximately X % of 50 inches. Stated differently, there is an area of uncertainty surrounding the estimated position, wherein the longitude and latitude coordinates for the updated estimated position define a center of a “DR-location data error circle,” and wherein the radius of the DR-location data error circle is X % of the total linear distance traversed by the marking device from the most recent starting position (in the present example, the radius would be X % of 50 inches). Accordingly, the DR-location data error circle grows with linear distance traversed by the marking device. It has been generally observed that the value of X depends at least in part on the type of target surface imaged by the camera system; for example, for target surfaces with various features that may be relatively easily tracked by the optical flow algorithm 150, a value of X equal to approximately three generally corresponds to the observed error circle (i.e., the radius of the error circle is approximately 3% of the total linear distance traversed by the marking device from the most recent starting position; e.g., for a linear distance of 50 inches, the radius of the error circle would be 1.5 inches). On the other hand, for some types of target surfaces (e.g., smooth white concrete with few features, and under bright lighting conditions), the value of X has been observed to be has high as from 17-20. Various concepts relating to a determination of particular surface type, which may be useful in determining an appropriate value for “s” (as used above to calculate dx and dy) and/or the value of X for determination of a radius for a DR-location data error circle, are discussed in detail in U.S. Patent Application Publication No. 2012-0065924-A1, published Mar. 15, 2012, corresponding to non-provisional U.S. patent application Ser. No. 13/210,291, filed Aug. 15, 2011, and entitled, “Methods, Apparatus and Systems for Surface Type Detection in Connection with Locate and Marking Operations.”

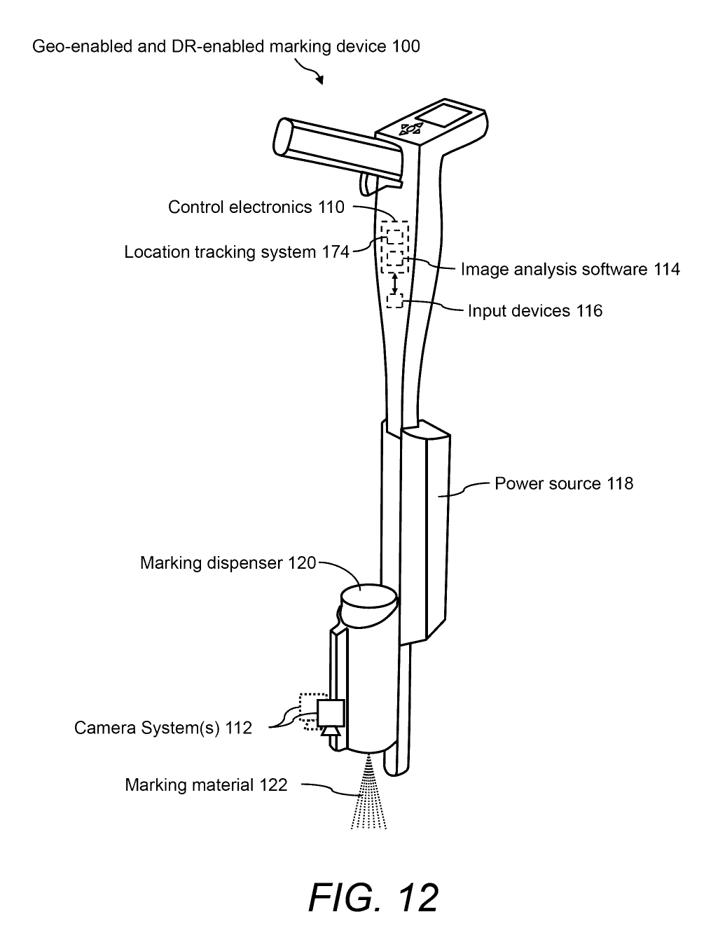

Given that a certain amount of error may be accumulating in the optical flow-based dead reckoning process, the position of imaging-enabled marking device 100 may be “recalibrated” at any time during method 500. That is, the method 500 is not limited to capturing and/or entering (e.g., in step 510) start position information (e.g., the starting coordinates 412 shown in FIG. 7) for an initial or starting position only. Rather, in some implementations, virtually at any time during the locate operation as the marking device traverses the path 310 shown in FIG. 6, the optical flow algorithm 150 may be updated with new start position information (i.e., presumed known latitude and longitude coordinates, obtained from any of a variety of sources) corresponding to an updated starting/initial/reference/last-known position of the marking device along the path 310, from which the optical flow algorithm may begin calculating subsequent estimated positions of the marking device. In one example, geo-encoded facility maps may be a source of new start position information. For example, in the process of performing locate operations, the technician using the marking device may pass by a landmark that has a known position (known latitude and longitude coordinates) based on geo-encoded facility maps. Therefore, when present at this landmark, the technician may update optical flow algorithm 150 (e.g., via the user interface 136 of the marking device) with the known location information, and the optical flow calculation continues. The concept of acquiring start position information for multiple starting/initial/reference/last-known positions along a path traversed by the marking device, between which intervening positions along the path may be estimated pursuant to an optical flow algorithm executed according to the method 500 of FIG. 8, is discussed in further detail below in connection with FIGS. 12-20.

Referring again to FIG. 8, the output of the optical flow-based dead reckoning process of method 500 may be used to continuously apply correction to readings of location tracking system 174 and, thereby, improve the accuracy of the geo-location data of location tracking system 174. Additionally, the optical flow-based dead reckoning process of method 500 may be performed based on image information obtained by two or more camera systems 112 so as to increase the overall accuracy of the optical flow-based dead reckoning process of the present disclosure.

Further, the GNSS signal of location tracking system 174 of the marking device 100 may drop in and out depending on obstructions that may be present in the environment. Therefore, the output of the optical flow-based dead reckoning process of method 500 may be useful for tracking the path of imaging-enabled marking device 100 when the GNSS signal is not available, or of low quality. In one example, the GNSS signal of location tracking system 174 may drop out when passing under the tree shown in locate operations jobsite 300 of FIG. 6. In this scenario, the path of imaging-enabled marking device 100 may be tracked using optical flow algorithm 150 even when the user is walking under the tree. More specifically, without a GNSS signal and without the optical flow-based dead reckoning process, one can only assume a straight line path from the last known GNSS location to the reacquired GNSS location, when in fact the path may not be in a straight line. For example, one would have to assume a straight line path under the tree shown in FIG. 6, when in fact a curved path is indicated using the optical flow-based dead reckoning process of the present disclosure.

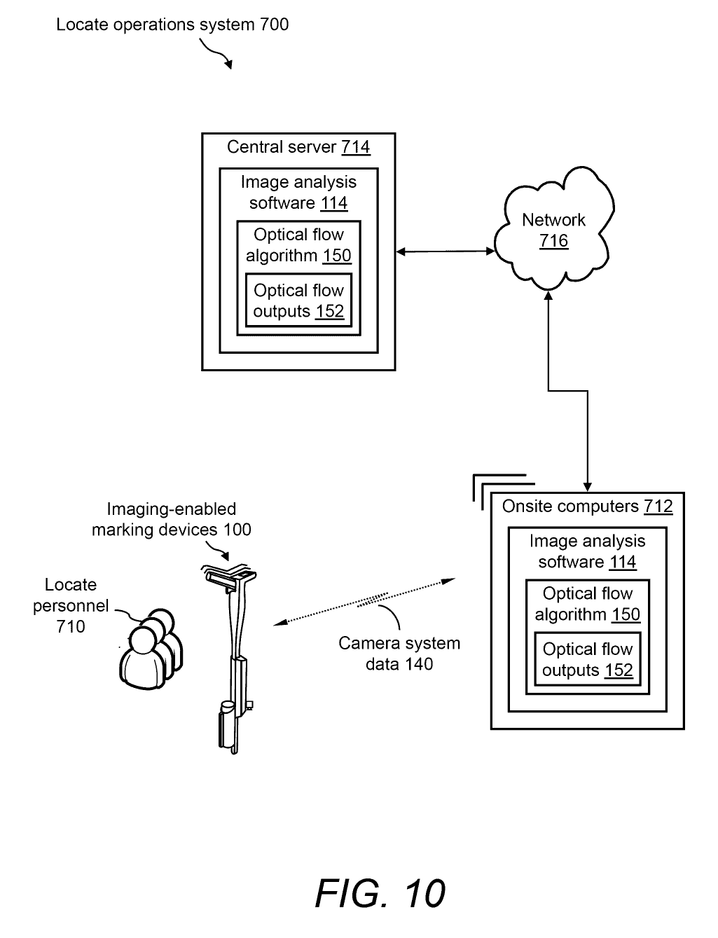

Referring to FIG. 10, a functional block diagram of an example of a locate operations system 700 that includes a network of imaging-enabled marking devices 100 is presented. More specifically, locate operations system 700 may include any number of imaging-enabled marking devices 100 that are operated by, for example, respective locate personnel 710. An example of locate personnel 710 is locate technicians. Associated with each locate personnel 710 and/or imaging-enabled marking device 100 may an onsite computer 712. Therefore, locate operations system 700 may include any number of onsite computers 712.

Each onsite computer 712 may be any onsite computing device, such as, but not limited to, a computer that is present in the vehicle that is being used by locate personnel 710 in the field. For example, onsite computer 712 may be a portable computer, a personal computer, a laptop computer, a tablet device, a personal digital assistant (PDA), a cellular radiotelephone, a mobile computing device, a touch-screen device, a touchpad device, or generally any device including, or connected to, a processor. Each imaging-enabled marking device 100 may communicate via its communication interface 134 with its respective onsite computer 712. More specifically, each imaging-enabled marking device 100 may transmit image data 140 to its respective onsite computer 712.

While an instance of image analysis software 114 that includes optical flow algorithm 150 and optical flow outputs 152 may reside and operate at each imaging-enabled marking device 100, an instance of image analysis software 114 may also reside at each onsite computer 712. In this way, image data 140 may be processed at onsite computer 712 rather than at imaging-enabled marking device 100. Additionally, onsite computer 712 may be processing image data 140 concurrently to imaging-enabled marking device 100.

Additionally, locate operations system 700 may include a central server 714. Central server 714 may be a centralized computer, such as a central server of, for example, the underground facility locate service provider. A network 716 provides a communication network by which information may be exchanged between imaging-enabled marking devices 100, onsite computers 712, and central server 714. Network 716 may be, for example, any local area network (LAN) and/or wide area network (WAN) for connecting to the Internet. Imaging-enabled marking devices 100, onsite computers 712, and central server 714 may be connected to network 716 by any wired and/or wireless means.

While an instance of image analysis software 114 may reside and operate at each imaging-enabled marking device 100 and/or at each onsite computer 712, an instance of image analysis software 114 may also reside at central server 714. In this way, camera system data 140 may be processed at central server 714 rather than at each imaging-enabled marking device 100 and/or at each onsite computer 712. Additionally, central server 714 may be processing camera system data 140 concurrently to imaging-enabled marking devices 100 and/or onsite computers 712.

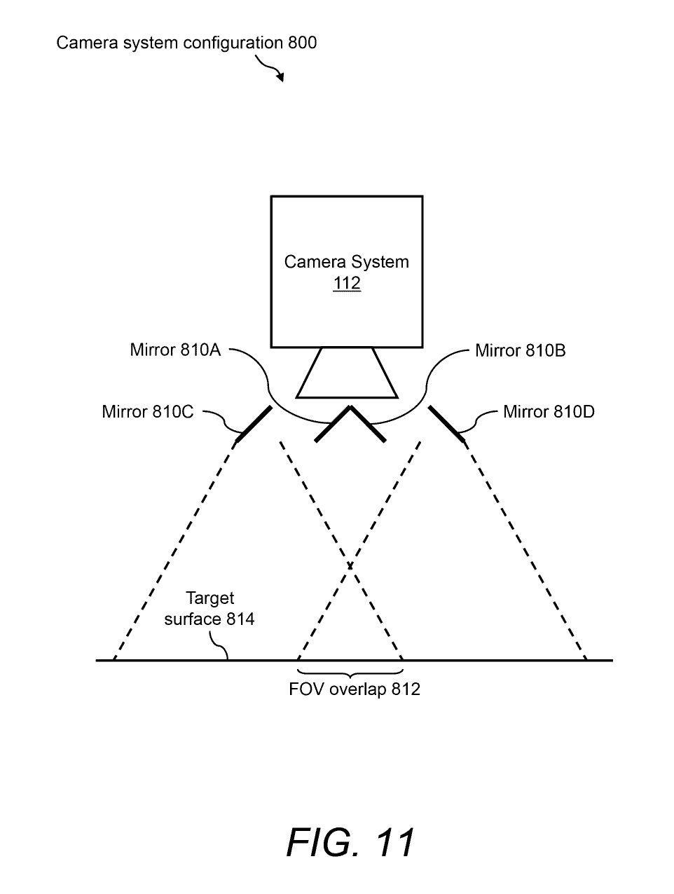

Referring to FIG. 11, a view of an example of a camera system configuration 800 for implementing a range finder function on a marking device using a single camera system is presented. In particular, the present disclosure provides a marking device, such as imaging-enabled marking device 100, that includes camera system configuration 800, which uses a single camera system 112 in combination with an arrangement of multiple mirrors 810 to achieve depth perception. A benefit of this configuration is that instead of two camera systems for implementing the range finder function, only one camera system is needed. In one example, camera system configuration 800 that is mounted on a marking device may be based on the system described with reference to an article entitled “Depth Perception with a Single Camera,” presented on Nov. 21-23, 2005 at the 1^{st} International Conference on Sensing Technology held in Palmerston North, New Zealand, which article is hereby incorporated herein by reference in its entirety.

In the embodiments shown, camera system configuration 800 includes a mirror 810A and a mirror 810B arranged directly in the FOV of camera system 112. Mirror 810A and mirror 810B are installed at a known distance from camera system 112 and at a known angle with respect to camera system 112. More specifically, mirror 810A and mirror 810B are arranged in an upside-down “V” fashion with respect to camera system 112, such that the vertex is closest to the camera system 112, as shown in FIG. 11. In this way, the angled plane of mirror 810A and mirror 810B and the imagery therein is the FOV of camera system 112.

A mirror 810C is associated with mirror 810A. Mirror 810C is set at about the same angle as mirror 810A and to one side of mirror 810A (in the same plane as mirror 810A and mirror 810B). This arrangement allows the reflected image of target surface 814 to be passed from mirror 810C to mirror 810A, which is then captured by camera system 112. Similarly, a mirror 810D is associated with mirror 810B. Mirror 810B and mirror 810D are arranged in opposite manner to mirror 810A and mirror 810C. This arrangement allows the reflected image of target surface 814 to be passed from mirror 810D to mirror 810B, which is then captured by camera system 112. As a result, camera system 112 captures a split image of target surface 814 from mirror 810A and mirror 810B. The arrangement of mirrors 810A, 810B, 810C, and 810D is such that mirror 810C and mirror 810D have a FOV overlap 812. In one example, FOV overlap 812 may be an overlap of about 30% to about 50%.

In operations, the stereo vision system that is implemented by use of camera system configuration 800 uses multiple mirrors to split or segment a single image frame into two sub-frames, each with a different point of view towards the ground. Both sub-frames overlap in their field of view by 30% or more. Common patterns in both sub-frames are identified by pattern matching algorithms and then the center of the pixel pattern is calculated as two sets of x-y coordinates. The relative location in each sub-frame of the center of the pixel patterns represented by sets of x-y coordinates is used to determine the distance to target surface 814. The distance calculations use the trigonometry functions for right triangles.

In one embodiment, camera system configuration 800 is implemented as follows. The distance of camera system configuration 800 from target surface 814 is about 1 meter, the size of mirrors 810A and 810B is about 10 mm×10 mm, the size of mirrors 810C and 810D is about 7.854 mm×7.854 mm, the FOV distance of mirrors 810C and 810D from target surface 814 is about 0.8727 meters, the overall width of camera system configuration 800 is about 80 mm, and all mirrors 810 are set at about 45 degree angles in an effort to keep the system as compact as possible. Additionally, the focal point is about 0.0016615 meters from the camera system lens and the distance between mirrors 810A and 810B and the camera system lens is about 0.0016615+0.001547=0.0032085 meters. In other embodiments, other suitable configurations may be used. For example, in another arrangement, mirror 810A and mirror 810B are spaced slightly apart. In yet another arrangement, camera configuration 800 includes mirror 810A and mirror 810C only or mirror 810B and mirror 810D only. Further, camera system 112 may capture a direct image of target surface 814 in a portion of its FOV that is outside of mirror 810A and mirror 810B (i.e., not obstructed from view by mirror 810A and mirror 810B).

Geo-Locate and Dead Reckoning-Enabled Marking Devices

Referring to FIG. 12, a perspective view of an embodiment of the marking device 100 which is geo-enabled and DR-enabled is presented. In some embodiments, the device 100 may be used for creating electronic records of locate operations. More specifically, FIG. 12 shows an embodiment of a geo-enabled and DR-enabled marking device 100 that is an electronic marking device that is capable of creating electronic records of locate operations using the combination of the geo-location data of the location tracking system and the DR-location data of the optical flow-based dead reckoning process.

In many respects, the marking device 100 shown in FIG. 12 may be substantially similar to the marking device discussed above in connection with FIGS. 4A, 4B and 5 (and, unless otherwise specifically indicated below, the various components and functions discussed above in connection with FIGS. 4A, 4B and 5 apply similarly in the discussion below of FIGS. 12-20). For example, in some embodiments, geo-enabled and DR-enabled marking device 100 may include certain control electronics 110 and one or more camera systems 112. Control electronics 110 is used for managing the overall operations of geo-enabled and DR-enabled marking device 100. A location tracking system 174 may be integrated into control electronics 110 (e.g., rather than be included as one of the constituent elements of the input devices 116). Control electronics 110 also includes a data processing algorithm 1160 (e.g., that may be stored in local memory 132 and executed by the processing unit 130). Data processing algorithm 1160 may be, for example, any algorithm that is capable of combining geo-location data 1140 (discussed further below) and DR-location data 152 for creating electronic records of locate operations.

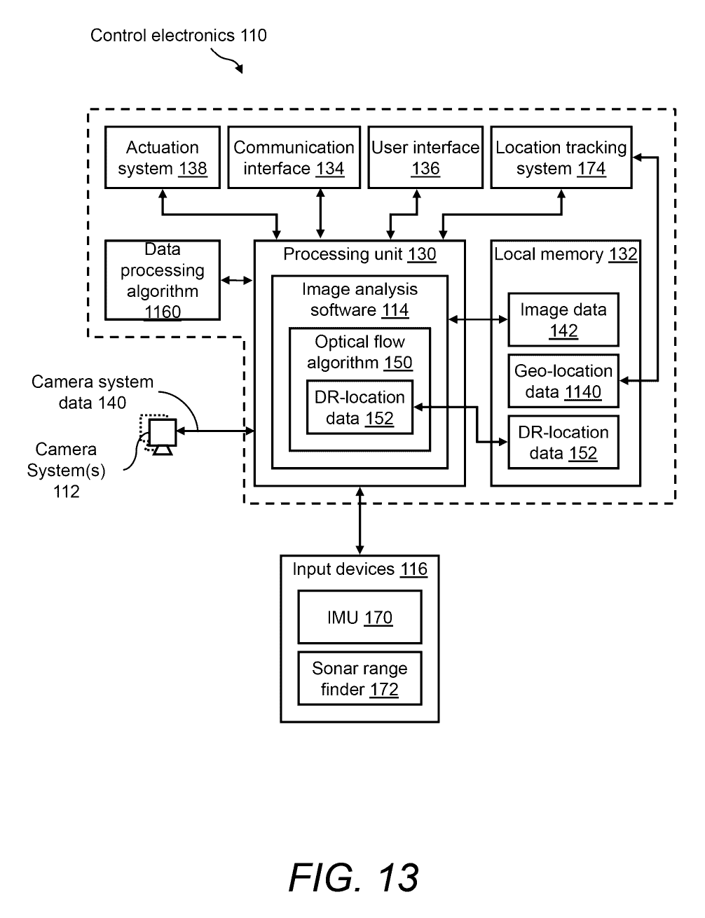

Referring to FIG. 13, a functional block diagram of an example of control electronics 110 of geo-enabled and DR-enabled marking device 100 of the present disclosure is presented. In this example, control electronics 110 may include, but is not limited to, location tracking system 174 and image analysis software 114, a processing unit 130, a quantity of local memory 132, a communication interface 134, a user interface 136, and an actuation system 138. FIG. 13 also shows that the output of location tracking system 174 may be saved as geo-location data 1140 at local memory 132. As discussed above in connection with FIG. 5, geo-location data from location tracking system 174 may serve as start position information associated with a “starting” position (also referred to herein as an “initial” position, a “reference” position or a “last-known” position) of imaging-enabled marking device 100, from which starting (or “initial,”, or “reference” or “last-known”) position subsequent positions of the marking device may be determined pursuant to the optical flow-based dead reckoning process. As also discussed above in connection with FIGS. 4A and 5, the location tracking system 174 may be a GNSS-based system, and a variety of geo-location data may be provided by the location tracking system 174 including, but not limited to, time (coordinated universal time—UTC), date, latitude, north/south indicator, longitude, east/west indicator, number and identification of satellites used in the position solution, number and identification of satellites in view and their elevation, azimuth and signal-to-noise-ratio (SNR) values, and dilution of precision (DOP) values. Accordingly, it should be appreciated that in some implementations the location tracking system 174 may provide a wide variety of geographic information as well as timing information (e.g., one or more time stamps) as part of geo-location data 1140, and it should also be appreciated that any information available from the location tracking system 174 (e.g., any information available in various NMEA data messages, such as coordinated universal time, date, latitude, north/south indicator, longitude, east/west indicator, number and identification of satellites used in the position solution, number and identification of satellites in view and their elevation, azimuth and SNR values, dilution of precision values) may be included as part of geo-location data 1140.

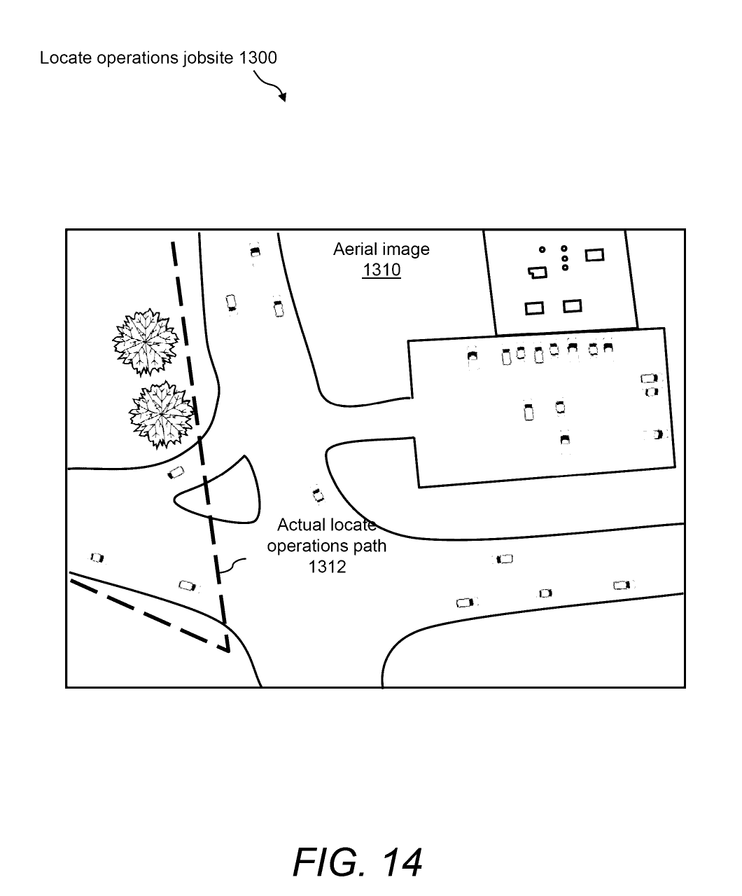

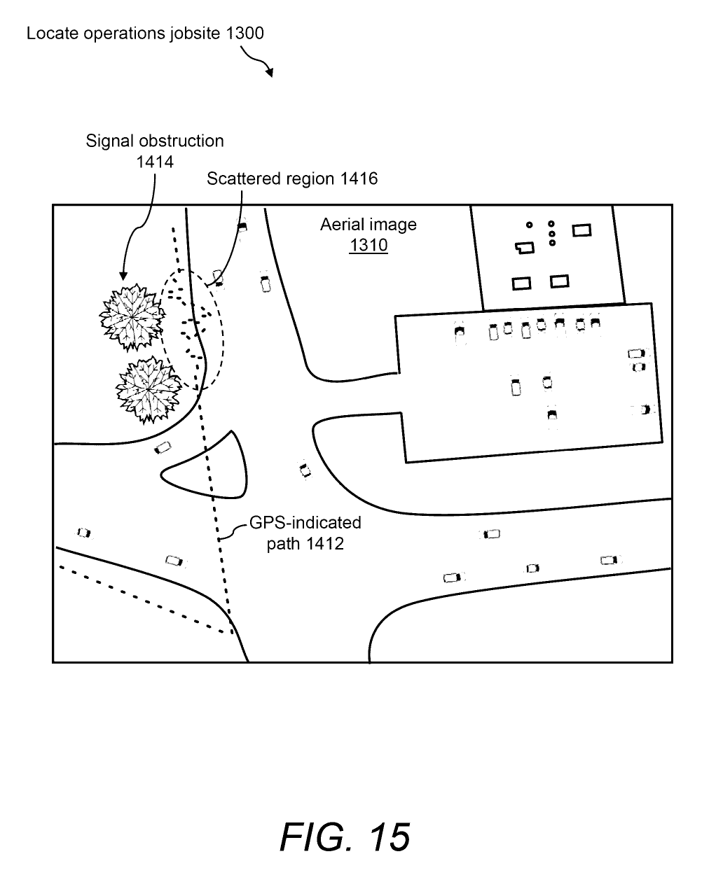

Referring to FIG. 14, an example of an aerial view of a locate operations jobsite 300 and an example of an actual path taken by geo-enabled and DR-enabled marking device 100 during locate operations is presented for reference purposes only. For example, an aerial image 1310 is shown of locate operations jobsite 300. Aerial image 1310 is the geo-referenced aerial image of locate operations jobsite 300. Indicated on aerial image 1310 is an actual locate operation path 1312. For reference and/or context purposes only, actual locate operations path 1312 depicts the actual path or motion of geo-enabled and DR-enabled marking device 100 during one example locate operation. An electronic record of this example locate operation may include location data that substantially correlates to actual locate operations path 1312. The source of the contents of the electronic record that correlates to actual locate operations path 1312 may be geo-location data 1140 of location tracking system 174, DR-location data 152 of the flow-based dead reckoning process performed by optical flow algorithm 150 of imaging analysis software 114, and any combination thereof. Additional details of the process of creating electronic records of locate operations using geo-location data 1140 of location tracking system 174 and/or DR-location data 152 of optical flow algorithm 150 are described with reference to FIGS. 15 through 19.

Referring to FIG. 15, the aerial view of the example locate operations jobsite 300 and an example of a GPS-indicated path 1412, which is the path taken by geo-enabled and DR-enabled marking device 100 during locate operations as indicated by geo-location data 1140 of location tracking system 174 is presented. More specifically, GPS-indicated path 1412 is a graphical representation (or plot) of the geo-location data 1140 (including GPS latitude/longitude coordinates) of location tracking system 174 rendered on the geo-referenced aerial image 1310. GPS-indicated path 1412 correlates to actual locate operations path 1312 of FIG. 14. That is, geo-location data 1140 of location tracking system 174 is collected during the locate operation that is associated with actual locate operations path 1312 of FIG. 14. This geo-location data 1140 is then processed by, for example, data processing algorithm 1160.

Those skilled in the art will recognize that there is some margin of error of each point forming GPS-indicated path 1412. This error (e.g., ±some distance) is based on the accuracy of the longitude and latitude coordinates provided in the geo-location data 1140 from the location tracking system 174 at any given point in time. This accuracy in turn may be indicated, at least in part, by dilution of precision (DOP) values that are provided by the location tracking system 174 (DOP values indicate the quality of the satellite geometry and depend, for example, on the number of satellites “in view” of the location tracking system 174 and the respective angles of elevation above the horizon for these satellites). The example GPS-indicated path 1412, as shown in FIG. 15, is an example of the recorded GPS-indicated path, albeit it is understood that certain error may be present. In particular, as discussed above, each longitude/latitude coordinate pair provided by the location tracking system 174 may define the center of a “geo-location data error circle,” wherein the radius of the geo-location data error circle (e.g., in inches) is related, at least in part, to a DOP value corresponding to the longitude/latitude coordinate pair. In some implementations, the DOP value is multiplied by some base unit of error (e.g., 200 inches) to provide a radius for the geo-location data circle (e.g., a DOP value of 5 would correspond to a radius of 1000 inches for the geo-location data error circle).

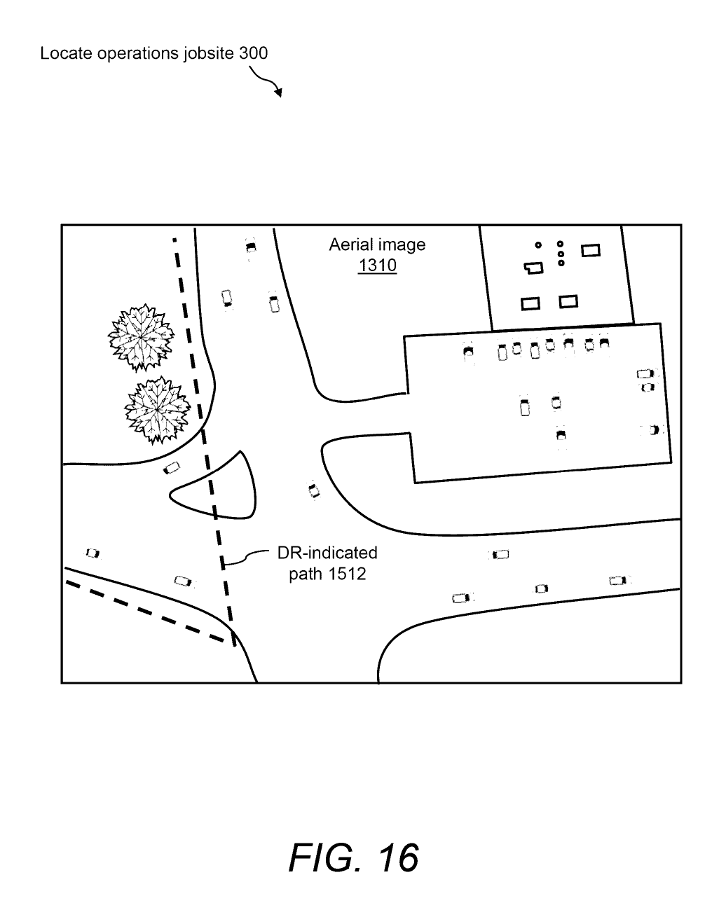

In the example of GPS-indicated path 1412, certain objects may be present at locate operations jobsite 300 that may partially or fully obstruct the GPS signal, causing a signal degradation or loss (as may be reflected, at least in part, in DOP values corresponding to certain longitude/latitude coordinate pairs). For example, FIG. 15 shows a signal obstruction 1414, which may be, for example, certain trees that are present at locate operations jobsite 300. In this example, signal obstruction 1414 happens to be located near the locate activities (i.e., near actual locate operations path 1312 of FIG. 14) such that the GPS signal reaching geo-enabled and DR-enabled marking device 100 may be unreliable and/or altogether lost. An example of the plot of unreliable geo-location data 140 is shown in a scattered region 1416 along the plot of GPS-indicated path 1412, wherein the plotted points may deviate significantly from the position of actual locate operations path 1312 of FIG. 14. Consequently, any geo-location data 1140 that is received by geo-enabled and DR-enabled marking device 100 when near signal obstruction 1414 may not be reliable and, therefore, when processed in the electronic record may not accurately indicate the path taken during locate operations. However, according to the present disclosure, DR-location data 1152 from optical flow algorithm 150 may be used in the electronic record in place of any inaccurate geo-location data 1140 in scattered region 1416 to more accurately indicate the actual path taken during locate operations. Additional details of this process are described with reference to FIGS. 16 through 19.

Referring to FIG. 16, the aerial view of the example locate operations jobsite and an example of a DR-indicated path 1512, which is the path taken by the geo-enabled and DR-enabled marking device 100 during locate operations as indicated by DR-location data 152 of the optical flow-based dead reckoning process is presented. More specifically, DR-indicated path 1512 is a graphical representation (or plot) of the DR-location data 152 (e.g., a series of newLAT and newLON coordinate pairs for successive frames of processed image information) provided by optical flow algorithm 150 and rendered on the geo-referenced aerial image 310. DR-indicated path 1512 correlates to actual locate operations path 1312 of FIG. 14. That is, DR-location data 152 from optical flow algorithm 150 is collected during the locate operation that is associated with actual locate operations path 1312 of FIG. 14. This DR-location data 152 is then processed by, for example, data processing algorithm 1160. As discussed above, those skilled in the art will recognize that there is some margin of error of each point forming DR-indicated path 1512 (recall the “DR-location data error circle” discussed above). The example DR-indicated path 1512, as shown in FIG. 16, is an example of the recorded longitude/latitude coordinate pairs in the DR-location data 152, albeit it is understood that certain error may be present (e.g., in the form of a DR-location data error circle for each longitude/latitude coordinate pair in the DR-location data, having a radius that is a function of linear distance traversed from the previous starting/initial/reference/last-known position of the marking device).

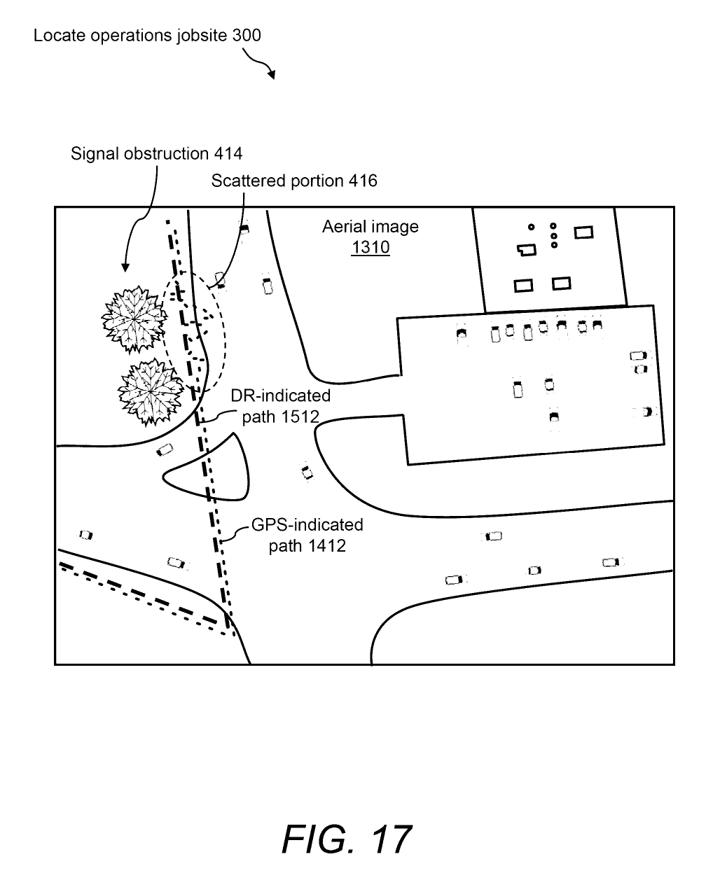

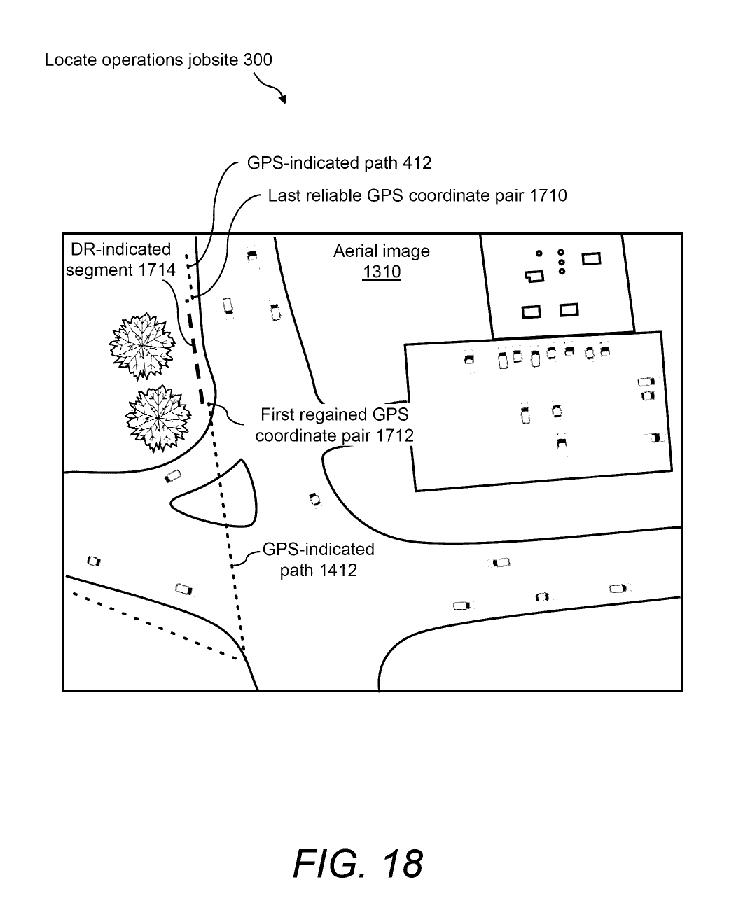

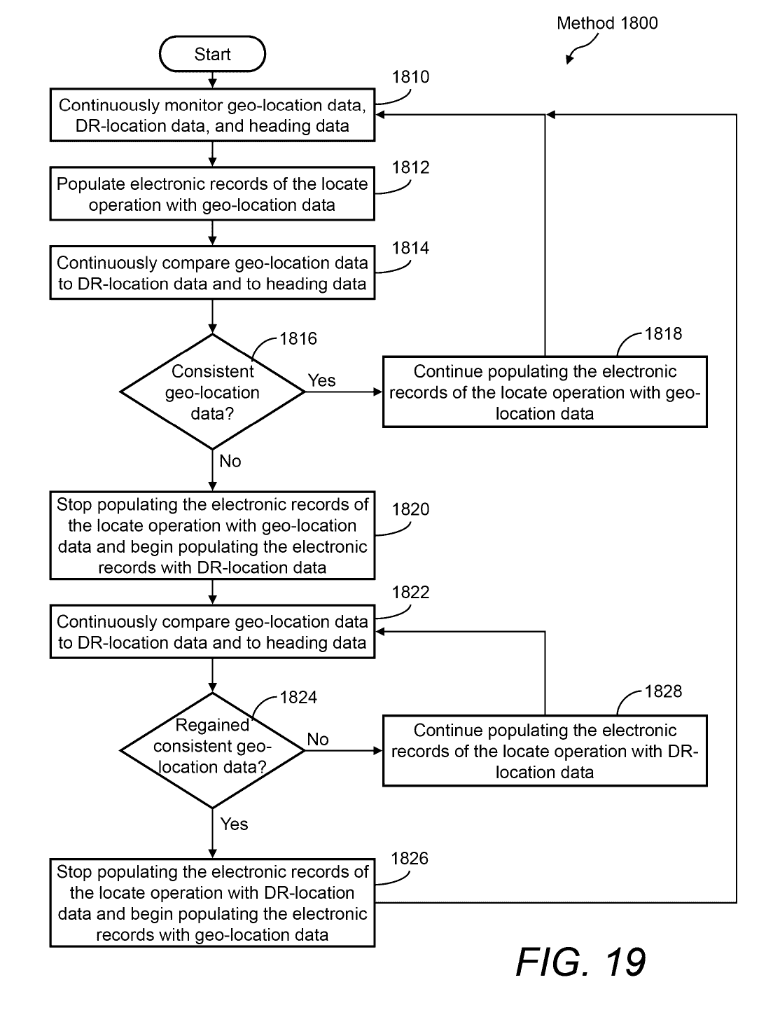

Referring to FIG. 17, both GPS-indicated path 1412 of FIG. 15 and DR-indicated path 1512 of FIG. 16 overlaid atop aerial view 1310 of the example locate operations jobsite 300 is presented. That is, for comparison purposes, FIG. 17 shows GPS-indicated path 1412 with respect to DR-indicated path 1512. It is shown that the portion of DR-indicated path 1512 that is near scattered region 1416 of GPS-indicated path 1412 may be more useful for electronically indicating actual locate operations path 1312 of FIG. 14 that is near signal obstruction 1414. Therefore, according to the present disclosure, a combination of geo-location data 1140 of location tracking system 112 and DR-location data 1152 of optical flow algorithm 1159 may be used in the electronic records of locate operations, an example of which is shown in FIG. 18. Further, an example method of combining geo-location data 1140 and DR-location data 1152 for creating electronic records of locate operations is described with reference to FIG. 19.

Referring to FIG. 18, a portion of GPS-indicated path 1412 and a portion of the DR-indicated path 1512 that are combined to indicate the actual locate operations path of geo-enabled and DR-enabled marking device 100 during locate operations is presented. For example, the plots of a portion of GPS-indicated path 1412 and a portion of the DR-indicated path 1512 are combined and substantially correspond to the location of actual locate operations path 1312 of FIG. 14 with respect to the geo-referenced aerial image 1310 of locate operations jobsite 300.

In some embodiments, the electronic record of the locate operation associated with actual locate operations path 1312 of FIG. 14 includes geo-location data 1140 forming GPS-indicated path 1412, minus the portion of geo-location data 1140 that is in scattered region 1416 of FIG. 15. By way of example, the portion of geo-location data 1140 that is subtracted from electronic record may begin at a last reliable GPS coordinate pair 1710 of FIG. 18 (e.g., the last reliable GPS coordinate pair 1710 may serve as “start position information” corresponding to a starting/initial/reference/last-known position for subsequent estimated position pursuant to execution of the optical flow algorithm 150). In one example, the geo-location data 1140 can be deemed unreliable based at least in part on DOP values associated with GPS coordinate pairs (and may also be based on other information provided by the location tracking system 174 and available in the geo-location data 1140, such as number and identification of satellites used in the position solution, number and identification of satellites in view and their elevation, azimuth and SNR values, and received signal strength values (e.g., in dBm) for each satellite used in the position solution). In other examples, the geo-location data 1140 may be deemed unreliable if a certain amount inconsistency with DR-location data 152 and/or heading data from an electronic compass included in IMU 170 occurs. In this way, last reliable GPS coordinate pair 1710 may be established.

As some point after which longitude/latitude coordinate pairs in geo-location data 1140 are deemed to be unreliable according to some criteria, the reliability of subsequent longitude/latitude coordinate pairs in the geo-location data 1140 may be regained (e.g., according to the same criteria, such as a different DOP value, increased number of satellites used in the position solution, increases signal strength for one or more satellites, etc.). Accordingly, a first regained GPS coordinate pair 1712 of FIG. 18 may be established. In this example, the portion of geo-location data 1140 between last reliable GPS coordinate 1710 and first regained GPS coordinate 1712 is not included in the electronic record. Instead, to complete the electronic record, a segment 1714 of DR-location data (e.g., a segment of DR-indicated path 1512 shown in FIG. 17) may be used. By way of example, the DR-location data 152 forming a DR-indicated segment 1714 of FIG. 18, which may be calculated using the last reliable GPS coordinate pair 1710 as “start position information,” is used to complete the electronic record of the locate operation associated with actual locate operations path 1312 of FIG. 14.

In the aforementioned example, the source of the location information that is stored in the electronic records of locate operations may toggle dynamically, automatically, and in real time between geo-location data 1140 and DR-location data 152, based on the real-time status of location tracking system 174 (e.g., and based on a determination of accuracy/reliability of the geo-location data 1140 vis a vis the DR-location data 152). Additionally, because a certain amount of error may be accumulating in the optical flow-based dead reckoning process, the accuracy of DR-location data 152 may at some point become less than the accuracy of geo-location data 1140. Therefore, the source of the location information that is stored in the electronic records of locate operations may toggle dynamically, automatically, and in real time between geo-location data 1140 and DR-location data 152, based on the real-time accuracy of the information in DR-location data 152 as compared to the geo-location data 1140.

In an actuation-based data processing scenario, actuation system 138 may be the mechanism that prompts the logging of any data of interest of location tracking system 174, optical flow algorithm 150, and/or any other devices of geo-enabled and DR-enabled marking device 100. In one example, each time the actuator of geo-enabled and DR-enabled marking device 100 is pressed or pulled, any available information that is associated with the actuation event is acquired and processed. In a non-actuation-based data processing scenario, any data of interest of location tracking system 174, optical flow algorithm 150, and/or any other devices of geo-enabled and DR-enabled marking device 100 may be acquired and processed at certain programmed intervals, such as every 100 milliseconds, every 1 second, every 5 seconds, etc.

Tables 1 and 2 below show an example of two electronic records of locate operations (i.e., meaning data from two instances in time) that may be generated using geo-enabled and DR-enabled marking device 100 of the present disclosure. While certain information shown in Tables 1 and 2 is automatically captured from location data of location tracking system 174, optical flow algorithm 150, and/or any other devices of geo-enabled and DR-enabled marking device 100, other information may be provided manually by the user. For example, the user may use user interface 136 to enter a work order number, a service provider ID, an operator ID, and the type of marking material being dispensed. Additionally, the marking device ID may be hard-coded into processing unit 130.

TABLE 1
Example electronic record of locate operations generated using geo-
enabled and DR-enabled marking device 100

| Device | Data returned |
|---|---|
| Service provider ID | 0482735 |
| Marking Device ID | A263554 |
| Operator ID | 8936252 |
| Work Order # | 7628735 |
| Marking Material | RED Brand XYZ |
| Timestamp data of processing | 12 Jul. 2010; 09:35:15.2 |
| unit 130 | |
| Location data of location tracking | 35° 43′ 34.52″ N, 78° 49′ 46.48″ W |
| system 112 and/or optical flow | |
| algorithm 150 | |
| Heading data of electronic | 213 degrees |
| compass in IMU 170 | |
| Other IMU data of IMU 170 | Accelerometer = 0.285 g, |
| | Angular acceleration = +52 degrees/sec, |
| | Magnetic Field = −23 micro Teslas (μT) |
| Actuation system 138 status | ON |

TABLE 2
Example electronic record of locate operations generated using geo-
enabled and DR-enabled marking device 100

| Device | Data returned |
|---|---|
| Service provider ID | 0482735 |
| Marking Device ID | A263554 |
| Operator ID | 8936252 |
| Work Order # | 7628735 |
| Marking Material | RED Brand XYZ |
| Timestamp data of processing | 12 Jul. 2010; 09:35:19.7 |
| unit 130 | |
| Location data of location tracking | 35° 43′ 34.49″ N, 78° 49′ 46.53″ W |
| system 112 and/or optical flow | |
| algorithm 150 | |
| Heading data of electronic | 214 degrees |
| compass in IMU 170 | |
| Other IMU data of IMU 170 | Accelerometer = 0.271 g, |
| | Angular acceleration = +131 degrees/sec, |
| | Magnetic Field = −45 micro Teslas (μT) |
| Actuation system 138 status | ON |

The electronic records created by use of geo-enabled and DR-enabled marking device 100 include at least the date, time, and geographic location of locate operations. Referring again to Tables 1 and 2, other information about locate operations may be determined by analyzing multiple records of data. For example, the total onsite-time with respect to a certain work order may be determined, the total number of actuations with respect to a certain work order may be determined, and the like. Additionally, the processing of multiple records of data is the mechanism by which, for example, GPS-indicated path 1412 of FIG. 15 and/or DR-indicated path 1512 of FIG. 16 may be rendered with respect to a geo-referenced aerial image.

Referring to FIG. 19, a flow diagram of an example of a method 1800 of combining geo-location data 1140 and DR-location data 152 for creating electronic records of locate operations is presented. Preferably, method 1800 is performed at geo-enabled and DR-enabled marking device 100 in real time during locate operations. However, method 1800 may be performed by post-processing geo-location data 1140 of location tracking system 174 and DR-location data 152 of optical flow algorithm 150. Additionally, in some embodiments, method 1800 uses geo-location data 1140 of location tracking system 174 as the default source of data for the electronic record of locate operations, unless substituted for by DR-location data 152. However, this is exemplary only. Method 800 may be modified to use DR-location data 152 of optical flow algorithm 150 as the default source of data for the electronic record, unless substituted for by geo-location data 1140. Method 1800 may include, but is not limited to, the following steps, which are not limited to any order.

At step 1810, geo-location data 1140 of location tracking system 174, DR-location data 152 of optical flow algorithm 150, and heading data of an electronic compass (in the IMU 170) are continuously monitored by, for example, data processing algorithm 1160. In one example, data processing algorithm 1160 reads this information at each actuation of geo-enabled and DR-enabled marking device 100. In another example, data processing algorithm 1160 reads this information at certain programmed intervals, such as every 100 milliseconds, every 1 second, every 5 seconds, or any other suitable interval. Method 1800 may, for example, proceed to step 1812.

At step 1812, using data processing algorithm 1160, the electronic records of the locate operation are populated with geo-location data 1140 from location tracking system 174. Tables 1 and 2 are examples of electronic records that are populated with geo-location data 1140. Method 1800 may, for example, proceed to step 1814.

At step 1814, data processing algorithm 1160 continuously compares geo-location data 1140 to DR-location data 152 and to heading data in order to determine whether geo-location data 1140 is consistent with DR-location data 152 and to heading data. For example, data processing algorithm 1160 may determine whether the absolute location information and heading information of geo-location data 1140 is substantially consistent with the relative location information and the direction of movement indicated in DR-location data 152 and also consistent with the heading indicated by IMU 170. Method 1800 may, for example, proceed to step 1816.

Examples of reasons why the geo-location data 1140 may become inaccurate, unreliable, and/or altogether lost and, thus, not be consistent with DR-location data 152 and/or heading data are as follows. The accuracy of the GNSS location from a GNSS receiver may vary based on known factors that may influence the degree of accuracy of the calculated geographic location, such as, but not limited to, the number of satellite signals received, the relative positions of the satellites, shifts in the satellite orbits, ionospheric effects, clock errors of the satellites' clocks, multipath effect, tropospheric effects, calculation rounding errors, urban canyon effects, and the like. Further, the GNSS signal may drop out fully or in part due to physical obstructions (e.g., trees, buildings, bridges, and the like).

At decision step 1816, if the information in geo-location data 1140 is substantially consistent with information in DR-location data 152 of optical flow algorithm 150 and with heading data of IMU 170, method 1800 may, for example, proceed to step 1818. However, if the information in geo-location data 1140 is not substantially consistent with information in DR-location data 152 and with heading data of IMU 170, method 1800 may, for example, proceed to step 1820.

The GPS longitude/latitude coordinate pair that is provided by location tracking system 174 comes with a recorded accuracy, which may be indicated in part by associated DOP values. Therefore, in another embodiment, instead of or concurrently to performing steps 1814 and 1816, which compares geo-location data 1140 to DR-location data 152 and to heading data and determines consistency, method 1800 may proceed to step 1818 as long as the DOP value associated with the GPS longitude/latitude coordinate pair is at or below a certain acceptable threshold (e.g., in practice it has been observed that a DOP value of 5 or less is generally acceptable for most locations). However, method 1800 may proceed to step 1820 if the DOP value exceeds a certain acceptable threshold.

Similarly, in various embodiments, the control electronics 110 may detect an error condition in the location tracking system 174 based on other types of information. For example, in an embodiments where location tracking system 174 is a GPS device, control electronics 110 may monitor the quality of the GPS signal to determine if the GPS tracking has dropped out. In various embodiments the GPS device may output information related to the GPS signal quality (e.g., the Received Signal Strength Indication based on the IEEE 802.11 protocol), the control electronics 110 evaluates this quality information based on some criterion/criteria to determine if the GPS tracking is degraded or unavailable. As detailed herein, when such an error condition is detected, the control electronics 110 may switch over to optical flow based dead reckoning tracking to avoid losing track of the position of the marker device 100.

At step 1818, the electronic records of the locate operation continue to be populated with geo-location data 1140 of location tracking system 174. Tables 1 and 2 are examples of electronic records that are populated with geo-location data 1140. Method 1800 may, for example, return to step 8110.

At step 1820, using data processing algorithm 1160, the population of the electronic records of the locate operation with geo-location data 1140 of location tracking system 174 is stopped. Then the electronic records of the locate operation begin to be populated with DR-location data 152 of optical flow algorithm 150. Method 1800 may, for example, proceed to step 1822.

At step 1822, data processing algorithm 1160 continuously compares geo-location data 1140 to DR-location data 152 and to heading data of IMU 170 in order to determine whether geo-location data 1140 is consistent with DR-location data 152 and to the heading data. For example, data processing algorithm 1160 may determine whether the absolute location information and heading information of geo-location data 1140 is substantially consistent with the relative location information and the direction of movement indicated in DR-location data 152 and also consistent with the heading indicated by IMU 170. Method 1800 may, for example, proceed to step 1824.

At decision step 1824, if the information in geo-location data 1140 has regained consistency with information in DR-location data 152 of optical flow algorithm 150 and with the heading data, method 1800 may, for example, proceed to step 1826. However, if the information in geo-location data 1140 has not regained consistency with information in DR-location data 152 of optical flow algorithm 150 and with the heading data, method 1800 may, for example, proceed to step 1828.

At step 1826, using data processing algorithm 1160, the population of the electronic records of the locate operation with DR-location data 152 of optical flow algorithm 150 is stopped. Then the electronic records of the locate operation begin to be populated with geo-location data 140 of location tracking system 174. Method 1800 may, for example, return to step 1810.

At step 1828, the electronic records of the locate operation continue to be populated with DR-location data 152 of optical flow algorithm 150. Tables 1 and 2 are examples of electronic records that are populated with DR-location data 152. Method 1800 may, for example, return to step 1822.

In summary and according to method 800 of the present disclosure, the source of the location information that is stored in the electronic records may toggle dynamically, automatically, and in real time between location tracking system 174 and the optical flow-based dead reckoning process of optical flow algorithm 150, based on the real-time status of location tracking system 174 and/or based on the real-time accuracy of DR-location data 152.

In another embodiment based at least in part on some aspects of the method 1800 shown in FIG. 19, the optical flow algorithm 150 is relied upon to provide DR-location data 152, based on and using a last reliable GPS coordinate pair (e.g., see 1710 in FIG. 18) as “start position information,” if and when a subsequent GPS coordinate pair provided by the location tracking system 174 is deemed to be unacceptable/unreliable according to particular criteria outlined below. Stated differently, each GPS coordinate pair provided by the location tracking system 174 (e.g., at regular intervals) is evaluated pursuant to the particular criteria outlined below; if the evaluation deems that the GPS coordinate pair is acceptable, it is entered into the electronic record of the locate operation. Otherwise, if the evaluation initially deems that the GPS coordinate pair is unacceptable, the last reliable/acceptable GPS coordinate pair is used as “start position information” for the optical flow algorithm 150, and DR-location data 152 from the optical flow algorithm 150, calculated based on the start position information, is entered into the electronic record, until the next occurrence of an acceptable GPS coordinate pair.

In one alternative implementation of this embodiment, in instances where a GPS coordinate pair is deemed unacceptable and instead one or more longitude/latitude coordinate pairs from DR-location data 152 is considered for entry into the electronic record of the locate operation, a radius of a DR-location data error circle associated with the longitude/latitude coordinate pairs from DR-location data 152 is compared to a radius of a geo-location data error circle associated with the GPS coordinate pair initially deemed to be unacceptable; if the radius of the DR-location data error circle exceeds the radius of the geo-location data error circle, the GPS coordinate pair initially deemed to be unacceptable is nonetheless used instead of the longitude/latitude coordinate pair(s) from DR-location data 152. Stated differently, if successive GPS coordinate pairs constituting geo-location data 1140 are initially deemed to be unacceptable over appreciable linear distances traversed by the marking device, there may be a point at which the accumulated error in DR-location data 152 is deemed to be worse than the error associated with corresponding geo-location data 1140; accordingly, at such a point, a GPS coordinate pair constituting geo-location data 1140 that is initially deemed to be unacceptable may nonetheless be entered into the electronic record of the locate operation.

More specifically, in the embodiment described immediately above, the determination of whether or not a GPS coordinate pair provided by location tracking system 174 is acceptable is based on the following steps (a failure of any one of the evaluations set forth in steps A-C below results in a determination of an unacceptable GPS coordinate pair):

A. At least four satellites are used in making the GPS location calculation so as to provide the GPS coordinate pair (as noted above, information about number of satellites used may be provided as part of the geo-location data 1140).

B. The Position Dilution of Precision (DOP) value provided by the location tracking system 174 must be less than a threshold PDOP value. As noted above, the Position Dilution of Precision depends on the number of satellites in view as well as their angle of elevations above the horizon. The threshold value depends on the accuracy required for each jobsite. In practice, it has been observed that a PDOP maximum value of 5 has been adequate for most locations. As also noted above, the Position Dilution of Precision value may be multiplied by a minimum error distance value (e.g., 5 meters or approximately 200 inches) to provide a corresponding radius of a geo-location data error circle associated with the GPS coordinate pair being evaluated for acceptability.

C. The satellite signal strength for each satellite used in making the GPS calculation must be approximately equal to the Direct Line Of Sight value. For outdoor locations in almost all cases, the Direct Line of Sight signal strength is higher than multipath signal strength. The signal strength value of each satellite is kept track of and an estimate is formed of the Direct Line of Sight signal strength value based on the maximum strength of the signal received from that satellite. If for any measurement the satellite signal strength value is significantly less than its estimated Direct Line of Sight signal strength, that satellite is discounted (which may affect the determination of number of satellites used in A.) (Regarding satellite signal strength, a typical received signal strength is approximately −130 dBm. A typical GPS receiver sensitivity is approximately −142 dBm for which the receiver obtains a position fix, and approximately −160 dBm for the lowest received signal power for which the receiver maintains a position fix).

D. If all of steps A-C are satisfied, a final evaluation is done to ensure that the calculated speed of movement of the marking device based on successive GPS coordinate pairs is less than a maximum possible speed (“threshold speed) of the locating technician carrying the marking device (e.g., on the order of approximately 120 inches/sec). For this evaluation, we define:
goodPos1 to be position determined to be a good position at initial time t1
geoPos2 to be position determined by geo-location data at time t2
drPos2 to be position determined by DR-location data at time t2
Distance (p2, p1) be a function that determines distance between two positions p2 and p1
   At time t2 the following calculation is carried out:

geoSpeed21=Distance(geoPos2,goodPos1)/(t2−t1)
If |geoSpeed21| is less than threshold speed TS determine geoPos2 to be the good position for time t2. The threshold speed is based on the likely maximum speed of the locating technician.
If |geoSpeed21| is greater than threshold speed TS calculate:

drSpeed21=Distance(drPos2,goodPos1)/(t2−t1)
Now if speed |drSpeed21| is less than |geoSpeed21| use drPos2 as the good position for time t2, else use geoPos2 as the good position for time t2.
   For the next position determination iteration, the position determined as good at time t2 is used as the initial good position.

E. If any of steps A-D fail such that the GPS coordinate pair provided by location tracking system 174 is deemed to be unacceptable and instead a longitude/latitude coordinate pair from DR-location data 152 is considered, compare a radius of the geo-location data error circle associated with the GPS coordinate pair under evaluation, to a radius of the DR-location data error circle associated with the longitude/latitude coordinate pair from DR-location data 152 being considered as a substitute for the GPS coordinate pair. If the radius of the DR-location data error circle exceeds the radius of the geo-location data error circle, the GPS coordinate pair initially deemed to be unacceptable in steps A-D is nonetheless deemed to be acceptable.

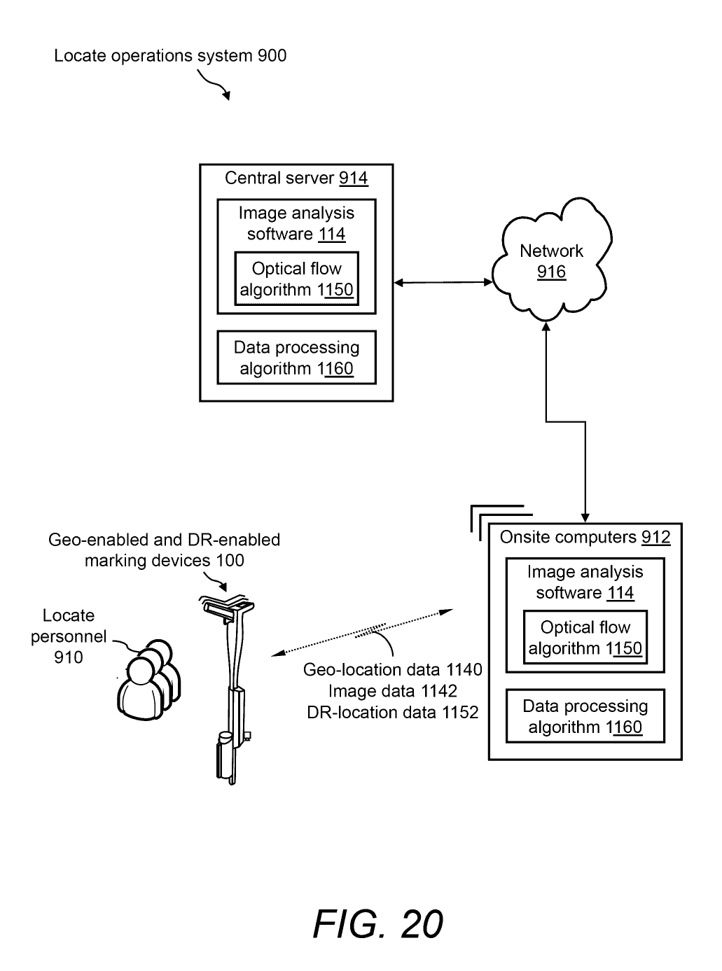

Referring to FIG. 20, a functional block diagram of an example of a locate operations system 900 that includes a network of geo-enabled and DR-enabled marking devices 100 is presented. More specifically, locate operations system 900 may include any number of geo-enabled and DR-enabled marking devices 100 that are operated by, for example, respective locate personnel 910. An example of locate personnel 910 is locate technicians. Associated with each locate personnel 910 and/or geo-enabled and DR-enabled marking device 100 may an onsite computer 912. Therefore, locate operations system 900 may include any number of onsite computers 912.

Each onsite computer 912 may be any onsite computing device, such as, but not limited to, a computer that is present in the vehicle that is being used by locate personnel 910 in the field. For example, onsite computer 912 may be a portable computer, a personal computer, a laptop computer, a tablet device, a personal digital assistant (PDA), a cellular radiotelephone, a mobile computing device, a touch-screen device, a touchpad device, or generally any device including, or connected to, a processor. Each geo-enabled and DR-enabled marking device 100 may communicate via its communication interface 1134 with its respective onsite computer 912. More specifically, each geo-enabled and DR-enabled marking device 100 may transmit image data 142 to its respective onsite computer 912.

While an instance of image analysis software 114 that includes optical flow algorithm 150 and an instance of data processing algorithm 160 may reside and operate at each geo-enabled and DR-enabled marking device 100, an instance of image analysis software 114 with optical flow algorithm 150 and an instance of data processing algorithm 160 may also reside at each onsite computer 912. In this way, image data 142 may be processed at onsite computer 912 rather than at geo-enabled and DR-enabled marking device 100. Additionally, onsite computer 912 may be processing geo-location data 1140, image data 1142, and DR-location data 1152 concurrently to geo-enabled and DR-enabled marking device 100.

Additionally, locate operations system 900 may include a central server 914. Central server 914 may be a centralized computer, such as a central server of, for example, the underground facility locate service provider. A network 916 provides a communication network by which information may be exchanged between geo-enabled and DR-enabled marking devices 100, onsite computers 912, and central server 914. Network 916 may be, for example, any local area network (LAN) and/or wide area network (WAN) for connecting to the Internet. Geo-enabled and DR-enabled marking devices 100, onsite computers 912, and central server 914 may be connected to network 916 by any wired and/or wireless means.

While an instance of an instance of image analysis software 114 with optical flow algorithm 1150 and an instance of data processing algorithm 1160 may reside and operate at each geo-enabled and DR-enabled marking device 100 and/or at each onsite computer 912, an instance of image analysis software 114 with optical flow algorithm 1150 and an instance of data processing algorithm 1160 may also reside at central server 914. In this way, geo-location data 1140, image data 1142, and DR-location data 1152 may be processed at central server 914 rather than at each geo-enabled and DR-enabled marking device 100 and/or at each onsite computer 912. Additionally, central server 914 may be processing geo-location data 1140, image data 1142, and DR-location data 1152 concurrently to geo-enabled and DR-enabled marking devices 100 and/or onsite computers 912.

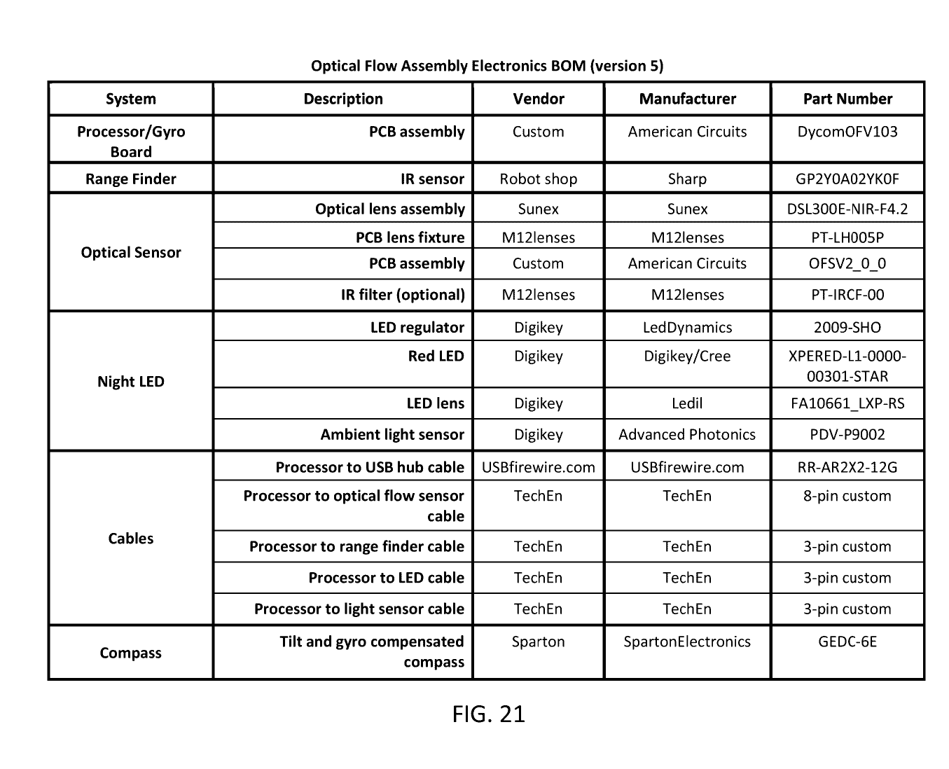

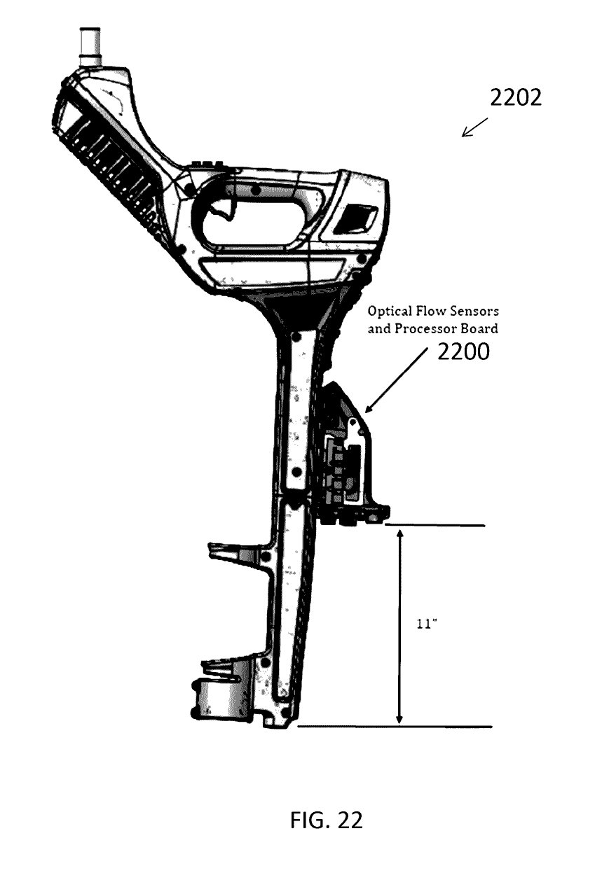

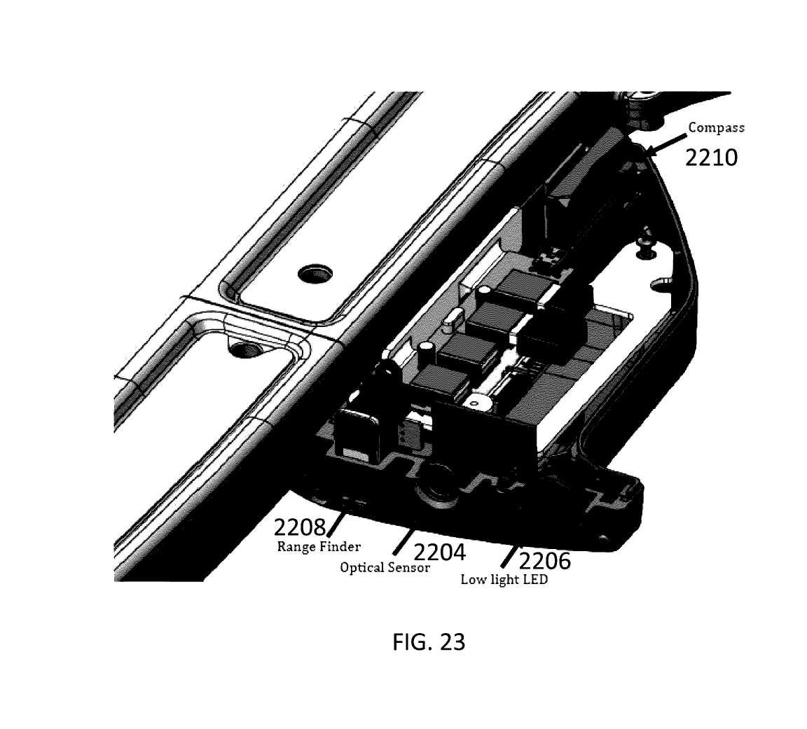

According to some embodiments, an optical flow sensor (that may include various elements of a camera system 112 and/or other input devices 116 as disclosed elsewhere herein) comprises three primary components: (1) a CMOS optical sensor; (2) an IR light range finder; and (3) a gyro-assisted, tilt-compensated compass unit. FIG. 21 provides an overview of the components and some component vendors for the optical flow assembly electronics according to some embodiments. FIGS. 22 and 23 illustrate exemplary placement of the components of an optical flow sensor 2200 on a marking apparatus 2202 in accordance with some embodiments.

A CMOS optical sensor (e.g., Avago part number ADNS-3080, available from Avago Technologies Ltd. (San Jose, Calif.)) is typically used in an optical mouse. This sensor measures changes in position by optically acquiring sequential image frames and determining direction and magnitude of motion based upon movement of surface features from frame to frame. The sensor's advantages over conventional camera-based optical flow are its low cost, low power usage (e.g., 172 mW @ 3.3V), and low system processing overhead for a high frame rate of image processing (e.g., up to 6400 fps) due to the onboard digital signal processor (DSP). According to some embodiments (e.g., the marking apparatus 2202 illustrated in FIGS. 22 and 23), the optical lens fixture (e.g., optical sensor 2204) may be designed for use at the marking apparatus operating height of approximately 14 inches above the ground surface, which places the lens high enough that it is away from paint back-spray, but still low enough that a LED lighting system (e.g., low light LED 2206) can illuminate the ground surface sufficiently in low light operating conditions. The optical lens may have a focal length of about 17 mm and a vertical field of view angle of about 16 degrees.

An IR light range finder (e.g., Sharp part number GP2Y0A02YK0F, available from Sharp Microelectronics (Camas, Wash.)) scales the optical sensor's displacement counts to the height of the sensor above the operating surface, converting image movement counts into object displacement values. This sensor may be selected over more compact single lobed sonar range finders because it is a sealed unit lending to outdoor use applications. This sensor also may be selected over laser range finders so that the ground surface distance is an average value over a patch of ground, instead of a point distance. According to some embodiments (e.g., the marking apparatus 2202 illustrated in FIGS. 22 and 23), the IR light range finder (e.g., range finder 2208) may require placement on a marking apparatus such that it is high enough to be protected from paint back-spray, and near enough to the optical sensor such that it senses the same surface as the optical sensor.

A gyro-assisted, tilt-compensated compass unit (e.g., the Sparton GEDC-6E AHRS, available from Sparton Navigation and Exploration (DeLeon Springs, Fla.)) is employed to convert the optical sensor's local displacement into a global displacement, no matter what direction the marking apparatus is facing during movement. Appropriate placement of this sensor facilitates good heading results. According to some embodiments (e.g., the marking apparatus 2202 illustrated in FIGS. 22 and 23), the compass unit (e.g., compass 2210) may require placement on a marking apparatus such that it is as far away as possible from magnetic materials (e.g., the battery, ferrous metals, etc.) in the object. On the other hand, the compass unit may be placed as close as possible to the object's center of rotation to offset the effects of centripetal acceleration on the accelerometer sensor doing the tilt compensation of the unit's magnetometer. In some embodiments of a marking apparatus, the compass is located near, on, or within the head of the apparatus (e.g., under the antenna). The gyro-based heading assist may help correct the magnetometer-based heading during object movement, and during periods where the earth's magnetic field is disturbed (e.g., next to cars, metallic service units, metal plates, etc.).

Methods and Apparatus for Substituting, Supplementing, and/or Refining Satellite Data with Data from Other Sensors

According to some embodiments, an object (e.g., a marking apparatus) may be docked in a docking station (e.g., mounted in a technician's vehicle as the marking apparatus is taken from jobsite to jobsite to perform marking operations). Such a docking station may be equipped with one or more GNSS modules/chipsets similar or identical to those employed in the object (e.g., the STA8088EXG receiver integrated circuit available from STMicroelectronics (Geneva, Switzerland) and/or the NV08C-CSM receiver integrated circuit available from NVS Technologies AG (Montlingen, Switzerland)). The GNSS modules/chipsets of the docking station are coupled to an antenna. In implementations in which the docking station is coupled to a vehicle, the antenna may be mounted to the vehicle, and the vehicle in this instance provides an expansive ground plane to facilitate improved reception and corresponding improved quality of available signals from satellites (e.g., due to a reduction of multipath interference). Additionally, employing GNSS modules that are configured to receive signals from, for example, GLONASS satellites in addition to GPS satellites, provides for expanded coverage and increases the number of satellites potentially available to contribute signals to facilitate resolving location with increased accuracy and reliability. In implementations in which an object is docked in a docking station and initialized, initial geographic coordinates may be transferred from the docking station to the object, together with all relevant GNSS data germane to the functionality of the chipset, to provide a reliable and accurate “stakepoint” for subsequent tracking of the object (e.g., use of the marking apparatus for a marking operation).

It should be appreciated that an object (e.g., a marking apparatus) may be initialized while not docked in a docking station. In some instances, the accuracy and reliability of initial geographic “stakepoints” upon initialization may be affected by a smaller ground plane for the antenna of the object that is coupled to the GNSS module(s)/chipset(s), and the presence of environmental artifacts that could provide for multipath interference and/or obstruction to available satellite signals (e.g., amongst dense natural and artificial environments such as a heavy tree canopy or an urban canyon, etc.).

The initialization routine of an electronic compass may include ascertaining geographically dependent declination and ambient magnetic field values via an Internet connection by an appropriate source of this information (e.g., the National Oceanic and Atmospheric Administration (NOAA)). In some embodiments, the initialization routine of an object comprising an electronic compass (e.g., a marking apparatus) may include obtaining a current magnetic field reading local to the site at which the object is to be tracked (e.g., the work site where the marking apparatus is to be used for a marking operation) and comparing the local reading to a baseline geographically-dependent ambient magnetic field value to establish a calibration factor that may be used in various post-processing techniques for data collected from one or more GNSS modules/chipsets and/or other sensors associated with the object.

According to some embodiments, one or more data logs are created by the processor(s) and/or stored in a memory associated with an object. The one or more data logs may be used for post-processing of data collected during movement of the object. In some embodiments, one or more data logs are created by a processor(s) of a marking apparatus and/or stored in a memory of the marking apparatus during use of the marking apparatus to conduct a marking operation (or “job”). In some embodiments, an activity log, an optical flow log, and/or a visit file is created.

In embodiments in which an activity log is maintained, data may be logged essentially from power-on of the marking apparatus or undocking of the marking apparatus from a docking station until the marking apparatus is re-docked or a particular job is specifically indicated as terminated or completed (e.g., by the technician indicating, for example, via a user interface/GUI of the marking apparatus). A processor of the marking apparatus may regularly poll one or more sensors of the marking apparatus whether or not an actuator of the marking apparatus is actuated by the technician. The collected data may be stored in, for example, a time-indexed sequence. Examples of data collected in an activity log may include, but are not limited to, accelerometer data, humidity/temperature/light level data, GNSS data (including latitude/longitude coordinates and associated information provided by the GNSS module(s)/chipset(s), such as NMEA data), battery level data, processor/CPU temperature data, marker color data, and an indicator as to whether or not an actuator of the marking apparatus is actuated at a given time.

In embodiments in which an optical flow log is maintained, data may be logged in a manner similar to that of the activity log, e.g., essentially from power-on of the marking apparatus (or undocking) until the marking apparatus is re-docked or a job is completed or terminated. The data stored in an optical flow log may be derived from sensors of an optical flow module to facilitate dead reckoning calculations. Examples of data collected in an optical flow log may include, but are not limited to, compass heading (and associated reading) data, range finder reading data, data output by an optical flow chip (e.g., representing relative x-y position as a function of time), quality metrics data for various optical elements, and an indicator as to whether or not an actuator of the marking apparatus is actuated at a given time.

In embodiments in which a visit file is maintained, data may be derived from an activity log, for example, data may be logged that is essentially a subset of information taken from the activity log that is associated with actuations (“trigger pulls”) of the marking apparatus. In one example, a visit file includes only that GNSS data (e.g., latitude/longitude coordinates and associated NMEA data) that temporally corresponds to trigger pulls. According to some embodiments, a visit file may be post-processed and “refined” (discussed further below), based at least in part on various data in an optical flow log and/or additional data in an activity log, to provide an electronic record of the marking operation (which may include information to be overlaid on a base image to provide an electronic visualization of the marking operation). The processor(s) of a marking apparatus may implement a preliminary interpolation processing technique, in which GNSS data from successive (neighboring) trigger pulls are compared and assessed for “feasibility” in the context of a technician performing a marking operation (e.g., inquiring whether the successive GNSS coordinates reflect respective locations that represent possible human movements within a given time frame); as a result of such interpolation, “errant” GNSS data may be ignored and in some instances replaced by interpolated values derived from the nearest reliable GNSS data.

According to some embodiments, a technique for post-processing data in a visit file (e.g., in which the GNSS data is provided by the STA8088 chipset) is based on the following steps. For each latitude/longitude coordinate pair in the visit file:

A. Check the signal-to-noise ratio (SNR) of each satellite that was available in the determination of the coordinate pair; if the SNR for a given satellite is below a predetermined threshold (e.g., 35 dB), then flag that satellite as providing an unreliable signal.

B. If pursuant to the foregoing step, three or fewer satellites remain that were available in the determination of the coordinate pair and that have SNRs above the predetermined threshold (i.e., have “reliable” signals), then flag the coordinate pair as unreliable.

C. If more than three satellites remain that were available in the determination of the coordinate pair and that have reliable signals, then check the elevation of each remaining satellite; if the elevation for a given satellite is below a predetermined threshold (e.g., 20 degrees), then flag that satellite as providing an unreliable signal.

D. If pursuant to the foregoing step, three or fewer satellites remain that were available in the determination of the coordinate pair and that have reliable signals, then flag the coordinate pair as unreliable.

E. If more than three satellites remain that were available in the determination of the coordinate pair and that have reliable signals, then check the dilution of position (DOP) of each remaining satellite; if the DOP for a given satellite is below a predetermined threshold (e.g., 2.7), then flag the coordinate pair as reliable (otherwise flag the coordinate pair as unreliable).

F. If pursuant to the foregoing step, the coordinate pair is flagged as reliable, then ascertain the length of time since the last, if any, coordinate pair flagged unreliable in the visit file (the “recovery time”); if the recovery time is above a predetermined threshold (e.g., 4 seconds), then flag the current coordinate pair as reliable.

The exemplary predetermined thresholds for satellite SNR, elevation, DOP, and recovery time used above, were determined empirically based on use of a particular embodiment (i.e., a marking apparatus with a STA8088 chipset and a particular antenna configuration in a typical use-case of the marking apparatus to perform a marking operation). Accordingly, it should be appreciated that these exemplary values are provided primarily for purposes of illustration, and are not limiting. More generally, by analyzing satellite SNR, elevation, DOP, and/or recovery time, intelligent automatic decisions may be made regarding the reliability of a given GNSS coordinate pair.

In some aspects, the empirical choices for exemplary values are based at least in part on the inventors' appreciation that the STA8088 chipset includes proprietary algorithms that are optimized for particular use cases (primarily relating to walking or driving), and thus are not necessarily tailored to every application, for example, the use case of a somewhat disjointed stop-and-go series of movements attendant to a marking operation. Accordingly, data in the NMEA data stream may be considered in the context of the use-case, pursuant to the post-processing technique above and empirically determined evaluation metrics, to provide for a quality/reliability assessment of GNSS coordinate pairs.

According to some embodiments of a post-processing technique to assess the location information present in and/or refine a visit file, data from an optical flow log may be used as to substitute, supplement, and/or improve (see further discussion below) GNSS coordinate pairs that are determined as unreliable. For example, upon the determination of an unreliable GNSS coordinate pair, data in an optical flow log for the time period in proximity of a trigger pull corresponding to the unreliable GNSS coordinate pair may be used as a substitute in a refined visit file, based at least in part on an evaluation of the reliability of the data in an optical flow log. In one aspect, the query may be framed in terms of a comparative analysis, for example, whether the data in the optical flow log is more or less reliable than a given GNSS coordinate pair, which may have been determined to be unreliable. In some embodiments, if the data in the optical flow log is deemed to be more reliable than an unreliable GNSS coordinate pair, it may be used in place of the unreliable GNSS coordinate pair; however, if the data in the optical flow log is deemed to be less reliable than an unreliable GNSS coordinate pair, the unreliable GNSS coordinate pair ultimately may be maintained in the refined visit file. In other embodiments, the data in the optical flow log may be used to supplement and/or refine an unreliable GNSS coordinate pair (as described below) such that the refined GNSS coordinate pair ultimately may be maintained in the refined visit file.

Some relevant metrics for evaluating the reliability of the data in an optical flow log include, but are not limited to, the elapsed time between reliable GNSS coordinate pairs (e.g., a “distance gap”), various health indicators relating to the optics associate with the optical flow chip and other optical flow sensor elements, and magnetic field readings reflecting a degree of heading accuracy provided by the compass.

The conventional approach to determining a position of a GNSS receiver has been to use time-stamped signals transmitted from a minimum of four GNSS satellites because there are four unknown variables, including (1) the x-position, (2) the y-position, and (3) the z-position of the receiver in three-dimensional space, and (4) the absolute time at the receiver. In addition, the visible GNSS satellites must be distributed across the sky for reliable accuracy. However, a GNSS receiver often fails to receive signals transmitted from four satellites due to, for example, obstructions (e.g., urban canyons or other sky view factors), atmospheric effects, radio reception issues (e.g., shadowing and multi-path effects), selective availability policies, and other sources of natural and artificial interference. Even if the receiver receives signals from four visible satellites, the satellites may not be adequately distributed for reliable accuracy.

According to some embodiments, a position of a GNSS receiver may be determined with fewer visible and/or adequately distributed GNSS satellites. For example, if the altitude of the location is known, the number of unknown variables and the number of visible and/or adequately distributed GNSS satellites required is reduced by one.

The altitude of the GNSS receiver may be adequately determined or estimated using a number of methods. For example, the general area of a job site or work area where a marking apparatus is used may be known and may have a roughly similar altitude, allowing the altitude to be estimated beforehand using known altitude databases of the general area such as those provided by, for example, Google Earth (Mountain View, Calif.) and the U.S. Geological Survey (Reston, Va.).

The altitude of the GNSS receiver also may be estimated by measuring atmospheric pressure, which varies directly with altitude and remains relatively constant over a relatively small work area for a relatively small time period. For example, atmospheric pressure may be measured at a location with good GNSS satellite visibility and then tracked for variations with movement. Atmospheric pressure may be measured using, for example, one or more barometers, altimeters, variometers, and/or other pressure sensors. Pressure sensing chips, such as MS5611-01BA03 (with as low as 10-cm resolution, available from Measurement Specialties™ (Hampton, Va.)) and BMP180 (with as low as 0.17-m resolution, available from Bosch Sensortec (Reutlingen/Kusterdingen, Germany)), may be used according to some embodiments.

Most commercial GNSS modules use a cheap oscillator as a timekeeping device. The output frequency of such oscillators drifts rapidly and cannot be relied upon to keep time to the accuracy required to estimate position. For this reason, the local receiver time is designated as an unknown variable that requires information from a GNSS satellite to be resolved. As with altitude, if the absolute time at the receiver is known, the number of unknown variables and the number of visible and/or adequately distributed GNSS satellites required is reduced by one. The absolute time at the receiver may be adequately determined or estimated using a more accurate timekeeping device, for example, a Chip Scale Atomic Clock (CSAC), such as the Quantum™ SA.45s CSAC (available from Microsemi Corp. (Aliso Viejo, Calif.)). For example, an accurate fix on absolute time may be taken at a location with good GNSS satellite visibility and then time maintenance can be performed using the CSAC.

According to some embodiments, data from visible GNSS satellites may be combined with data from one or more other sensors to obtain position fixes and to improve positioning accuracy even though a position fix may not be accurate, or even possible, using each sensor set in isolation.

According to some embodiments, data from GNSS satellites may be combined with data from sensors of velocity and/or distance traveled to refine what would otherwise be unreliable GNSS data. For example, a carrier phase lock may be used to calculate motion along a line-of-sight (LOS) vector between a receiver r and a satellite s. Assuming atmospheric conditions stay constant, this may be accomplished without base station correction.

The value of the distance traveled by receiver r along the LOS vector between receiver r and satellite s, as projected on the horizontal plane, may be obtained based on ephemeris data (i.e., date regarding the position at a given time) of satellite s. The ephemeris data either provides or facilitates calculation of the satellite's azimuth angle (i.e., the compass bearing, relative to true (geographic) north, of a point on the horizontal plane directly beneath the satellite) and elevation angle (i.e., the angle between the point on the horizontal plane directly beneath the satellite and the satellite). Ephemerides may be downloaded from National Oceanic and Atmospheric Administration (NOAA) and/or obtained from data broadcast by the satellites themselves. According to some embodiments, the LOS vector may be presumed to be constant over relatively short periods of time (e.g., in cases where GNSS readings are being collected every tenth of a second). Alternatively, the orientation of the LOS vector can be averaged over a period of time. The orientation of the x- and y-axes of the horizontal plane is determined based on at least the orientation of the LOS vector projected on the horizontal plane.

Meanwhile, the dead reckoning techniques (e.g., optical flow-based) that are used in connection with or incorporated in the imaging-enabled marking apparatus of the present disclosure (as well as associated methods and systems) accurately provides the total distance moved in the horizontal plane (i.e., the x- and y-axes), which may be calculated using the following formula:

D^{OF}=\sqrt{(Dₓ^{OF})²+(D_{y}^{OF})²}

where:
D^{OF} is the total distance moved by receiver r as measured by, for example, optical flow;
Dₓ^{OF} is the distance moved by receiver r along the x-axis; and
D_{y}^{OF} is the distance moved by receiver r along the y-axis.

Thus, the value of the distance traveled by receiver r along the LOS vector projected on the horizontal plane between the receiver and satellite s may be calculated using the following formula:

Dᵣ^{s}=D^{s}+λᵢ(dφ)−c(dtᵣ)+c(dtₛ)+(dI_{r,i}^{s})+(dTᵣ^{s})+φ_{E}

where:
Dᵣ^{s} is the distance moved by receiver r along the LOS vector from receiver r to satellite s;
D^{s} is the distance moved by satellite s along the LOS vector from receiver r to satellite s;
λᵢ is the wavelength of the carrier i;
dφ is the carrier phase difference between two successive measurement epochs;
c is the speed of light;
dtᵣ is the receiver clock drift;
dtₛ is the satellite clock drift;
dI_{r,i}^{s} is the change in ionospheric delay for carrier i between satellite s and receiver r;
dTᵣ^{s} is the change in tropospheric delay between satellite s and receiver r; and
φ_{E} is the change in carrier phase due to the Earth's rotation.

The value of the distance traveled by receiver r along the LOS vector projected on the horizontal plane between receiver r and satellite s may be estimated with or without a base station, and with additional satellites visible or with only a single satellite visible.

In the case of a standalone receiver r:
D^{s} may be calculated using broadcast or downloaded satellite ephemeris;
λᵢ, c are known;
dφ is output from receiver r;
dtᵣ may be assumed to be calculated under good satellite visibility and held constant for the duration of any satellite visibility outage;
dtₛ may be obtained over broadcast or downloaded over Internet;
dI_{r,i}^{s} may be assumed to be zero for the duration of any satellite visibility outage;
dTᵣ^{s} may be assumed to be zero for the duration of any satellite visibility outage;
φ_{E} may be calculated using satellite ephemeris and the last known position of receiver r; and
If readings from a nearby base station are available, then the effects of dtₛ, dI_{r,i}^{s} and dTᵣ^{s} may be eliminated by differencing the carrier phase readings for satellite s.

The value of the distance traveled by receiver r along the LOS vector projected on the horizontal plane may be calculated using the following formula:

D_{r,HorizX}^{s}=Dᵣ^{s} cos(Elᵣ^{s})

where Elᵣ^{s} is the elevation angle of satellite s.

Because the motion of receiver r in two orthogonal axes on the horizontal plane, together with the orientation of the axes, is known, the motion of receiver r in the horizontal plane may be fully characterized. Thus, the distance traveled by the receiver in the horizontal plane along a direction perpendicular to the LOS vector projected on the horizontal plane between the receiver r and satellite s may be calculated using D^{OF} as the total distance moved and Pythagorean Theorem:

D_{r,HorizY}^{s}=\sqrt{(D^{OF})²−(D_{r,HorizX}^{s})²}

The above calculation provides two possible positions to which receiver r could have moved, one of which may be eliminated using, for example, a coarse heading sensor, another satellite fix, and/or propagating receiver dynamics.

Because the position of satellite s is known from broadcast or downloaded satellite ephemerides, the motion of receiver r in the horizontal plane may be calculated using a distance sensor and information from a single satellite. However, at least one satellite must have carrier phase lock; otherwise, performance will be severely degraded because of the noise in the ranging distance obtained using pseudo range only.

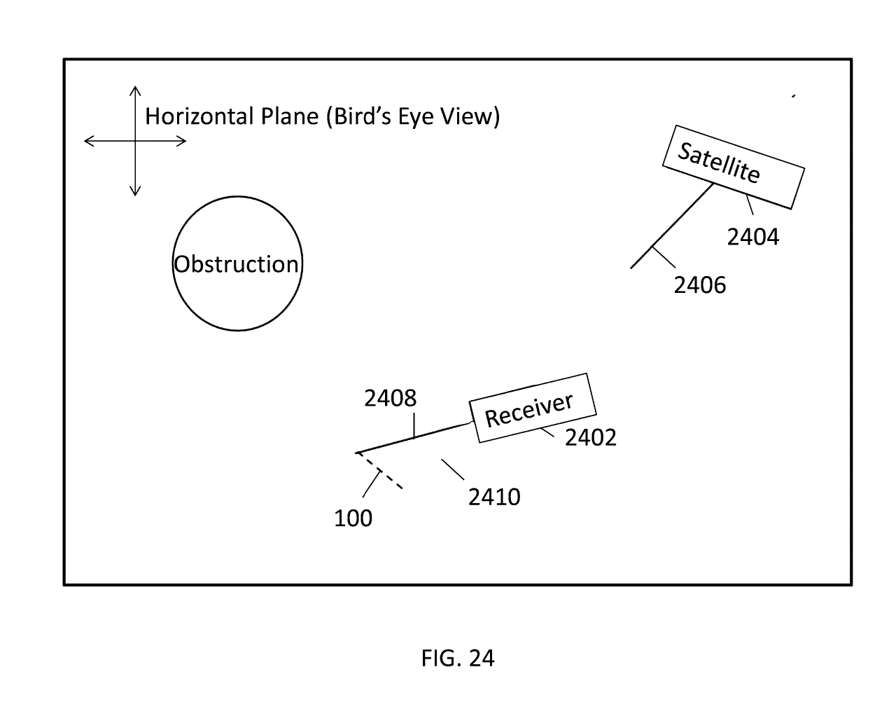

FIG. 24 illustrates a method of combining data from a satellite with data from one or more sensors of velocity and/or distance traveled to refine what would otherwise be unreliable satellite data. First, a carrier phase lock may be used to calculate motion along an LOS vector projected on the horizontal plane between receiver 2402 and satellite 2404. The ephemerides (i.e., positions at a given time) of satellite 2404 may be downloaded from the NOAA and/or obtained from data broadcast by satellite 2404, and used to determine a distance 2406 moved by satellite 2404 along the LOS vector. A sensor of velocity and/or distance traveled (e.g., for optical flow-based dead reckoning) may be used to obtain a total distance 2408 moved by receiver 2402 in two orthogonal axes in the horizontal plane. Based at least in part on the distance 2406 moved by satellite 2404 along the LOS vector and the total distance 2408 moved by receiver 2402 in the horizontal plane, the distance 2410 traveled by receiver 2402 along the LOS vector may be calculated. From the total distance 2408 moved by receiver 2402 in the horizontal plane and the distance 2410 traveled by receiver 2402 along the LOS vector projected on the horizontal plane, the distance 2412 traveled by receiver 2402 in the horizontal plane along a direction perpendicular to the LOS vector projected on the horizontal plane may be calculated such that the new position of receiver 2402 may be determined.

Some GNSS receivers do not provide carrier phase information, but instead, provide Doppler frequency information. In this case the range rate rᵣ^{s} between receiver r and satellite s may be calculated using the following formula:

$${r}_{r}^{s} = {e}_{r}^{sT} ( {v}^{s} ( {t}^{s} ) - {v}_{r} ) + \frac{{ω}_{e}}{c} ( {v}_{y}^{s} {x}_{r} + {y}^{s} {v}_{x , r} - {v}_{x}^{s} {y}_{r} - {x}^{s} {v}_{y , r} )$$

where:
y^{s}=−Dopplerᵢ^{s}λᵢ where Dopplerᵢ^{s} is the Doppler output of the receiver for satellite s and carrier i, and λᵢ is the wavelength of the carrier;
eᵣ^{s} is unit LOS vector from receiver r to satellite s;
v^{s}(t^{s}) is the velocity of satellite s at time t^{s};
v^{s}=(vₓ^{s},v_{y}^{s},v_{z}^{s})^{T} where vₓ^{s}, v_{y}^{s}, v_{z}^{s} are components of the velocity of satellite s in the respective x-, y-, and z-axes of the “Earth-Centered, Earth-Fixed” (“ECEF,” also known as “Earth Centered Rotational” or “ECR”) Cartesian coordinate system;
ωₑ is Earth's rotational velocity;
c is the speed of light; and
vᵣ=(v_{x,r}, v_{y,r}, v_{z,r})^{T} where v_{x,r}, v_{y,r}, v_{z,r} are components of the velocity of receiver r in the respective x-, y-, and z-axes of the ECEF Cartesian coordinate system.

Using the above formula, the range rate rᵣ^{s} between receiver r and satellite s, in combination with distance/velocity sensor information, can be solved iteratively.

Thus, in accordance with some embodiments, only partial GNSS information data may be combined with data from one or more sensors of velocity and/or distance traveled to fully characterize motion of an object (e.g., a marking apparatus) equipped with a GNSS receiver in a horizontal plane.

This method is of practical importance as distance and velocity sensors and carrier phase GPS receivers are cheap as compared to highly accurate attitude and heading sensors. Sensors of velocity and/or distance may include, but are not limited to, one or more accelerometers, gyroscopes, inertial motion units, sonar range finders, laser range finders, laser surface velocimeters, odometers, pitot tubes, anemometers, velocity receivers, and/or camera systems (e.g., digital video cameras or optical flow chips) with image analysis software (with algorithms for performing optical flow calculations and/or algorithms that are useful for performing optical flow-based dead reckoning).

The techniques described above may be generalized to three dimensions. For example, in areas with variable elevation (e.g., an incline or hills) object motion may not be constrained to a horizontal plane. Object motion may also leave a horizontal plane in applications including, but not limited to, tracking an object in flight (e.g., an unmanned aerial vehicle or UAV). In such cases, the total distance traveled may be combined with the distances traveled along the LOS vectors between the receiver and two or more satellites to obtain a three-dimensional position of the object.

In some embodiments, data regarding total distance traveled by a receiver is not available; but receiver orientation information, the ephemeris of a satellite, and a distance traveled by the receiver along a LOS vector projected on the horizontal plane between the receiver and the satellite is available. Accordingly, data from GNSS satellites may be combined with heading data to characterize motion of an object (e.g., a marking apparatus) equipped with a GNSS receiver. Instead of total distance traveled, an Attitude Heading Reference System (AHRS), a gyroscope, an electronic compass, and/or another orientation sensor may be used to obtain the absolute heading of an associated object (e.g., a marking apparatus).

For example, the motion of receiver r may be fully characterized in the horizontal plane using only partial GNSS information and the following formula:

Dᵣ=D_{r,HorizX}^{s}/cos(θᵣ−Azᵣ^{s})

where:
Dᵣ is the total distance traveled by receiver r in the horizontal plane;
D_{r,HorizX}^{s} is the distance moved by receiver r along the LOS vector projected on the horizontal plane between receiver r and satellite s;
θᵣ is the heading of receiver r; and
Azᵣ^{s} is the azimuth angle of the LOS vector projected on the horizontal plane between receiver r and satellite s, which may be calculated using the broadcast or downloaded ephemeris of satellite s.

Even when a sufficient number of GNSS satellites are visible and/or adequately distributed across the sky, positioning accuracy may be improved by taking into account information from all available sensors.

The more satellites in lock with the receiver, the more error may be reduced by averaging available GNSS information from the satellites. Likewise, heading information from an AHRS or an electronic compass may be averaged. In some embodiments, a weighted average inversely proportional to an amount of uncertainty (as estimated by noise covariance) is used.

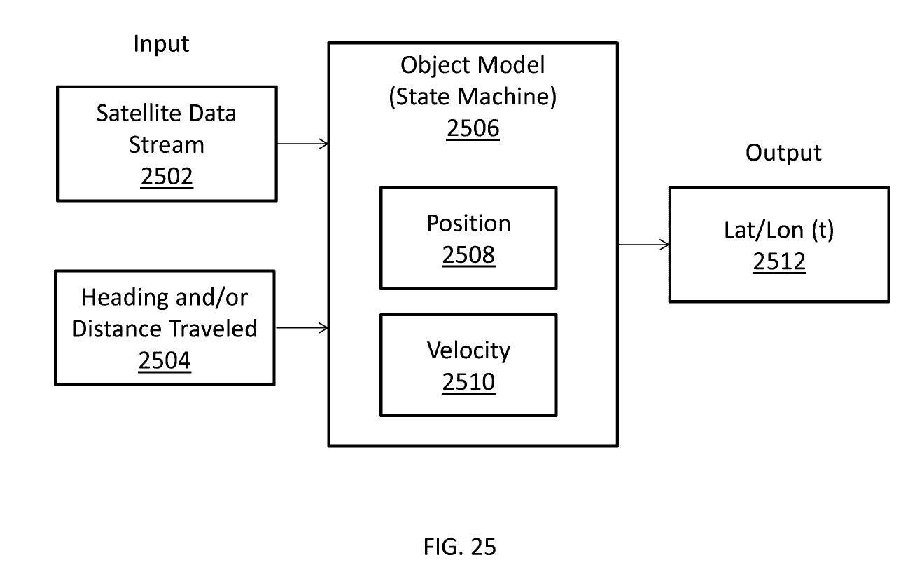

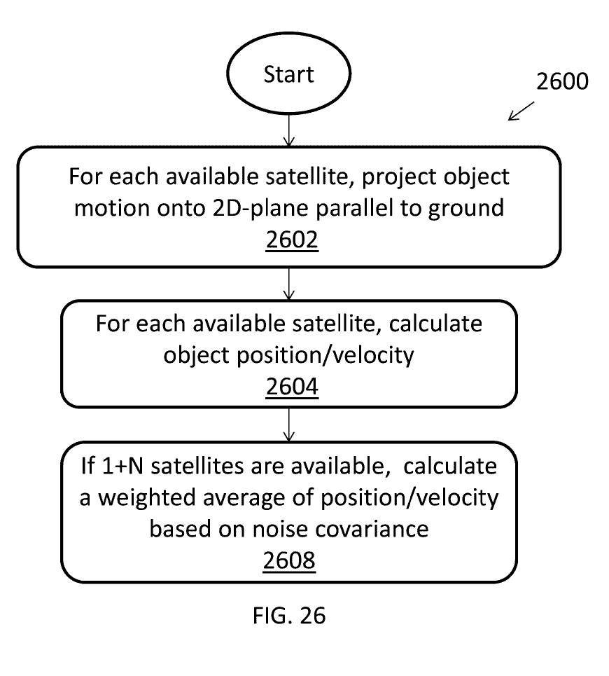

For example, a dynamic model of the receiver which has position and velocity as its state variables may be used, and data from the sensors may be treated as measurements on the dynamic model. Such a state machine model of object movement is illustrated in FIGS. 25 and 26 according to some embodiments. In FIG. 25, the satellite data stream input 2502 and receiver heading and/or distance traveled input 2504 are input into the state machine 2506, which has a position state variable 2508 and a velocity state variable 2510 as a function of time. The output 2512 of the state machine 2506 is a stream of coordinates (e.g., latitude and longitude pairs) as a function of time. FIG. 26 illustrates a method 2600 used by the state machine according to some embodiments. In step 2602, the object motion is projected onto a horizontal plane substantially parallel to the ground for each available satellite. Then, in step 2604, the object position/velocity is calculated for each available satellite. If more than one satellite (1+N) is available, in step 2606, a weighted average of the N+1 calculations is taken based on a reliability factor like noise covariance. The uncertainty in model and measurements may then be combined, and the system state, which is usually non-linear, propagated using a number of available techniques including, but not limited to, extended Kalman filter (EKF), unscented Kalman filter (UKF), and/or particle filters (PF).

According to some embodiments, real time data recorded with different sensors (e.g., location tracking systems such as one or more GNSS modules and/or one or more camera systems, optical flow sensors, IMUS, gyros, compasses, range sensors, etc.) is post-processed with or without additional information available about the area to “blend” at least some of the data together for a more accurate result. This post-processing “blending” may account for the accuracy and/or drift of each sensor. Blending may also account for the noise expected and/or present in data from each sensor, which typically varies with the environment.

According to some embodiments, post processing may obtain data from sensors including, but not limited to, an ST GPS Module (e.g., STA8088) (e.g., for GPS position, velocity, and/or time data, satellite SNRs for both GPS and GLONASS constellations, etc., at about 5 Hz); an NVS GPS Module (e.g., NVS 08CSM) (e.g., for raw GPS and GLONASS satellite data including pseudo range, carrier phase, Doppler, SNRs, time stamps, etc., at about 10 Hz); an optical flow sensor (e.g., for x-,y-movement data, etc., at about 90 Hz); a range sensor (e.g., for height above ground, etc., at about 90 Hz); a compass (e.g., for computed direction heading, magnetic field vector values, etc., at about 90 Hz); a trigger pulled input sensor (e.g., for actuation time stamps, etc., at about 90 Hz); a gyroscope (e.g., for angular velocity vector, etc., at about 90 Hz); and/or an accelerometer (e.g., for acceleration vectors, etc., at about 90 Hz). In addition, post processing may obtain data from an imagery server (e.g., for GIS images of the area).

Post processing may include further GNSS data processing. In some embodiments, data from a GNSS log is analyzed. For example, a table or other data structure may be created and filled with successive GPS readings. Each GPS reading entry in the data structure may contain data including, but not limited to, elapsed time (e.g., since the job began), GPS time, latitude, longitude, horizontal dilution of position (HDOP) as reported by the GPS module, HDOP calculated taking into account only satellites with SNR above a predetermined threshold set (using, e.g., the positions of satellites in the sky as reported the GPS module), HDOP calculated with only high SNR satellites in East-West directions, HDOP calculated with only high SNR satellites in North-South directions, speed of movement as reported by the GPS module, and/or heading as reported by the GPS module.

Post processing may include further optical flow data processing. In some embodiments, data from an optical flow log is analyzed. For example, a table or other data structure may be created and filled with successive optical flow readings. Each optical flow reading entry in the data structure may contain data including, but not limited to, elapsed time (e.g., since the job began), distance traveled in the x-direction calculated using data reported by the optical flow module (e.g., camera system 112), distance traveled in the y-direction calculated using data reported by the optical flow module, heading as reported by a gyroscope, and/or heading as reported by a compass. In some embodiments, only the total distance traveled or the heading is known and the orientation and/or distance traveled in the x- and y-directions must be calculated based on partial GNSS data (e.g., data from at least one satellite in carrier phase lock) as described above.

According to some embodiments, a compass may exhibit a bias in reported headings, which can be compensated, at least in some instances. The approximate area in which an object is moving may be ascertained, for example, from a GNSS reading. One or more images of the area may be obtained, edge detection may be performed on the one or more images, and any detected edges may be analyzed for straight lines. An optical flow path may be plotted on one or more corresponding images of the same location with the same dimensions and scale as the one or more images, but with a dark (e.g., black) background. Any straight lines also may be detected in the one or more corresponding optical flow path images and compared against any straight lines detected in the original one or more images. If a straight line in the one or more corresponding optical flow path images is close to a straight line in the original one or more images, but has a relatively small angle, the small angle may be assumed to be due to a bias in the compass and subject to correction. In embodiments related to marking operations (as well as other applications), the assumption is that the path followed by a technician will be parallel to a straight edge or will cut the straight edge at a sharp angle. In practice, marks made at a small angle to an edge are rare.

In some embodiments, the type of surface detected is compared to one or more images of the approximate area in which an object is moving ascertained, for example, from a GNSS reading. As described above, when calculating updated longitude and latitude coordinates for estimated positions as an object (e.g., a marking device) traverses a path along the target surface, the accuracy of the estimated positions is generally within some percentage (X %) of the linear distance traversed by the marking device along the path from the most recent starting position (or initial/reference/last-known position). The value of X (i.e., the observed DR-location data error circle) grows with linear distance traversed by the object and depends at least in part on the type of target surface imaged by the camera system. For example, for target surfaces with various features that may be relatively easily tracked by an optical flow algorithm, a value of X equal to approximately three generally corresponds to the observed error circle (i.e., the radius of the error circle is approximately 3% of the total linear distance traversed by the object). On the other hand, for some types of target surfaces (e.g., smooth white concrete with few features, and under bright lighting conditions), the value of X has been observed to be has high as from 17 to 20.

At the same time, variations in target surface type and features also may be used to track an object and/or supplement or refine existing data (e.g., GNSS data). For example, a transition from a smooth concrete surface to a grass surface is visible in both the magnitude and the characteristics of the noise in the raw output data of a range finder (i.e., the noise is relatively small and consistent on the smooth concrete surface, but the magnitude of the noise is much greater with more variability on the grass surface). According to some embodiments, a computer algorithm may be used to automatically determine the one or more types of surfaces being traversed by an object by applying a high pass filter to the raw output data of the range finder with an appropriate threshold and moving window sample size for the noise-to-signal ratio (1/SNR) characteristic of different types of surfaces. As an alternative to or in conjunction with the noise-to-signal ratio, other parameters (e.g., a time progression of the standard deviation and other statistical measures) of the raw output data of the range finder may be measured and/or calculated.

According to some embodiments, the data from GNSS is examined going forward in time. GNSS position readings may be considered reliable if the calculated HDOP is above a predetermined threshold at a given time, the calculated HDOP is above the threshold, for example, about four seconds after that time (or tracking ends before, for example, about four seconds after that time), the calculated HDOP is above the threshold, for example, about four seconds before that time (or tracking had not yet started more than, for example, about four seconds before that time). In some embodiments, it is particularly important to consider HDOP readings before and after a given position reading because the filter in the GNSS module introduces delays.

While going forward in time, GNSS position readings may be scanned for the first reliable GNSS positions. Scanning may continue until an unreliable GNSS position reading is encountered. Once an unreliable GNSS position reading is encountered, the GNSS position readings may be rejected and substituted with points from a calculated optical flow path (or a path calculated from some other form of dead reckoning, e.g., based on total distance traveled or heading as described above) until a reliable GNSS position reading is encountered. This results in a forward-corrected path. For each point at which the optical flow path is substituted, the time elapsed since the last reliable GNSS position reading may be recorded as dead reckoning time. Often a small gap will occur in a forward-corrected path wherever the optical flow path ends and the GNSS position readings begin again.

In some embodiments, the same process is repeated starting from the end of the job and going backwards in time, resulting in a backward-corrected path. The forward and backward corrected path should be the same where GNSS is reliable but may differ at points where the optical flow path data is substituted. For example, the optical flow path is more likely to be correct closer to the points where GNSS was last reliable and progressively degrades with dead reckoning time.

According to some embodiments, a more accurate path may be obtained by taking a weighted average of the forward-corrected path and the corresponding backward-corrected path, with the optical flow path being given more weight in either the forward-corrected path or the backward-corrected path. The following computer program code is an example of an applied algorithm for taking a weighted average of the forward-corrected path and the corresponding backward-corrected path.

gpsd_cor[ctr].lat=(gpsdFwd[ctr].dr_time*gpsdBack[ctr].lat+gpsdBack[ctr].dr_time*gpsdFwd[ctr].lat)/total_time

gpsd_cor[ctr].longitude=(gpsdFwd[ctr].dr_time*gpsdBack[ctr].longitude+gpsdBack[ctr].dr_time*gpsdFwd[ctr].longitude)/total_time
gpsd_cor is the table of corrected positions
ctr is counter in the table
gpsdFwd is forward corrected path table
dr_time is the time spent in dead reckoning till that counter's entry
gpsdBack is the backward corrected path
lat is the latitude
long is the longitude
total_time is the sum of forward and backward dead reckoning times at that counter entry calculated as follows:

total_time=gpsdFwd[ctr].dr_time+gpsdBack[ctr].dr_time

Depending on the object-tracking application, post processing may be split into at least two parts: (1) a post-processing daemon that runs in the background and logs data and (2) a post-processing program that processes the data.

In some embodiments for marking methods and apparatus, a post-processing daemon determines whether the marking apparatus is connected, obtains a listing of jobs on the marking apparatus, determines whether any of the jobs are unprocessed, downloads any unprocessed jobs, calls a post-processing program for each of any unprocessed jobs, determines whether any of the jobs are processed, and/or provides a facility to upload processed jobs, for example, to a server (e.g., a central server and its login credentials may be hard coded in the daemon). When a post-processing daemon is running, an indicator (e.g., a small icon in the Windows status bar area of a display screen that may be clicked to access different functionality) may be displayed to the technician. The following computer program code is an example for controlling options of a post-processing daemon.
;This specifies the delay between each check of Marking apparatus connectivity DelayBetweenRuns=5000
;Even if no marking apparatus is connected, the software checks the incoming folder and processes any files present
CheckIncoming=1
;This specifies the user name with which uploaded Marking apparatus data is tagged Marking apparatusUser=smishra

In some embodiments for marking methods and apparatus, a post-processing program processes each job. The program may leave an original visit file generated on the marking apparatus untouched and, instead, generate copies of the visit file refined to correspond to post processing (e.g., blending of additional data). The program may also output a plot of the GNSS path (e.g., color-coded depending on estimated accuracy based on threshold values—green indicates a reliable data period, yellow indicates a transition period, and red indicates a period with a strong likelihood that the data is unreliable), a plot of the forward-corrected path (e.g., color-coded depending on the source of data—green indicates the GNSS path while white indicates the corrected path), a plot of the backward-corrected path (e.g., color-coded depending on the source of data—green indicates the GNSS path while white indicates the corrected path), and/or a plot of the blended path based at least in part on a weighted average of the forward-corrected path and the backward-corrected path.

The following computer program code is an example for controlling options of a post-processing program written in the open source LuaJIT programming language, which uses shared libraries written in the American National Standards Institute (ANSI) C programming language.
--Per Marking apparatus configuration
--Temperature scaling for Gyro
BiasMultiplier=−0.8523
BiasConstant=15.784
--Override computed value for gyro bias using a set bias
Bias Override=0
BiasSet=50
--Gyro angular velocity scaling
GyroScale=0.948124;
--Distance scaling for distance traveled
DistanceScale=0.8
--Use Ocean Server compass
useCompassSet=1
CompassBiasSet=−15.0
--Use Sparton Compass
useSpartonCompassSet=true
spartonMountingBias=15.0
spartonMagneticLowerMagnitude=400
spartonMagneticUpperMagnitude=500
magneticInterferenceThreshold=3*1000*1000
--GPS values
--Valid Satellite SNR above which it is assumed that the Satellite signal is
--not experiencing multipath
validSatSNR=37.5
--Each position generated by GPS is classified as good, ok or junk depending
--on calculated Dilution of Precision values using only satellites whose
--Signal to Noise ratios are above validSATSNR
goodHDOPlevel=2.1
okHDOPlevel=8.1
junkHDOPlevel=13.0
--The speed at which the user is moving is useful for determining accuracy
--of GPS data. In particular, below this speed noise corrupts GPS heading
--data significantly.
--Also used to determine if the gps values should be considered good.
--Usually if the tech starts off in a good area and speed is high the
--readings will be good.
gpsGoodSpeedCutoff=0.9--meters/second
--The position data for the GPS is filtered. Bad data may extend in good
--data regions for approximately this time before and after a bad
--constellation is detected.
gpsLookAheadAndBackTime=4.0—seconds
--Move the files to processed directory
--Normally set to 1 but is useful to set to 0 when experimenting with
--different blending algorithms on the same jobs over and over again
moveToProcessed=0

It should be appreciated that the sensors and techniques described herein may be applied in many contexts including, but not limited to, motion-based detection, recognition, surveillance, documentation, and/or navigation. In addition to field services, these sensors and techniques may be used to improve operations in, for example, business/sales, insurance, government (security, military, law enforcement, emergency infrastructure, etc.), healthcare/safety (hospitals, pharmacies, child protection, elderly care, etc.), pet tracking, teen driver tracking, transit services (taxis/limousines, airports, buses, trains, trolleys, rental cars, etc.), food and beverage service, agriculture, heavy equipment/construction, forestry/fishing/mining, energy/utilities, telecommunications, waste management, manufacturing, storage/inventory (warehouses, pharmacies, etc.), and distribution/delivery (trucking, pipelines, railways, etc.).

These sensors and techniques may be used to track a variety of different objects, including objects carried by, mounted on, or otherwise connected to the motion of a human or an animal With respect to tracking activities, the sensors described herein may be affixed to or contained in, for example, accessories like work/utility belts, helmets/hard hats, air tanks, backpacks, etc. Similar to the marking device embodiments, the sensors described herein also may be affixed to or contained in various other handheld tools and equipment including, but not limited to, tools and equipment for cataloguing inventory, surveying, cleaning, yard/lawn maintenance, pest control, natural gas leak detection, installations, inspections, and repairs, as well as vessels or containers like carts or wagons for work, shopping, delivery, stocking, food service, healthcare, etc. The sensors described herein also may be affixed to, contained in, or otherwise connected to manned or unmanned and/or autonomous mobile machines, such as robots, rovers, track-type equipment (e.g., tractors), graders, skid steer loaders, excavators (e.g., trenchers, boring machines, and hydromatic tools), back hoes, forestry equipment (harvesters), pipelayers, scrapers, compactors, loaders, material handlers (e.g., fork lifts), pavers, plows, highway equipment (e.g., plows, street sweepers, and line painters), other heavy equipment, land vehicles, watercraft, spacecraft, and aircraft.

For example, a user may be attempting to access GNSS data, for example, on a cellular phone from a motor vehicle. Even though a position fix may not be accurate, or even possible, using the GNSS data in isolation (because it is unreliable due to one or more of the reasons described above), partial data from at least one visible GNSS satellite (e.g., in carrier phase lock) may be combined with data from one or more other sensors (e.g., sensors of velocity and/or distance traveled) to obtain position fixes and to improve positioning accuracy. Thus, in accordance with some embodiments, partial GNSS data may be combined with data from the vehicle's odometer (automatically accessed using, for example, a CAN bus device, or a Bluetooth device) on the cellular phone and post-processed to fully characterize the motion of the vehicle.

It should also be appreciated that latitude and longitude coordinates may be obtained from any of a variety of sources, including local signal transmitters. For example, an unmanned aerial vehicle (UAV) may have a receiver capable of receiving signals from GNSS satellites and GNSS-like signals from local, terrestrial signal transmitters (i.e., pseudo-satellites or pseudolite navigation systems, which replicate all of a GNSS constellation's functions) and one or more sensors of velocity and/or distance traveled, such as a pitot tube, in accordance with some embodiments. In some environments, satellite signals may not be reliable or even available because, for example, the signals are being jammed. As a result, local signal transmitters may be deployed. Even though a position fix of the UAV may not be accurate using the GNSS-like signals from the local signal transmitters in isolation, partial data from at least one visible local signal transmitter (e.g., in carrier phase lock) may be combined with data from one or more sensors of velocity and/or distance traveled (e.g., the pitot tube) to obtain position fixes and to improve positioning accuracy. Thus, in accordance with some embodiments, partial GNSS-like data may be combined with data from the UAV's pitot tube and post-processed to fully characterize the motion of the UAV.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

As a more specific example, an illustrative computer that may be used for surface type detection in accordance with some embodiments comprises a memory, one or more processing units (also referred to herein simply as “processors”), one or more communication interfaces, one or more display units, and one or more user input devices. The memory may comprise any computer-readable media, and may store computer instructions (also referred to herein as “processor-executable instructions”) for implementing the various functionalities described herein. The processing unit(s) may be used to execute the instructions. The communication interface(s) may be coupled to a wired or wireless network, bus, or other communication means and may therefore allow the illustrative computer to transmit communications to and/or receive communications from other devices. The display unit(s) may be provided, for example, to allow a user to view various information in connection with execution of the instructions. The user input device(s) may be provided, for example, to allow the user to make manual adjustments, make selections, enter data or various other information, and/or interact in any of a variety of manners with the processor during execution of the instructions.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

1. A system to track a position of an object moving along and above a ground surface, the system comprising:
the object, wherein the object comprises, affixed thereto or contained therein:
an inertial measurement unit (IMU) to provide a plurality of heading direction values for the object as the object moves along and above the ground surface;
a satellite-based location tracking apparatus to provide a first set of position coordinate pairs corresponding to respective positions of the object as the object moves along and above the ground surface, based on a plurality of satellites communicatively coupled to the satellite-based location tracking apparatus;
an optical flow-based image acquisition apparatus to acquire a plurality of images of the ground surface as the object moves along and above the ground surface, the optical flow-based image acquisition apparatus configured to provide a second set of position coordinate pairs corresponding to at least some of the respective positions of the object as the object moves along and above the ground surface, based on optical flow image processing of the plurality of images of the ground surface; and
at least one processor communicatively coupled to the IMU, the satellite-based location tracking apparatus, and the optical flow-based image acquisition apparatus, to calculate a third set of position coordinate pairs corresponding to the respective positions of the object based at least in part on:
at least some of the first set of position coordinate pairs;
at least one first reliability factor relating to the first set of position coordinate pairs; and
at least one of:
at least some of the second set of position coordinate pairs;
at least one second reliability factor relating to the second set of position coordinate pairs, if used by the processor to calculate the third set of position coordinate pairs;
at least some of the plurality of heading direction values; and
at least one third reliability factor relating to the plurality of heading direction values, if used by the processor to calculate the third set of position coordinate pairs.

2. The system of claim 1, wherein the IMU comprises at least one of:
at least one gyroscope; and
at least one electronic compass,
wherein the plurality of heading direction values are based on gravitational north in a north-south-east-west or NSEW reference frame.

3. The system of claim 2, wherein:
the IMU comprises the at least one gyroscope and the at least one electronic compass;
the at least one gyroscope provides a plurality of angular velocity vectors as a function of time;
the at least one electronic compass provides a plurality of magnetic field vectors as a function of time representative of a magnetic field of the earth;
the plurality of heading direction values are based on at least one of the plurality of angular velocity vectors and the plurality of magnetic field vectors; and
the at least one processor is configured to calculate the at least one third reliability factor relating to the plurality of heading direction values based at least in part on at least one of the plurality of angular velocity vectors and the plurality of magnetic field vectors.

4. The system of claim 3, wherein:
the system further comprises at least one communication interface coupled to the at least one processor to facilitate communication between the at least one processor and the Internet;
the at least one processor is configured to control the at least one communication interface so as to access via the Internet geographically-dependent ambient magnetic field values; and
the at least one processor is configured to compare the geographically-dependent ambient magnetic field values accessed via the Internet to respective ones of the plurality of magnetic field vectors to determine at least one of the at least one third reliability factor and a magnetic field calibration factor.

5. The system of claim 1, wherein:
the plurality of satellites communicatively coupled to the satellite-based location tracking apparatus, during operation of the system, includes at least one GNSS satellite; and
the satellite-based location tracking apparatus is configured to provide the first set of position coordinate pairs as a plurality of latitude/longitude coordinate pairs, wherein for each latitude/longitude coordinate pair of the plurality of latitude/longitude coordinate pairs, the satellite-based location tracking apparatus further is configured to provide:
a total number of GNSS satellites communicatively coupled to the satellite-based location tracking apparatus and used to calculate the latitude/longitude coordinate pair; and
for each satellite of the total number of GNSS satellites communicatively coupled to the satellite-based location tracking apparatus and used to calculate the latitude/longitude coordinate pair:
a signal-to-noise ratio (SNR);
an elevation value;
a dilution of precision (DOP) value; and
a time stamp including coordinated universal time and date.

6. The system of claim 5, wherein the at least one processor is configured to calculate the at least one first reliability factor for at least one coordinate pair of the first set of position coordinate pairs based at least in part on:
a first number of GNSS satellites communicatively coupled to the satellite-based location tracking apparatus and used to calculate the at least one coordinate pair and having an SNR above a first predetermined threshold, an elevation value above a second predetermined threshold, and a DOP value above a third predetermined threshold.

7. The system of claim 6, wherein the first number is at least four satellites.

8. The system of claim 6, wherein:
the first predetermined threshold for the SNR is 35 dB;
the second predetermined threshold for the elevation value is 20 degrees; and
the third predetermined threshold for the DOP value is 2.7.

9. The system of claim 5, wherein:
the satellite-based location tracking apparatus further is configured to provide, for each satellite of the total number of GNSS satellites communicatively coupled to the satellite-based location tracking apparatus and used to calculate the latitude/longitude coordinate pair:
a pseudo range value;
a carrier phase value; and
an azimuth value; and
the at least one processor is configured to calculate the at least one first reliability factor for at least one coordinate pair of the first set of position coordinate pairs based at least in part on:
the signal-to-noise ratio (SNR);
the pseudo range value;
the carrier phase value;
the elevation value; and
the azimuth value.

10. The system of claim 9, wherein the total number of GNSS satellites is less than or equal to three satellites.

11. The system of claim 1, wherein:
the optical flow-based image acquisition apparatus is configured to provide the second set of position coordinate pairs as a plurality of relative position coordinate pairs based on a field-of-view (FOV) of the image acquisition apparatus;
the at least one processor is configured to calculate the at least one second reliability factor for at least one coordinate pair of the second set of position coordinate pairs based at least in part on at least one of:
an elapsed time since a previous reliable position coordinate pair of the first set of position coordinate pairs was acquired from the satellite-based location tracking apparatus; and
a distance traveled by the object in a two-dimensional plane substantially parallel to the ground surface since the previous reliable position coordinate pair of the first set of position coordinate pairs was acquired from the satellite-based location tracking apparatus.

12. The system of claim 11, wherein the at least one processor is further configured to calculate the at least one second reliability factor for the at least one coordinate pair of the second set of position coordinate pairs based at least in part on the at least one third reliability factor relating to the plurality of heading direction values.

13. The system of claim 1, wherein the object is a marking device to dispense a marking material onto the ground surface.

14. The system of claim 1, wherein the object is a vehicle.

15. The system of claim 14, wherein the vehicle is at least one of an unmanned vehicle and an autonomous vehicle.

16. The system of claim 14, wherein the vehicle is at least one of a land vehicle, a piece of heavy equipment, a watercraft, a spacecraft, and an aircraft.

17. The system of claim 16, wherein the piece of heavy equipment is at least one of a work cart, tractor, grader, skid steer loader, trencher, back hoe, fork lift, paver, plow, and line painter.

18. The system of claim 1, wherein the object is at least one of an accessory, a handheld tool, a piece of equipment, and a container.

19. A system to track a position of an object moving substantially in a two-dimensional plane substantially parallel to a ground surface, the system comprising:
A) the object, wherein the object comprises, affixed thereto or contained therein:
A1) a satellite-based location tracking apparatus to provide a first set of position coordinates pairs corresponding to respective positions of the object as the object moves substantially in the two-dimensional plane, based on a plurality of satellites communicatively coupled to the satellite-based location tracking apparatus, wherein:
the plurality of satellites communicatively coupled to the satellite-based location tracking apparatus, during operation of the system, includes at least one GNSS satellite; and
the satellite-based location tracking apparatus is configured to provide the first set of position coordinate pairs as a plurality of latitude/longitude coordinate pairs, wherein for each latitude/longitude coordinate pair of the plurality of latitude/longitude coordinate pairs, the satellite-based location tracking apparatus further is configured to provide:
a total number of GNSS satellites communicatively coupled to the satellite-based location tracking apparatus and used to calculate the latitude/longitude coordinate pair; and
satellite-specific information for each satellite of the total number of GNSS satellites communicatively coupled to the satellite-based location tracking apparatus and used to calculate the latitude/longitude coordinate pair, the satellite-specific information comprising for each satellite:
a signal-to-noise ratio (SNR);
at least one of a carrier phase value and a Doppler frequency value;
ephemeris information; and
a time stamp including coordinated universal time and date; and
A2) at least one of:
A2a) an inertial measurement unit (IMU) to provide a plurality of heading direction values for the object as the object moves substantially in the two-dimensional plane; and
A2b) an optical flow-based image acquisition apparatus to acquire a plurality of images of the ground surface as the object moves substantially in the two-dimensional plane, the optical flow-based image acquisition apparatus configured to provide a second set of position coordinate pairs corresponding to at least some of the respective positions of the object as the object moves substantially in the two-dimensional plane, based on optical flow image processing of the plurality of images of the ground surface; and
B) at least one processor communicatively coupled to the satellite-based location tracking apparatus, and the at least one of the IMU and the optical flow-based image acquisition apparatus, to calculate a third set of position coordinate pairs corresponding to the respective positions of the object as a function of time based at least in part on:
B1) at least some latitude/longitude coordinate pairs of the plurality of latitude/longitude coordinate pairs provided by the satellite-based location tracking apparatus;
B2) at least some of the satellite-specific information for each satellite used to calculate the at least some latitude/longitude coordinate pairs; and
B3) at least one of:
B3a) at least some of the plurality of heading direction values provided by the IMU; and
B3b) at least some position coordinate pairs of the second set of position coordinate pairs provided by the optical flow-based image acquisition apparatus.

20. The system of claim 19, wherein:
the at least one processor is configured to implement a dynamic model for the respective positions of the object as a state machine having a position state variable and a velocity state variable as a function of time; and
the at least one processor calculates the position state variable and the velocity state variable based at least in part on:
at least one latitude/longitude coordinate pair of the plurality of latitude/longitude coordinate pairs;
the satellite-specific information for each satellite used to calculate the at least one latitude/longitude coordinate pair; and
at least one of:
at least one of the plurality of heading direction values provided by the IMU; and
a distance value based on the at least some position coordinate pairs of the second set of position coordinate pairs provided by the optical flow-based image acquisition apparatus.

21. The system of claim 20, wherein the at least one processor is configured to propagate a state of the state machine using at least one extended Kalman filter.

22. A method for tracking respective positions of an object that is moved along a ground surface, the method comprising:
A) electronically receiving:
A1) a plurality of satellite information data sets from a satellite-based location tracking apparatus coupled to the object, the plurality of satellite information data sets representing the respective positions of the object, each satellite information data set comprising:
a latitude/longitude coordinate pair corresponding to one position of the respective positions of the object;
a total number of GNSS satellites used by the satellite-based location tracking system to calculate the latitude/longitude coordinate pair; and
satellite-specific information for each satellite of the total number of satellites used to calculate the latitude/longitude coordinate pair; and
A2) at least one of:
A2a) heading direction values for the object, correlated in time with the plurality of satellite information data sets and corresponding to the respective positions of the object; and
A2b) distance information, correlated in time with the plurality of satellite information data sets and representing respective relative positions of the object in a two-dimensional plane substantially parallel to the ground surface; and
B) electronically calculating a third set of position coordinate pairs corresponding to the respective positions of the object as a function of time based at least in part on:
B1) at least some latitude/longitude coordinate pairs of the plurality of latitude/longitude coordinate pairs provided by the satellite-based location tracking apparatus;
B2) at least some of the satellite-specific information for each satellite used to calculate the at least some latitude/longitude coordinate pairs; and
B3) at least one of:
B3a) at least some of the heading direction values; and
B3b) at least some of the distance information.

23. An apparatus to provide position information regarding respective positions of an object that is moved along a ground surface, the apparatus comprising:
at least one communication interface to receive:
a plurality of satellite information data sets from a satellite-based location tracking apparatus coupled to the object, the plurality of satellite information data sets representing the respective positions of the object, each satellite information data set comprising:
a latitude/longitude coordinate pair corresponding to one position of the respective positions of the object;
a total number of GNSS satellites used by the satellite-based location tracking system to calculate the latitude/longitude coordinate pair; and
satellite-specific information for each satellite of the total number of satellites used to calculate the latitude/longitude coordinate pair, the satellite-specific information comprising, for each satellite:
a signal-to-noise ratio (SNR);
a carrier phase value;
an elevation value;
an azimuth value; and
a time stamp including coordinated universal time and date; and
distance information, correlated in time with the plurality of satellite information data sets, representing respective relative positions of the object in a two-dimensional plane substantially parallel to the ground surface; and
at least one processor, communicatively coupled to the at least one communication interface, to provide the position information regarding the respective positions of the object as a set of resultant latitude/longitude coordinate pairs, wherein for each satellite information data set of the plurality of satellite information data sets, the at least one processor is configured to:
A) analyze the total number of satellites used to calculate the latitude/longitude coordinate pair of the satellite information data set, and the satellite-specific information for each satellite of the total number of satellites, to determine if the longitude/latitude coordinate pair of the satellite information data set is of sufficient reliability;
B) if it is determined in A) that the latitude/longitude coordinate pair is of sufficient reliability, include the latitude/longitude coordinate pair in the set of resultant latitude/longitude coordinate pairs;
C) if it is determined in A) that the latitude/longitude coordinate pair is not of sufficient reliability:
C1) calculate an improved estimated latitude/longitude coordinate pair based at least in part on:
a previous latitude/longitude coordinate pair of sufficient reliability as determined in B);
the distance information representing the respective relative positions of the object in the two-dimensional plane substantially parallel to the ground surface; and
the carrier phase value, the elevation value, and the azimuth value for at least one satellite of the total number of satellites used to calculate the latitude/longitude coordinate pair; and
C2) include the improved estimated latitude/longitude coordinate pair in the set of resultant latitude/longitude coordinate pairs.

24. The apparatus of claim 23, wherein:
the distance information includes a plurality of relative position coordinate pairs provided by an optical flow-based image acquisition apparatus coupled to the object and configured to acquire a plurality of images of the ground surface as the object is moved along the ground surface; and
the plurality of relative position coordinate pairs are based on optical flow image processing of the plurality of images of the ground surface.

25. The apparatus of claim 23, wherein C1) comprises:
C1a) calculate a first distance D^{OF} moved by the object in the two-dimensional plane substantially parallel to the ground surface, relative to the previous latitude/longitude coordinate pair of sufficient reliability as determined in B), wherein the first distance D^{OF} is based at least in part on the distance information;
C1b) for a first satellite of the total number of satellites used to calculate the latitude/longitude coordinate pair:
calculate a carrier phase difference dφ for the first satellite based on a previous carrier phase value associated with the first satellite used to calculate the previous latitude/longitude coordinate pair of sufficient reliability as determined in B), and the carrier phase value for the first satellite;
calculate a second distance Dᵣ^{s} moved by the object along a line-of-site vector between the object and the first satellite, relative to the previous latitude/longitude coordinate pair of sufficient reliability as determined in B), wherein the second distance Dᵣ^{s} is calculated based at least in part on the carrier phase difference dφ;
calculate a first projected distance D_{r,HorizX}^{s} moved by the object along the line-of-site vector as projected onto the two-dimensional plane substantially parallel to the ground surface, based on the second distance Dᵣ^{s} and the elevation value for the first satellite;
calculate a second projected distance D_{r,HorizY}^{s} moved by the object along a perpendicular vector to the line-of-site vector as projected onto the two-dimensional plane substantially parallel to the ground surface, based on the first projected distance D_{r,HorizX}^{s} and the first distance D^{OF}; and
calculate a first estimated latitude/longitude coordinate pair based on the first projected distance D_{r,HorizX}^{s} the second projected distance D_{r,HorizY}^{s} the azimuth value for the first satellite, and the previous latitude/longitude coordinate pair of sufficient reliability as determined in B).

26. The apparatus of claim 25, wherein if the total number of satellites used to calculate the latitude/longitude coordinate pair is one, C1) further comprises:
use the first estimated latitude/longitude coordinate pair as the improved estimated latitude/longitude coordinate pair.

27. The apparatus of claim 25, wherein if the total number of satellites used to calculate the latitude/longitude coordinate pair is greater than one, C1) further comprises:
C1c) repeat C1b) for each remaining satellite of the total number of satellites used to calculate the latitude/longitude coordinate pair so as to calculate a corresponding estimated latitude/longitude coordinate pair for each remaining satellite;
C1d) calculate a weighted average latitude/longitude coordinate pair based on the estimated latitude/longitude coordinate pair for each satellite of the total number of satellites and the SNR for each satellite; and
C1e) use the weighted average latitude/longitude coordinate pair as the improved estimated latitude/longitude coordinate pair.

28. The apparatus of claim 23, wherein the at least one processor is configured to provide the position information regarding the respective positions of the object as the set of resultant latitude/longitude coordinate pairs without using any heading information for the object.

29. A system, comprising:
the apparatus of claim 24;
the satellite-based location tracking apparatus; and
the optical flow-based image acquisition apparatus.

30. The system of claim 29, wherein the object is a marking device to dispense a marking material onto the ground surface.

31. The system of claim 29, wherein the object is a vehicle.

32. The system of claim 31, wherein the vehicle is at least one of an unmanned vehicle and an autonomous vehicle.

33. The system of claim 31, wherein the vehicle is at least one of a land vehicle, a piece of heavy equipment, a watercraft, a spacecraft, and an aircraft.

34. The system of claim 33, wherein the piece of heavy equipment is at least one of a work cart, tractor, grader, skid steer loader, trencher, back hoe, fork lift, paver, plow, and line painter.

35. The system of claim 29, wherein the object is at least one of an accessory, a handheld tool, a piece of equipment, and a container.

36. An apparatus to provide position information regarding respective positions of an object that is moved along a ground surface, the apparatus comprising:
at least one communication interface to receive:
a plurality of satellite information data sets from a satellite-based location tracking apparatus coupled to the object, the plurality of satellite information data sets representing the respective positions of the object, each satellite information data set comprising:
a latitude/longitude coordinate pair corresponding to one position of the respective positions of the object;
a total number of GNSS satellites used by the satellite-based location tracking system to calculate the latitude/longitude coordinate pair; and
satellite-specific information for each satellite of the total number of satellites used to calculate the latitude/longitude coordinate pair, the satellite-specific information comprising, for each satellite:
a signal-to-noise ratio (SNR);
a carrier phase value;
an elevation value;
an azimuth value; and
a time stamp including coordinated universal time and date; and
heading information, correlated in time with the plurality of satellite information data sets, representing respective headings of the object at the respective positions along the ground surface; and
at least one processor, communicatively coupled to the at least one communication interface, to provide the position information regarding the respective positions of the object as a set of resultant latitude/longitude coordinate pairs, wherein for each satellite information data set of the plurality of satellite information data sets, the at least one processor is configured to:
A) analyze the total number of satellites used to calculate the latitude/longitude coordinate pair of the satellite information data set, and the satellite-specific information for each satellite of the total number of satellites, to determine if the longitude/latitude coordinate pair of the satellite information data set is of sufficient reliability;
B) if it is determined in A) that the latitude/longitude coordinate pair is of sufficient reliability, include the latitude/longitude coordinate pair in the set of resultant latitude/longitude coordinate pairs; and
C) if it is determined in A) that the latitude/longitude coordinate pair is not of sufficient reliability:
C1) calculate an improved estimated latitude/longitude coordinate pair based at least in part on:
a previous latitude/longitude coordinate pair of sufficient reliability as determined in B);
a heading direction θ of the respective headings, correlated in time with the satellite information data set; and
the carrier phase value, the elevation value, and the azimuth value for at least one satellite of the total number of satellites used to calculate the latitude/longitude coordinate pair; and
C2) include the improved estimated latitude/longitude coordinate pair in the set of resultant latitude/longitude coordinate pairs.

37. The apparatus of claim 36, wherein:
the heading information is provided by at least one of an attitude heading reference system, an inertial measurement unit, and an electronic compass coupled to the object.

38. The apparatus of claim 36, wherein C1) comprises:
C1a) for a first satellite of the total number of satellites used to calculate the latitude/longitude coordinate pair:
calculate a carrier phase difference dφ for the first satellite based on a previous carrier phase value associated with the first satellite used to calculate the previous latitude/longitude coordinate pair of sufficient reliability as determined in B), and the carrier phase value for the first satellite;
calculate a second distance Dᵣ^{s} moved by the object along a line-of-site vector between the object and the first satellite, relative to the previous latitude/longitude coordinate pair of sufficient reliability as determined in B), wherein the second distance Dᵣ^{s} is calculated based at least in part on the carrier phase difference dφ;
calculate a first projected distance D_{r,HorizX}^{s} moved by the object along the line-of-site vector as projected onto a two-dimensional plane substantially parallel to the ground surface, based on the second distance Dᵣ^{s} and the elevation value for the first satellite;
calculate a first distance D^{R} moved by the object in the two-dimensional plane substantially parallel to the ground surface, relative to the previous latitude/longitude coordinate pair of sufficient reliability as determined in B), based on the heading direction θ, the azimuth value for the first satellite, and a first projected distance D_{r,HorizX}^{s};
calculate a second projected distance D_{r,HorizY}^{s} moved by the object along a perpendicular vector to the line-of-site vector as projected onto the two-dimensional plane substantially parallel to the ground surface, based on the first projected distance D_{r,HorizX}^{s} and the first distance D^{R}; and
calculate a first estimated latitude/longitude coordinate pair based on the first projected distance D_{r,HorizX}^{s} the second projected distance D_{r,HorizY}^{s}, the azimuth value for the first satellite, and the previous latitude/longitude coordinate pair of sufficient reliability as determined in B).

39. The apparatus of claim 38, wherein if the total number of satellites used to calculate the latitude/longitude coordinate pair is one, C1) further comprises:
use the first estimated latitude/longitude coordinate pair as the improved estimated latitude/longitude coordinate pair.

40. The apparatus of claim 38, wherein if the total number of satellites used to calculate the latitude/longitude coordinate pair is greater than one, C1) further comprises:
C1b) repeat C1a) for each remaining satellite of the total number of satellites used to calculate the latitude/longitude coordinate pair so as to calculate a corresponding estimated latitude/longitude coordinate pair for each remaining satellite;
C1c) calculate a weighted average latitude/longitude coordinate pair based on the estimated latitude/longitude coordinate pair for each satellite of the total number of satellites and the SNR for each satellite; and
C1d) use the weighted average latitude/longitude coordinate pair as the improved estimated latitude/longitude coordinate pair.

41. A system, comprising:
the apparatus of claim 37;
the satellite-based location tracking apparatus; and
the at least one of the attitude heading reference system, the inertial measurement unit, and the electronic compass.

42. The system of claim 41, wherein the object is a marking device to dispense a marking material onto the ground surface.

43. The system of claim 41, wherein the object is a vehicle.

44. The system of claim 43, wherein the vehicle is at least one of an unmanned vehicle and an autonomous vehicle.

45. The system of claim 43, wherein the vehicle is at least one of a land vehicle, a piece of heavy equipment, a watercraft, a spacecraft, and an aircraft.

46. The system of claim 45, wherein the piece of heavy equipment is at least one of a work cart, tractor, grader, skid steer loader, trencher, back hoe, fork lift, paver, plow, and line painter.

47. The system of claim 41, wherein the object is at least one of an accessory, a handheld tool, a piece of equipment, and a container.
